(19) United States
(12) Patent Application Publication
(10) Pub. No.: US 2014/0081868 A1
(43) Pub. Date: Mar. 20, 2014

(54) SYSTEMS AND METHODS FOR TRANSFERRING VALUE

(71) Applicant: OPENCURO CORPORATION, Poway, CA (US)

(72) Inventor: Ian Edward James, San Francisco, CA (US)

(73) Assignee: OPENCURO CORPORATION, Poway, CA (US)

(21) Appl. No.: 14/085,233

(22) Filed: Nov. 20, 2013

Related U.S. Application Data
(62) Division of application No. 12/175,195, filed on Jul. 17, 2008.

(51) Int. Cl. G06Q 20/38

(52) U.S. Cl. CPC G06Q 20/383
USPC 705/44

(57) ABSTRACT

Systems and methods are provided for transferring value from a first user to a second user by using substantially random codes that are associated with the values to be transferred. A trusted authority enables users to create user accounts used to store value. A first user may request a payment code, which is associated with a specified value, and may be communicated to a second user, who may submit the payment code to the trusted authority. If the payment code is valid, the trusted authority debits the specified value from the first user's account and credits the specified value to the second user's account. Alternatively, the second user may request an invoice code, which is associated with a specified value, and may be communicated to the first user, who may submit the invoice code to the trusted authority. If the invoice code is valid, the trusted authority debits the specified value from the first user's account and credits the specified value to the second user's account.

### PRIORITY DATA

This application is a division of U.S. patent application Ser. No. 12/175,195 filed Jul. 17, 2008, now U.S. Pat. No. ______.

### BACKGROUND

Various techniques exist that enable people to transfer currency and pay for products and services. In person-to-person transactions, one party may transfer currency directly to a second party as a gift, a loan repayment, a wage, or a payment for products or services received from the second party. In addition, numerous payment techniques have been developed to facilitate payments without the need for direct currency transfers, such as checks, money orders, travelers checks, debit cards, gift cards, credit cards, vouchers, direct deposit and wire transfers. Further, in recent years, additional payment systems have been developed, such as PayPal and various electronic currency systems, as currency alternative systems. Although all such techniques advantageously provide alternatives to direct currency exchanges, each technique has several limitations.

In particular, most previously known alternative currency systems suffer from various privacy and fraud issues. For example, when a consumer purchases goods from a merchant using a credit or debit card, the merchant may require a substantial amount of information about the consumer as part of the transaction, including the consumer's name and credit card/debit card number, expiration date, card verification value (“CVV”) number, address or other financial data. Many merchants store such private data in vast databases that may be subject to unauthorized access. Indeed, numerous instances have occurred in recent years in which merchants have failed to adequately protect the security of consumer credit card data, and many consumers have been victims of fraud and identity theft as a result of such failures. Further, many consumers understandably object to communicating personally identifying information that may be linked with purchases of products and services, such as reading material, videos, escort services, and other similar products and services which may later be scrutinized by law enforcement or other government officials, or may otherwise be information that a consumer may not want to disclose.

In addition, some previously known payment methods have substantial burdens for merchants. To avoid potential liability to victims of identity theft, most merchants incur significant overhead to develop techniques to protect the security of private financial information received in connection with credit card and debit card transactions. Moreover, many credit card companies impose chargeback penalties if a consumer disputes a purchase made with a credit card. Also, many merchants continue to experience losses that result from checks that are dishonored for insufficient funds.

Thus, it would be desirable to provide systems and methods that permit value transfers, such as currency transfers, and that provide anonymity and avoid many of the privacy and fraud problems associated with previously known payment systems.

### SUMMARY

Systems and methods in accordance with this invention may be used to transfer value between users using substantially random codes that are associated with the values to be transferred. In particular, a trusted authority enables users to create user accounts that may be used to store value. Users may request codes from the trusted authority to transfer value to other users, and the codes may include payment codes and/or invoice codes.

For example, a first user may request a payment code to transfer a specified value to a second user. If the first user's account includes the specified value, the trusted authority generates a substantially random payment code associated with the specified value. The first user may then communicate the payment code to the second user, who may then submit the payment code to the trusted authority. If the payment code is valid (e.g., it was requested by a user but has not yet been submitted for payment), the trusted authority debits the specified value from the first user's account, and credits the specified value to the second user's account.

Alternatively, a first user may request an invoice code to receive a specified value from a second user. The trusted authority generates a substantially random invoice code associated with the specified value. The first user may then communicate the invoice code to the second user, who may then submit the invoice code to the trusted authority. If the invoice code is valid (e.g., it was requested by a user but has not yet been submitted for payment) and if the second user's account includes the specified value, the trusted authority debits the specified value from the second user's account, and credits the specified value to the first user's account.

For added security, return codes may be used. In particular, a first user may request a payment code to transfer a specified value to a second user, and may request a return code. If the first user's account includes the specified value, the trusted authority generates first and second substantially random payment codes associated with the specified value, and communicates the first payment code to the first user. The first user may then communicate the first payment code to the second user, who may then submit the first payment code to the trusted authority. If the first payment code is valid (e.g., it was requested by a user but has not yet been submitted for payment), the trusted authority communicates the second payment code to the second user. The second user may then communicate the second payment code to the first user, who may then submit the second payment code to the trusted authority. If the second payment code is valid (e.g., it was requested by a user but has not yet been submitted for payment), the trusted authority debits the specified value from the first user's account, and credits the specified value to the second user's account.

Alternatively, a first user may request an invoice code to receive a specified value from a second user, and may request a return code. The trusted authority generates first and second substantially random invoice codes associated with the specified value, and communicates the first invoice code to the first user. The first user may then communicate the first invoice code to the second user, who may then submit the first invoice code to the trusted authority. If the first invoice code is valid (e.g., it was requested by a user but has not yet been submitted for payment), the trusted authority communicates the second invoice code to the second user. The second user may then communicate the second invoice code to the first user, who may then submit the second invoice code to the trusted authority. If the second invoice code is valid (e.g., it was requested by a user but has not yet been submitted for payment) and if the second user's account includes the specified value, the trusted authority debits the specified value from the second user's account, and credits the specified value to the first user's account.

Exemplary systems and methods in accordance with this invention include or provide a trusted authority including a value store used to store value owned by users, and an account database including user accounts, each user account associated with a corresponding user and having a list of the stored value that is owned by the corresponding user, wherein the trusted authority is adapted to receive a request from a first user for a code to be associated with a specified value, generate a substantially random code, associate the generated code with the specified value, communicate the generated code to the first user, receive the generated code from a second user, determine if the received code is valid, and if the received code is valid, debit the specified value from the first user's account and credit the specified value to the second user's account to transfer ownership of the specified value from the first user to the second user.

Systems and methods in accordance with this invention also include or provide a trusted authority including a value store used to store value owned by users, and an account database including user accounts, each user account associated with a corresponding user and having a list of the stored value that is owned by the corresponding user, wherein the trusted authority is adapted to receive a request from a first user for a code to be associated with a specified value, generate a substantially random code, associate the generated code with the specified value, communicate the generated code to the first user, receive the generated code from a second user, determine if the received code is valid, and if the received code is valid, debit the specified value from the second user's account and credit the specified value to the first user's account to transfer ownership of the specified value from the second user to the first user.

### BRIEF DESCRIPTION OF THE DRAWINGS

Features of the present invention can be more clearly understood from the following detailed description considered in conjunction with the following drawings, in which the same reference numerals denote the same elements throughout, and in which:

FIG. 1 is a block diagram of an exemplary system in accordance with this invention;

FIG. 2 is a block diagram of an exemplary trusted authority in accordance with this invention;

FIG. 3 is a block diagram of an exemplary code generator in accordance with this invention;

FIG. 4 is a diagram of an exemplary account database in accordance with this invention;

FIG. 5 is a diagram of an exemplary code database in accordance with this invention;

FIG. 6 is a diagram of an exemplary user interface sign-on page in accordance with this invention;

FIG. 7 is a diagram of an exemplary user interface home page in accordance with this invention;

FIG. 8 is a diagram of an exemplary user interface linked external accounts page in accordance with this invention;

FIGS. 9A-9D are diagrams of exemplary user interface link external account pages in accordance with this invention;

FIGS. 10A-10E are diagrams of exemplary user interface external account transfer pages in accordance with this invention;

FIG. 11 is a diagram of exemplary transfers of value between external accounts, trusted authority and users in accordance with this invention;

FIGS. 12A-12D are other diagrams of an exemplary account database in accordance with this invention;

FIG. 13 is another diagram of an exemplary user interface home page in accordance with this invention;

FIG. 14 is diagram of an exemplary user interface account balance page in accordance with this invention;

FIGS. 15A-15C are diagrams of exemplary user interface pages for requesting a payment code associated with currency value in accordance with this invention;

FIG. 16 is a diagram of an exemplary account database in accordance with this invention following the transactions illustrated in FIGS. 15A-15C;

FIGS. 17A-17C are diagrams of exemplary user interface pages for requesting an invoice code associated with currency value in accordance with this invention;

FIG. 18 is a diagram of an exemplary account database in accordance with this invention following the transactions illustrated in FIGS. 17A-17C;

FIGS. 19A-19C are diagrams of exemplary user interface pages for requesting a return payment code associated with service value in accordance with this invention;

FIG. 20 is a diagram of an exemplary account database in accordance with this invention following the transactions illustrated in FIGS. 19A-19C;

FIGS. 21A-21C are diagrams of exemplary user interface pages for requesting a return invoice code associated with product value in accordance with this invention;

FIG. 22 is a diagram of an exemplary account database in accordance with this invention following the transactions illustrated in FIGS. 21A-21C;

FIG. 23 is a diagram of an exemplary code database following the transactions of FIGS. 15A-15C, 17A-17C, 19A-19C and 21A-21C;

FIG. 24 is another diagram of an exemplary user interface home page in accordance with this invention;

FIGS. 25A-25B are diagrams of exemplary user interface pages for submitting a payment code in accordance with this invention;

FIG. 26 is a diagram of an exemplary account database following the transaction of FIGS. 25A-25B;

FIGS. 27A-27C are diagrams of exemplary user interface pages for submitting an invoice code in accordance with this invention;

FIG. 28 is a diagram of an exemplary account database following the transactions of FIGS. 27A-27C;

FIGS. 29A-29B are diagrams of exemplary user interface pages for submitting a first return payment code in accordance with this invention;

FIG. 30 is a diagram of an exemplary account database following the transactions of FIGS. 29A-29B;

FIG. 31 is a diagram of an exemplary user interface page for submitting a second return payment code in accordance with this invention;

FIG. 32 is a diagram of an exemplary account database following the transaction of FIG. 31;

FIGS. 33A-33B are diagrams of exemplary user interface pages for submitting a first return invoice code in accordance with this invention;

FIG. 34 is a diagram of an exemplary account database following the transactions of FIGS. 33A-33B;

FIG. 35 is a diagram of an exemplary user interface page for submitting a second return invoice code in accordance with this invention;

FIG. 36 is a diagram of an exemplary account database following the transaction of FIG. 35;

FIG. 37 is a diagram of an exemplary payment code transfer in accordance with this invention;

FIG. 38 is a diagram of an exemplary invoice code transfer in accordance with this invention;

FIG. 39 is a diagram of an exemplary return payment code transfer in accordance with this invention;

FIG. 40 is a diagram of an exemplary return invoice code transfer in accordance with this invention;

FIG. 41 is a diagram of an exemplary process implemented by trusted authority for a payment code transfer in accordance with this invention;

FIG. 42 is a diagram of an exemplary process implemented by trusted authority for an invoice code transfer in accordance with this invention;

FIGS. 43A-43B are diagrams of an exemplary process implemented by trusted authority for a return payment code transfer in accordance with this invention; and

FIGS. 44A-44B are diagrams of an exemplary process implemented by trusted authority for a return invoice code transfer in accordance with this invention.

### DETAILED DESCRIPTION

Systems and methods in accordance with this invention may be used to transfer value between users using substantially random codes that are associated with the values to be transferred.

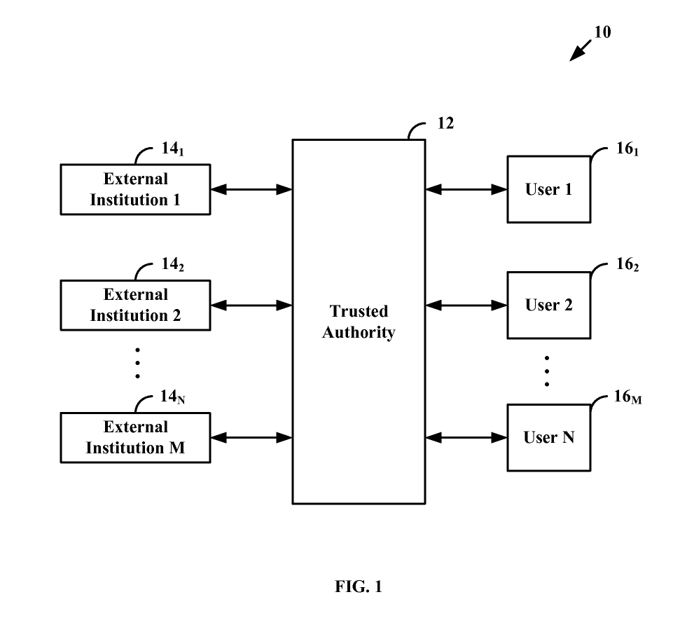

Referring now to FIG. 1, an exemplary value transfer system 10 in accordance with this invention is described. Value transfer system 10 includes a trusted authority 12 coupled to external institutions 14 and users 16. Trusted authority 12 enables users 16 to create individual user accounts (“TA Accounts”) that may be used to store value. Users 16 may link their TA accounts with the users' accounts at external institutions 14 (“external accounts”), transfer value between their external accounts and TA accounts, and transfer value to other users 16 using transferable codes (“Codes”) that are generated by trusted authority 12 and that are associated with the value to be transferred.

In particular, users 16 may request payment Codes (“P-Codes”) and/or invoice Codes (“I-Codes”) from trusted authority 12 to transfer value between users' TA accounts. Specifically, the Codes may be used to transfer value from the TA account of a first user 16 (referred to herein as a “Payer”) to the TA account of a second user 16 (referred to herein as a “Payee”). For example, a Payer may request a P-Code from trusted authority 12 to transfer a specified value to a Payee. The Payer communicates the P-Code to the Payee, who submits the P-Code to trusted authority 12. If the P-Code is valid (e.g., it has not previously been submitted for payment), trusted authority 12 debits the specified value from the Payer's TA account, and credits the specified value to the Payee's TA account.

Alternatively, the Payee may request an I-Code to receive a specified value from the Payer. The Payee communicates the I-Code to the Payer, who submits the I-Code to trusted authority 12. If the I-Code is valid (e.g., it has not previously been submitted for payment), trusted authority 12 debits the specified value from the Payer's TA account, and credits the specified value to the Payee's TA account. For added security, Payers may request return payment Codes (“RP-Codes”), and Payees may request return invoice Codes (“RI-Codes”). Additional details about the use of the various Code types will be described below.

Trusted authority 12 may be implemented by a financial institution, such as a traditional bank, savings and loan, credit union, or other similar traditional financial institution, or may be implemented by an individual, a corporation, a non-profit entity, an association, a government agency, or other similar person or institution. External institutions 14 may be financial institutions, escrow agents, service providers, or other similar institutions or combinations of such institutions. Users 16 may be individuals, groups, organizations, merchants, vendors, suppliers, or other similar users or combinations of such users.

External institutions 14 and users 16 may communicate with trusted authority 12 via a local area network, wide area network, public switched telephone network, cellular network, cable television network, satellite network, wireless network, the Internet, or combinations of such networks. External institutions 14 may communicate with trusted authority 12 via a first network, and users 16 may communicate with trusted authority via a second network that is the same or different from the first network. For simplicity, the remaining description refers to communications between trusted authority 12 and external institutions 14 and users 16 via the Internet. Such communications are preferably via secure connections, such as an SSL encrypted secure network connection or other similar secure connection.

### Trusted Authority

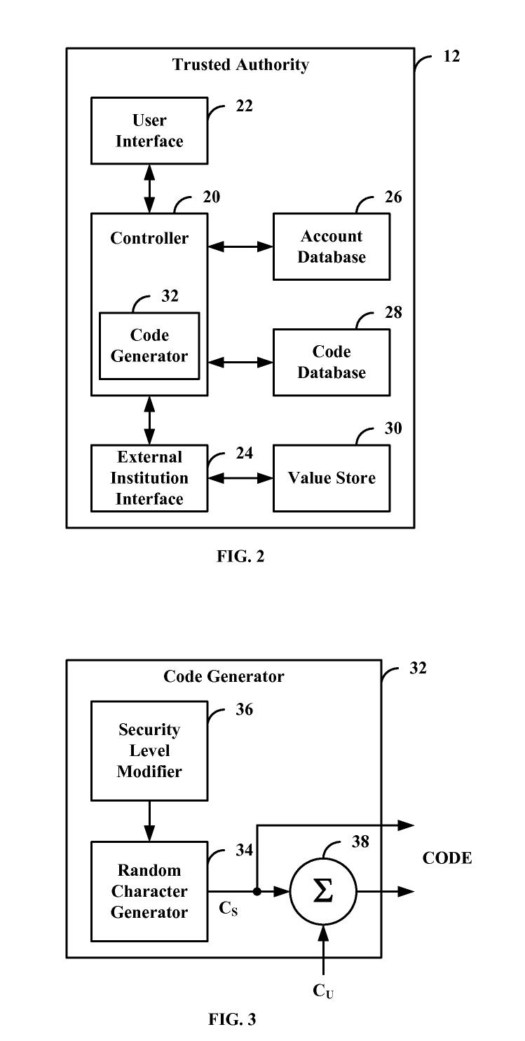

Referring now to FIG. 2, an exemplary embodiment of trusted authority 12 is described. Trusted authority 12 includes a controller 20, a user interface 22, an external institution interface 24, an account database 26, a code database 28 and a value store 30. Controller 20 may be a personal computer, laptop computer, mainframe computer, computer server, handheld computer, or other similar computing device. Controller 20 may include a computer-readable medium (not shown) having computer executable instructions for performing methods in accordance with invention. Controller 20 may include a code generator 32 for generating Codes that are requested by users 16 and are associated with value that may be transferred between users' TA accounts in accordance with this invention.

As described in more detail below, user interface 22 permits users 16 to create TA accounts, link TA accounts to external accounts at external institutions 14, transfer value between TA accounts and external accounts, and transfer value to other users 16 using Codes associated with the specified value. External institution interface 24 permits trusted authority 12 to transfer value between TA accounts and external accounts at external institutions 14.

Account database 26 stores data associated with TA accounts, and code database 28 stores data related to Codes that are generated by code generator 32 and that are associated with value that may be transferred between users' TA accounts. Account database 26 and code database 28 may be stored in computer memory (not shown), such as a hard drive, floppy drive, optical disc, magnetic memory, random access memory, flash memory, or other similar memory device. Account database 26 and code database 28 may be stored in a single memory device or multiple memory devices, and may include a single database or multiple databases. As described in more detail below, value store 30 stores value, indicia of value or indicia of ownership of value transferred to or from TA accounts. Value store 30 may be a vault, financial account, electronic database, warehouse, or other similar repository of value or combination of such repositories.

Various components of trusted authority 12 may be combined. For example, controller 20 may include hardware and/or software for implementing user interface 22 and/or external institution interface 24. In addition, one or more components of trusted authority 12 may be located at a single location, or may be distributed across multiple locations. For example, controller 20 may be implemented in multiple server computers distributed over a first geographic region, and value store 30 may be implemented in multiple value repositories distributed over a second geographic region. The first and second geographic regions may be the same or may be different from one another.

Referring now to FIG. 3, and exemplary code generator 32 is described. Code generator 32 includes a random character generator 34, and may optionally include a security level modifier 36 and a code combiner 38. Random character generator 34 may include a conventional hardware and/or software random number generator as is known in the art. At the direction of controller 20, random character generator 34 generates a random system code CS that may include a predetermined number of characters, such as numbers, letters, special characters (e.g., *, %, #, +, etc.) or other similar characters. System code CS need not include any information that may be used to identify the user 16 who requested the Code, or the value associated with system code CS. Persons of ordinary skill in the art will understand that in addition to, or alternative to generating characters, code generator 32 may generate system codes CS that include bar codes, audio codes, binary codes, Braille codes, semaphore flag codes, or other similar codes.

Controller 20 may use optional security level modifier 36 to control the number of characters or other similar parameter of system code CS to control the security of the created system code CS. For example, the length of system code CS may be increased to reduce the probability that a rogue user may guess the codes. System code CS may be output directly as a Code, or optionally may be combined with a user-specified code CU using optional code combiner 38. Code combiner 38 may concatenate the CS and CU characters, may intersperse the CS and CU characters, or may perform more complex combinations and/or manipulations of the CS and CU characters.

Referring again to FIG. 2, user interface 22 may include hardware and/or software that enables users 16 to create TA Accounts, link TA accounts with accounts at external institutions 14, transfer value between TA accounts and external accounts, and transfer value to other users 16 using Codes associated with the specified value. For example, user interface 22 may include a web server that hosts web pages that may be accessed by users 16 via web browsers running on personal computers, laptop computers, handheld computers, web-enabled cell phones, and other similar computer devices. Additionally, or alternatively, user interface 22 may include a telephone interface, email interface, text message interface, human interface or other similar interface that permits users 16 to access TA Accounts as described above. For simplicity, user interface 22 will be described in the remaining description as a web interface.

External institution interface 24 may include hardware and/or software that enables trusted authority 12 to transfer value between TA accounts and external accounts. For example, external institution interface 24 may include hardware and/or software for implementing electronic funds transfer protocols, wire transfer protocols, or other similar funds transfer protocols. Additionally, or alternatively, external institution interface 24 may include hardware and/or software that may be used to transfer non-currency value between TA accounts and external accounts. For example, external institution interface 24 may include hardware and/or software for initiating product shipments via a postal service, courier service (e.g., UPS, FEDEX, DHL), or other similar product delivery service. Additionally, or alternatively, external institution interface 24 may include a telephone interface, email interface, text message interface, human interface or other similar interface that permits the transfer of value between TA accounts and external accounts.

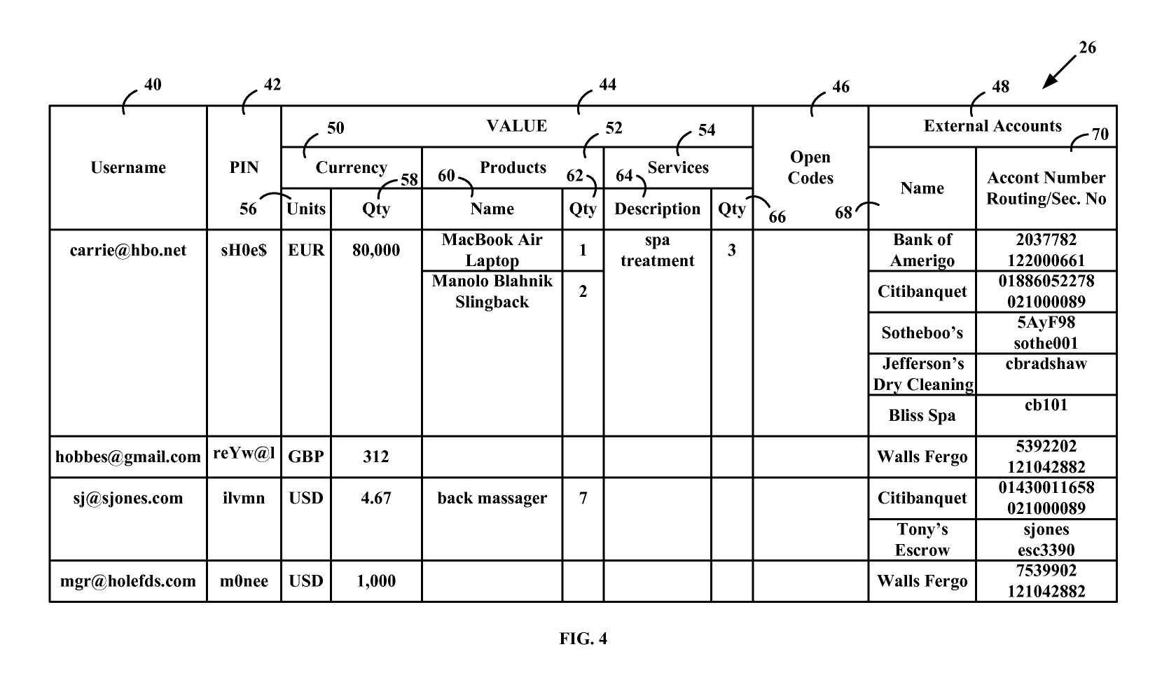

Referring now to FIG. 4, an exemplary account database 26 is described. Account database 26 includes data associated with users' TA accounts. For example, account database 26 includes a username field 40 that stores usernames associated with each TA account, a personal identification number (“PIN”) field 42 that stores a PIN or other similar security code associated with each TA account that is selected by the user 16 during the TA account setup process, a value field 44 that stores information regarding the value in each TA account, an open Codes field 46 that stores open Codes that have been requested for each TA account, and linked external accounts field 48 that stores information regarding external accounts linked with each TA account. Persons of ordinary skill in the art will understand that account databases 26 in accordance with this invention may include more, fewer, and/or different fields than the exemplary fields illustrated in FIG. 4.

The value stored in TA accounts may include any of currency, products, and/or services, and/or other similar value. Accordingly, account database 26 may include value subfields for currency 50, products 52 and services 54. Each value subfield includes a designator and a quantity. In the illustrated embodiment, the value designators for currency, products and services are “units,” “name,” and “description,” respectively. Thus, currency 50 may include subfields for units 56 and quantity 58, products 52 may include subfields for name 60 and quantity 62, and services 54 may include subfields for description 64 and quantity 66. Similarly, external accounts 48 may include subfields for the name 68 and account number and routing/security number 70 associated with the external account.

The exemplary account database 26 illustrated in FIG. 4 includes data associated with four separate TA accounts having corresponding usernames: carrie@hbo.net, hobbes@gmail.com, sj@sjones.com, and mgr@holefds.com. Username carrie@hbo.net has: (1) an associated PIN “sH0e$;” (2) associated value: (a) EUR 80,000, (b) one MacBook Air laptop computer, (c) two pairs of Manolo Blahnik slingback shoes, and (d) credit for three spa treatments; and (3) linked external accounts at (a) Bank of Amerigo, (b) Citibanquet, (c) Sotheboo's auction house, (d) Jefferson's Dry Cleaners, and (e) Bliss Spa. In contrast, username mgr@holefds.com has (1) an associated PIN “monee;” (2) an associated value of USD 1,000; and (3) a linked external account at Walls Fergo bank.

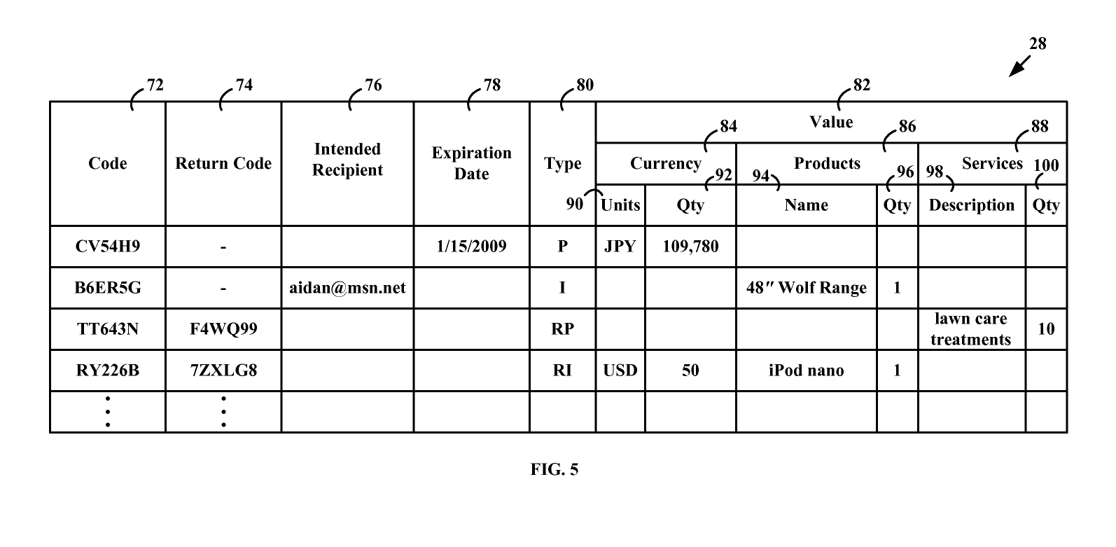

Referring now to FIG. 5, an exemplary code database 28 is described. Code database 28 includes data associated with “open” Codes, i.e., Codes that have been requested by users 16, but that have not yet been successfully submitted to trusted authority 12 to transfer value from a Payer's TA account to a Payee's TA account. For example, code database 28 includes a code field 72 that stores open Codes, and a return code field 74 stores any corresponding return Code. As described in more detail below, when requesting a Code, users 16 may specify an intended recipient and/or an expiration date for the Code. Thus, intended recipient field 76 stores information identifying any specified intended recipient associated with the Code, and expiration date field 78 stores information regarding any specified expiration date associated with the Code. Type field 80 stores descriptors for identifying the type of Code (e.g., “P” for P-Codes, “I” for I-Codes, “RP” for RP-Codes, and “RI” for RI-Codes. Person of ordinary skill in the art will understand that other similar descriptors may be used to identify Code types.

Code database 28 also includes a value field 82, which may be used to store information describing the value associated with the Code. Value field 82 may include value subfields for currency 84, products 86 and services 88. Further, currency field 84 may include subfields for units 90 and quantity 92, products subfield 86 may include subfields for name 94 and quantity 96, and services subfield 88 may include subfields for description 98 and quantity 100.

The exemplary code database 28 illustrated in FIG. 5 include six Codes: (1) CV54H9, which is a P-Code having an expiration date of Jan. 15, 2009, and an associated value of JPY 109,780; (2) B6ER5G, which is an I-Code having an intended recipient of aidan@msn.net, and an associated value of one 48″ Wolf range; (3) TT643N and (4) F4WQ99, which are first and second RP-Codes having an associated value of 10 lawn care treatments; and (5) RY226B and (6) 7ZXLG8, which are first and second RI-Codes having an associated value of USD 50 and one iPod nano. Thus, persons of ordinary skill in the art will understand that Codes may be associated with one or more categories of value, or one or more types of value within a category.

### User Interface

As described above in connection with FIG. 2, user interface 22 may be a web interface that enables users 16 to create TA Accounts, link TA accounts with accounts at external institutions 14, transfer value between TA accounts and external accounts, and request and submit Codes for transferring value to other users 16 using Codes generated by trusted authority 12. An exemplary web interface will now be described that illustrates each of these activities for each of the various exemplary forms of value.

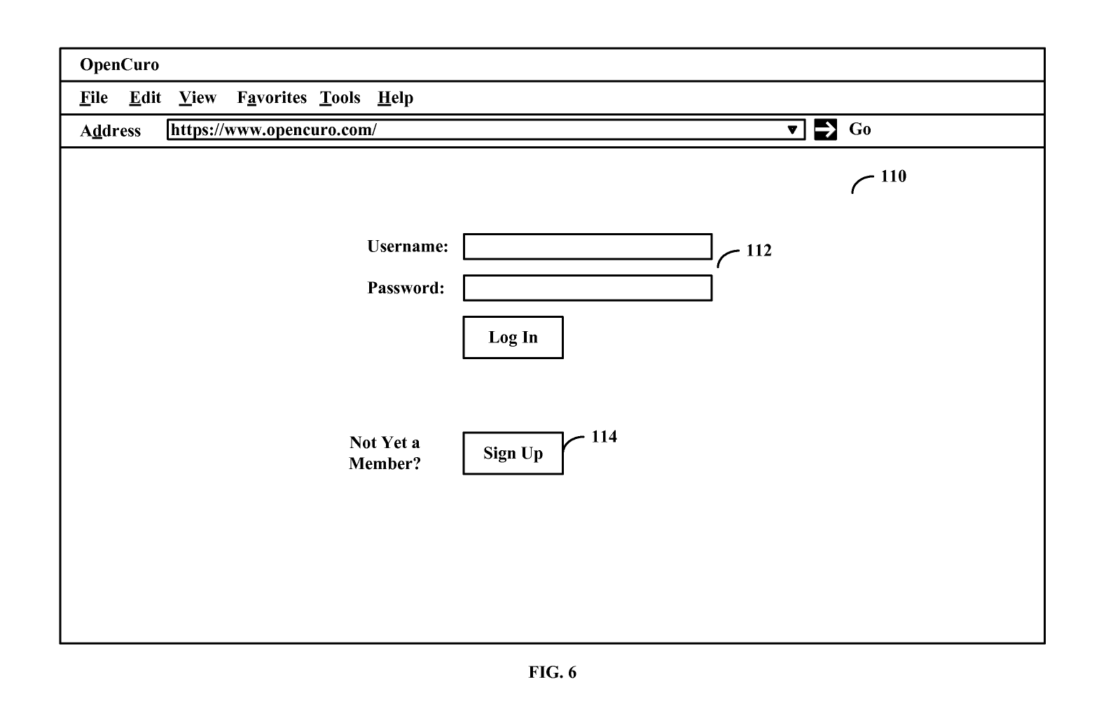

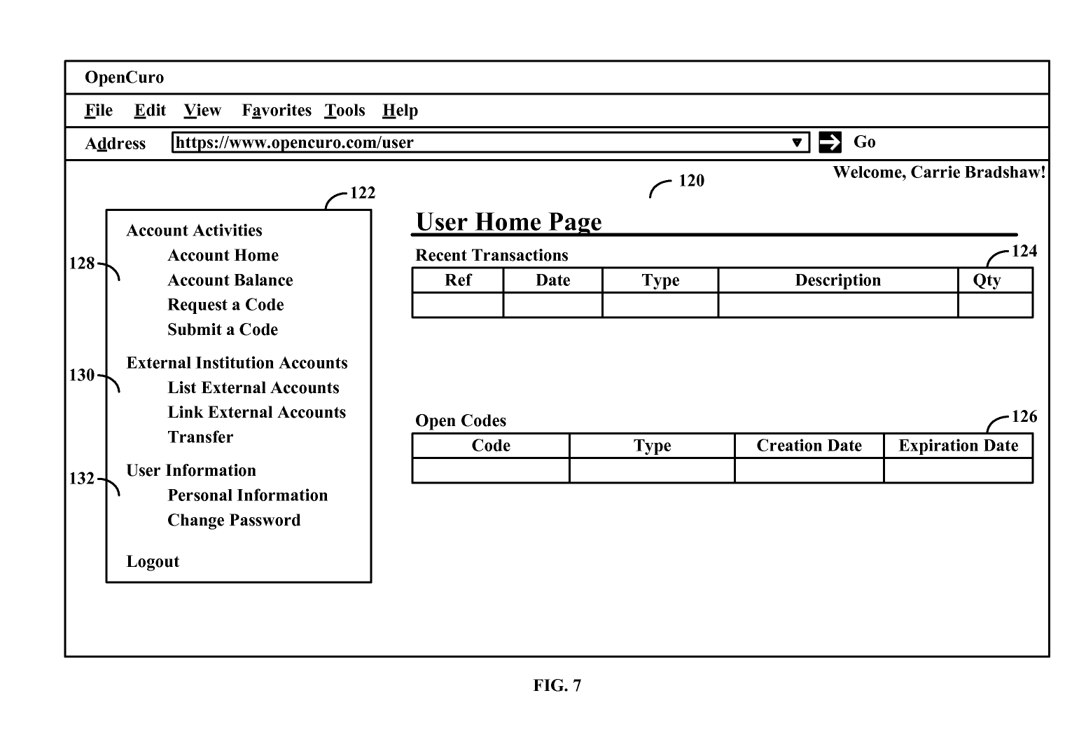

Users 16 may access web interface 22 via a conventional web browser, such as Internet Explorer, Firefox, Safari, Opera, or other similar web browser. Referring now to FIG. 6, an exemplary user sign-on page is described. Exemplary sign-on page 110 includes a user log-in section 112, which includes data entry fields for entering user identification information (e.g., a username, account number, etc.), and verification information (e.g., a password). Additionally, sign-on page 110 may include a sign-up section 114 to allow users 16 to create a TA Account. As part of the account setup-process, users 16 may be required to select a PIN or other similar security code. Persons of ordinary skill in the art will understand that sign-on page 110 may include more or less information than illustrated in FIG. 6, and may require that users 16 provide additional identification information (e.g., a token-generated password, or other similar security information).

After a user 16 has successfully signed into the system, web interface 22 may display a user home page, such as the exemplary user home page 120 illustrated in FIG. 7 for user “carrie@hbo.net.” Exemplary home page 120 includes a navigation pane 122, a “Recent Transactions” table 124 and an “Open Codes” table 126. Navigation pane 122 includes hyperlinks to web pages related to TA account management activities 128, external accounts management activities 130, and user information management activities 132. Hyperlinks pertaining to external account management activities 130 may be used to list linked external accounts, link TA accounts to external accounts, and transfer value between TA accounts and external accounts. Persons of ordinary skill in the art will understand that navigation pane 122 may include more, fewer and/or different hyperlinks than the exemplary hyperlinks illustrated in FIG. 7.

For currency value, a user 16 may fund her TA account through cash payment, money order, check, credit card payment, bank transfer, or similar method, or combination of such methods. Persons of ordinary skill in the art will understand that each funding method may require additional security measures specific to that method. For example, a user 16 may be required to link a bank account, confirm micro-deposits to prove she has control of the account, and/or to provide any number of additional forms of identification. Such security measures may be implemented within the framework of the trusted authority 12, as would be understood by a person of ordinary skill in the art.

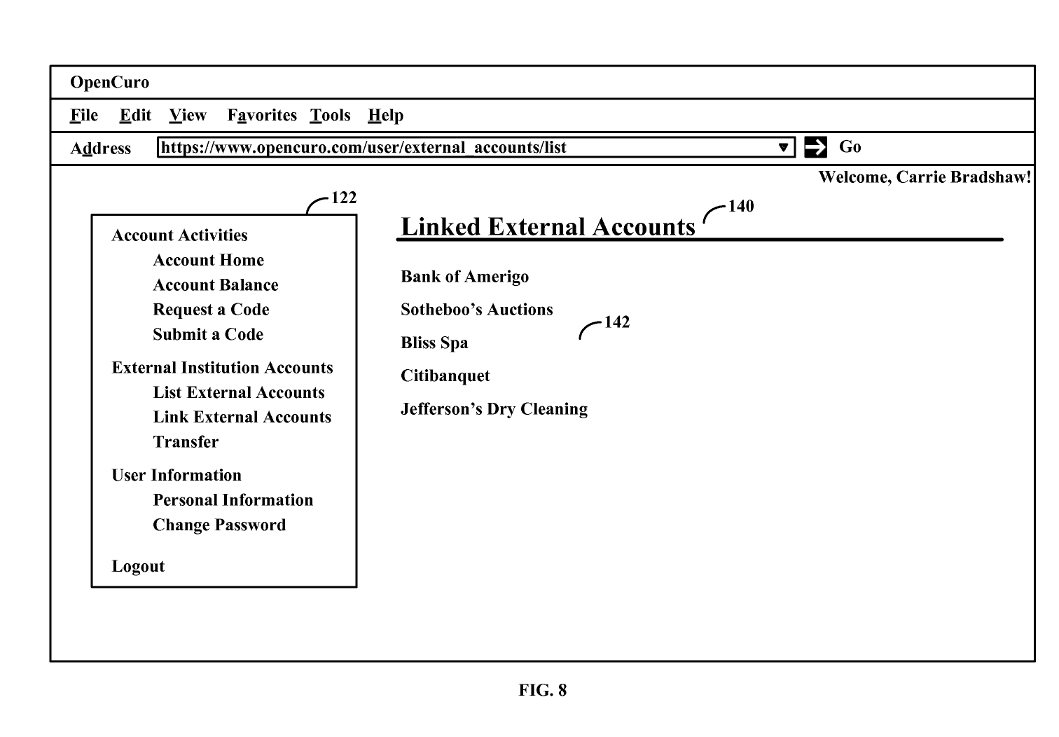

Referring now to FIG. 8, by selecting the “List External Accounts” hyperlink in navigation pane 122, a “Linked External Accounts” web page 140 is displayed that includes a list 142 of the user's linked external accounts. In the illustrated example, user carrie@hbo.net has linked her TA account to external accounts at two banks (Bank of Amerigo and Citibanquet), an auction house (Sotheboo's) and two service providers (Bliss Spa and Jefferson's Dry Cleaning).

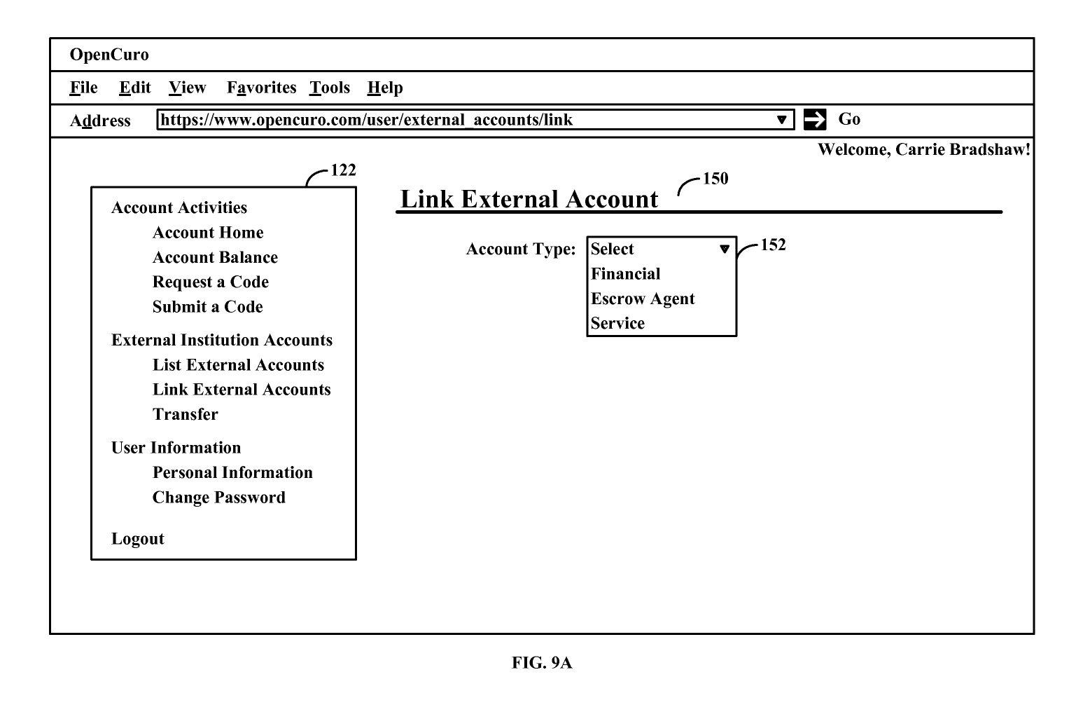

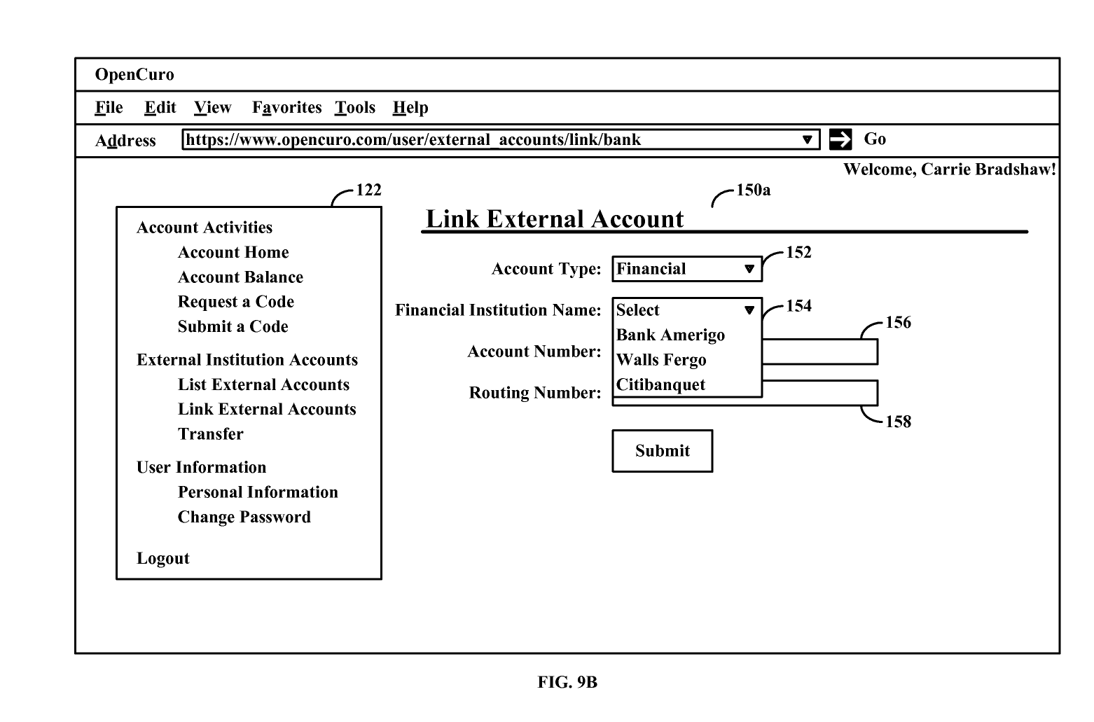

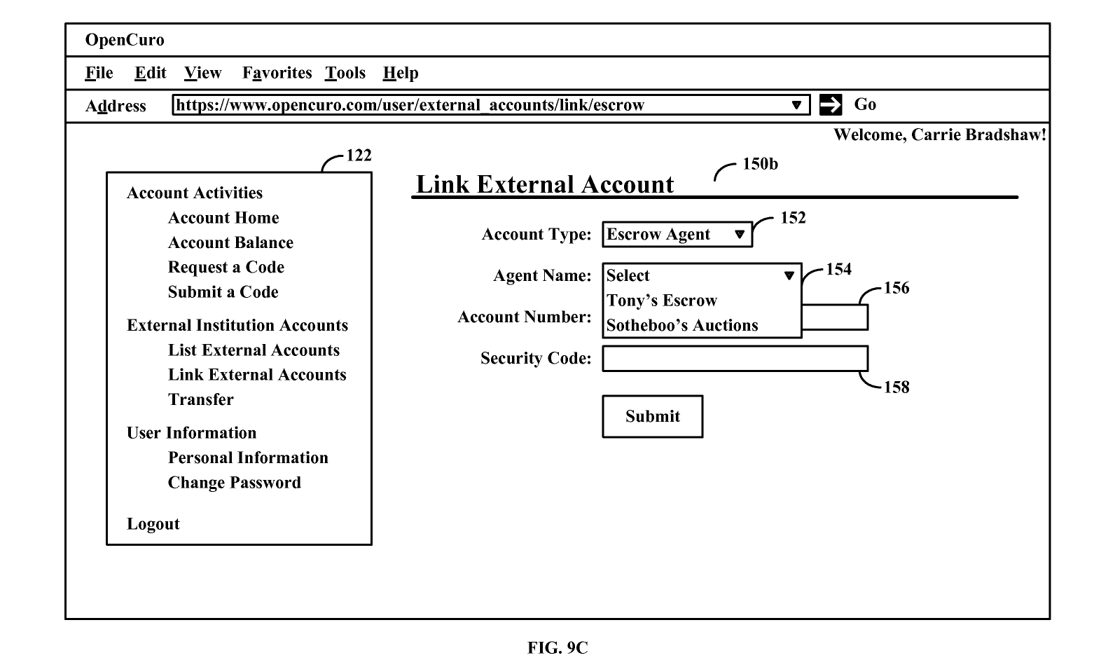

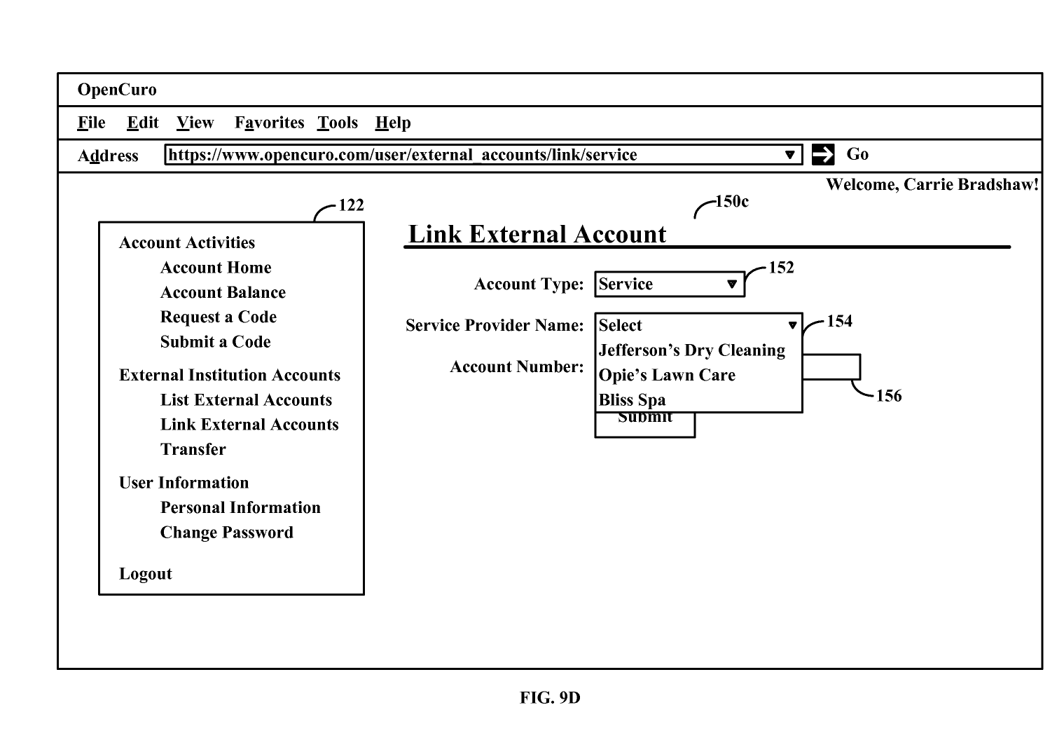

A “Link External Accounts” hyperlink in navigation pane 122 may be used to link the user's TA accounts to her external accounts. For example, FIG. 9 illustrates exemplary web pages that may be used to link a TA account to an external account. In FIG. 9A, an exemplary “Link External Account” web page 150 includes a drop-down list 152 of external account types, such as financial institutions, escrow agents, and service providers. Persons of ordinary skill in the art will understand that systems in accordance with this invention may use more or less than three different account types, and may use account types different from the exemplary account types illustrated in FIG. 9A.

As shown in FIG. 9B, if a user 16 selects a financial institution account type from drop-down list 152, web page 150a may display a financial institution name drop-down list 154 that includes names of various financial institutions whose accounts may be linked to TA accounts. Exemplary financial institutions may include banks, credit unions, mutual funds, discount brokerages, retirement plans and other similar financial institutions or combinations of such institutions. Web page 150a also may display data entry fields for providing an account number 156 and a routing number 158 associated with the user's account at the specified financial institution. Persons of ordinary skill in the art will understand that data entry fields may be provided for information different from and/or in addition to account number 156 and routing number 158. In addition, persons of ordinary skill in the art will understand that web page 150a alternatively may not use a financial institution name drop-down list 152, but may provide some other form of data entry field by which a user 16 may specify a financial institution to link to her TA account.

As shown in FIG. 9C, if a user 16 selects an escrow agent account type from drop-down list 152, web page 150b may display an escrow agent name drop-down list 154 that includes names of various escrow agents whose accounts may be linked to TA accounts. Exemplary escrow agents may include auction houses, certified escrow agents, title companies and other similar escrow agents or combinations of such agents. Web page 150b also may display data entry fields for providing an account number 156 and a security code 158 associated with the user's account at the specified escrow agent. Persons of ordinary skill in the art will understand that data entry fields may be provided for information different from and/or in addition to account number 156 and security code 158. In addition, persons of ordinary skill in the art will understand that web page 150b alternatively may not use an escrow agent name drop-down list 154, but may provide some other form of data entry field by which a user 16 may specify an escrow agent institution to link to her TA account.

As shown in FIG. 9D, if a user 16 selects a service provider account type from drop-down list 152, web page 150c may display a service provider name drop-down list 154 that includes names of various service providers whose accounts may be linked to TA accounts. Exemplary service providers may include dry cleaners, housekeepers, gardeners, auto mechanics, spas, plumbers and other similar service providers or combinations of such providers. Web page 150c also may display data entry fields for providing an account number 156 associated with the user's account at the specified service provider. Persons of ordinary skill in the art will understand that data entry fields may be provided for information different from and/or in addition to account number 156. In addition, persons of ordinary skill in the art will understand that web page 150c alternatively may not use a service provider name drop-down list 154, but may provide some other form of data entry field by which a user 16 may specify a service provider to link to her TA account.

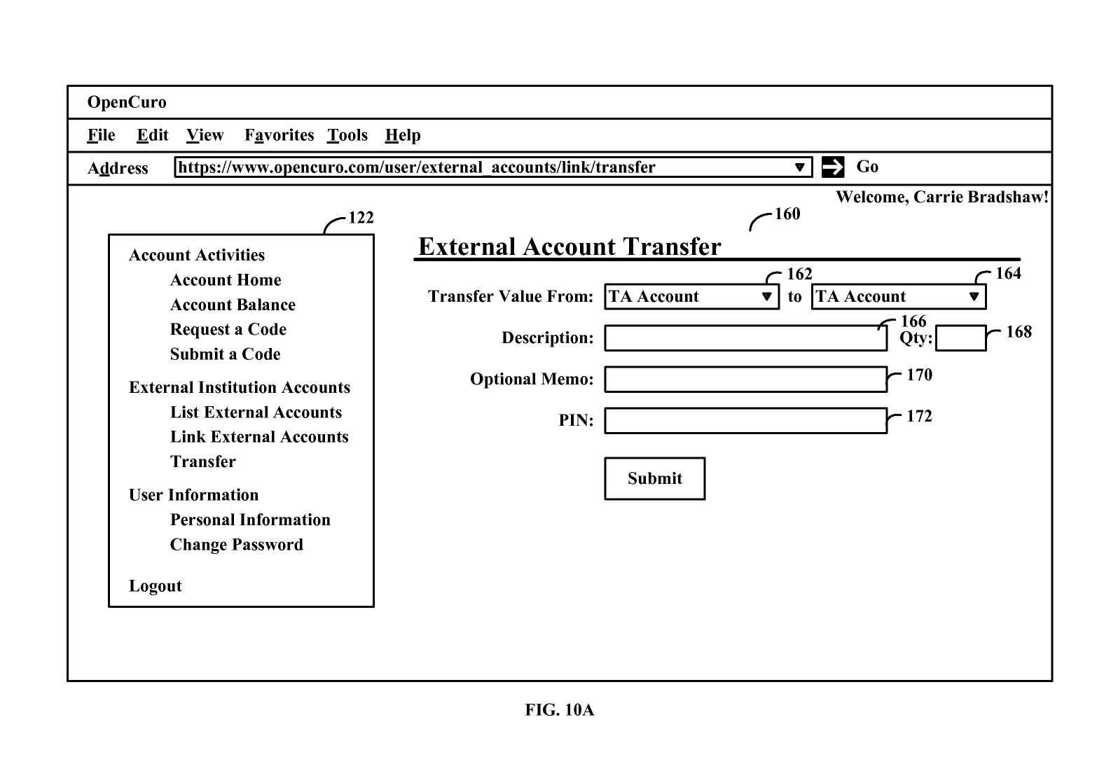

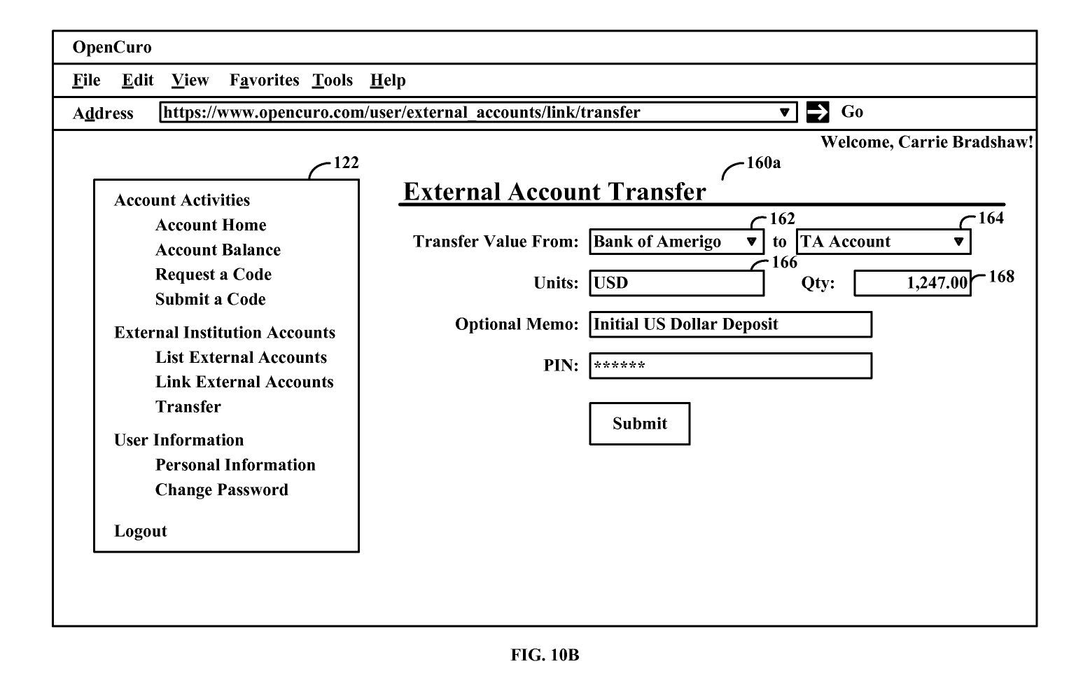

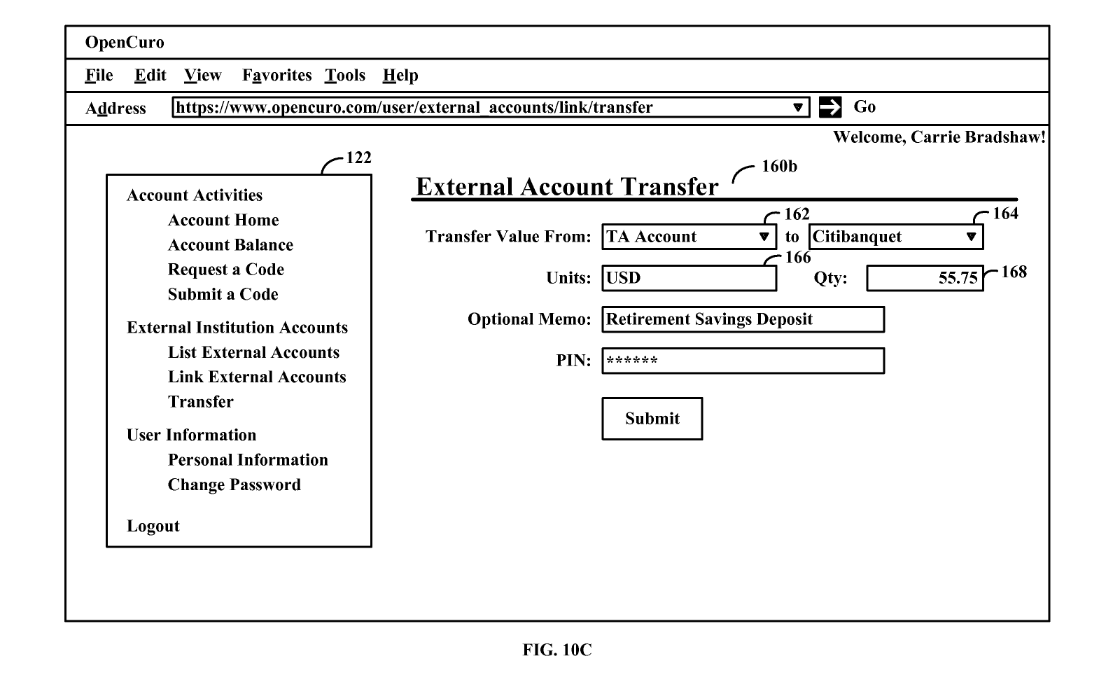

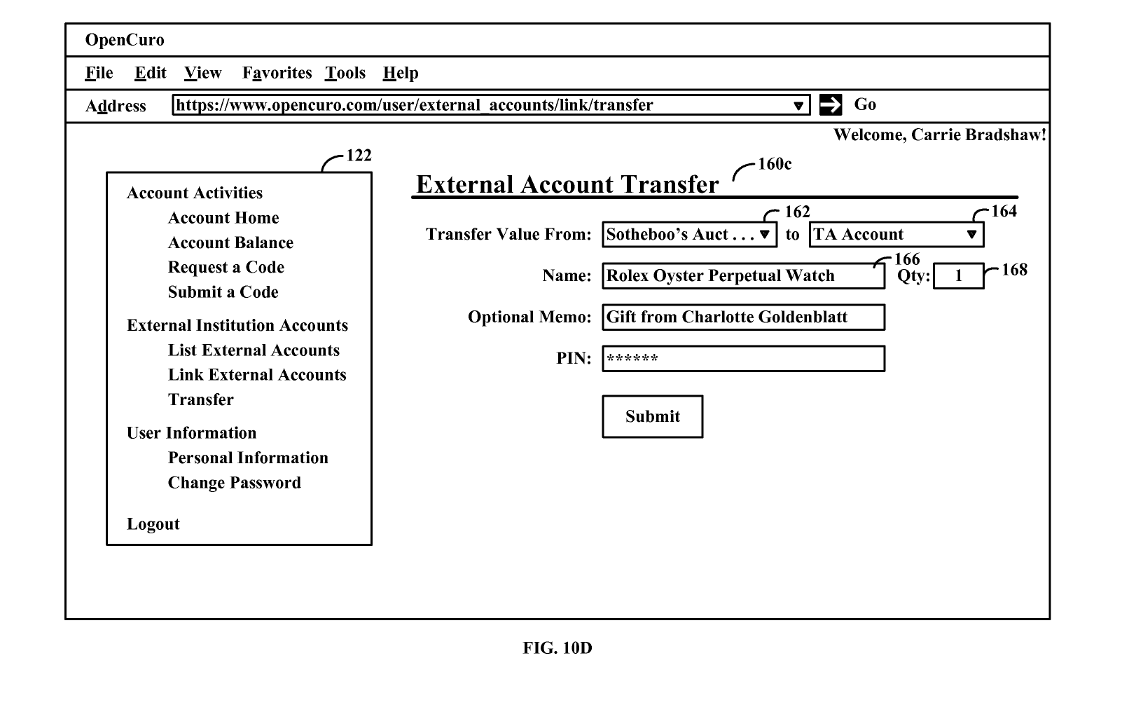

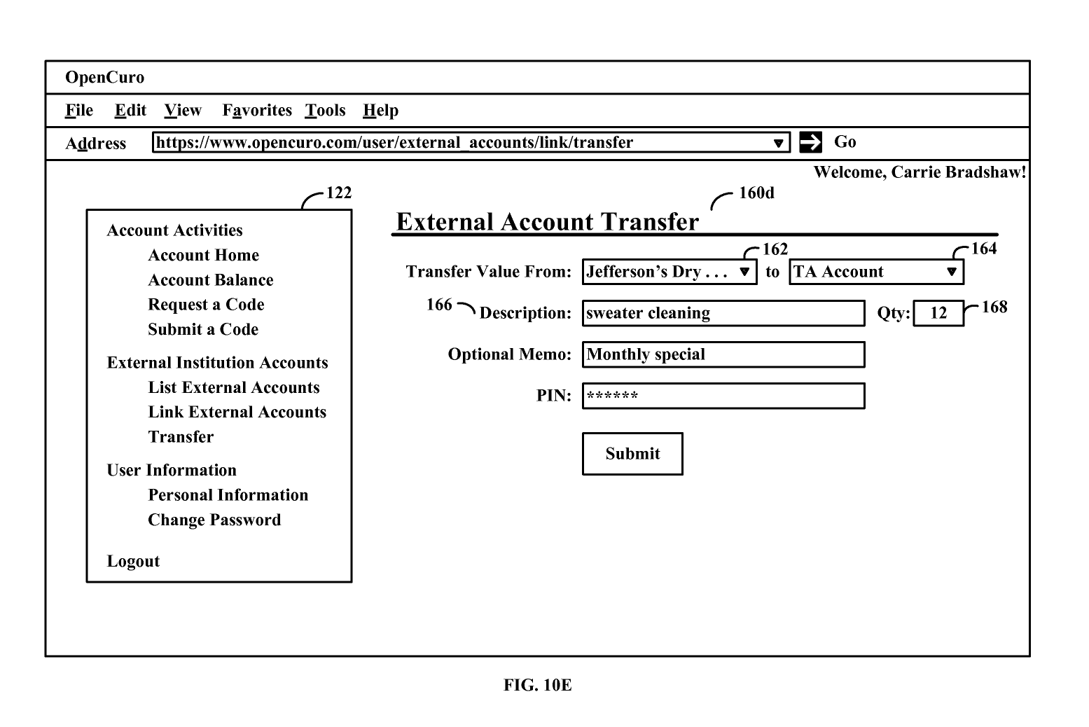

After linking one or more external accounts to TA accounts, a user 16 may use the “Transfer” hyperlink in navigation pane 122 to transfer value between the user's external accounts and her TA accounts. For example, FIGS. 10A-10E illustrate exemplary web pages that may be used by user carrie@hbo.net to transfer value between her external accounts and her TA account. FIG. 10A illustrates an exemplary “External Account Transfer” web page 160 that includes a “From” drop down menu 162 for specifying an account from which value will be transferred, and a “To” drop down menu 164 for specifying an account to which value will be transferred. Web page 160 also includes a description data entry field 166 and a quantity data entry field 168 for specifying the value to be transferred. Further, web page 160 may include an optional memo data entry field 170 for entering a text description of the transfer, and a PIN data entry field 172 for specifying the PIN or other security code that the user 16 created during the TA account setup process.

FIG. 10B illustrates an exemplary External Account Transfer web page 160a in which currency value is transferred from a user's linked bank account to her TA account. In particular, drop down menu 162 indicates that a specified value will be transferred from the user's Bank of Amerigo account, and drop down menu 164 indicates that the specified value will be transferred to the user's TA account. In accordance with this exemplary embodiment, if the external institution specified in either drop down menus 162 or 164 is a financial institution in which value is specified in a currency, External Account Transfer web page 160a will include a units data entry field 166 for specifying currency units, and a quantity data entry field 168 for specifying an amount of the specified currency. In the illustrated example, user carrie@hbo.net has specified a transfer of USD 1,247.00 from her Bank of Amerigo Account to her TA account. Once the user 16 clicks the submit button, the specified value will be transferred from the user's selected external account to value store 30.

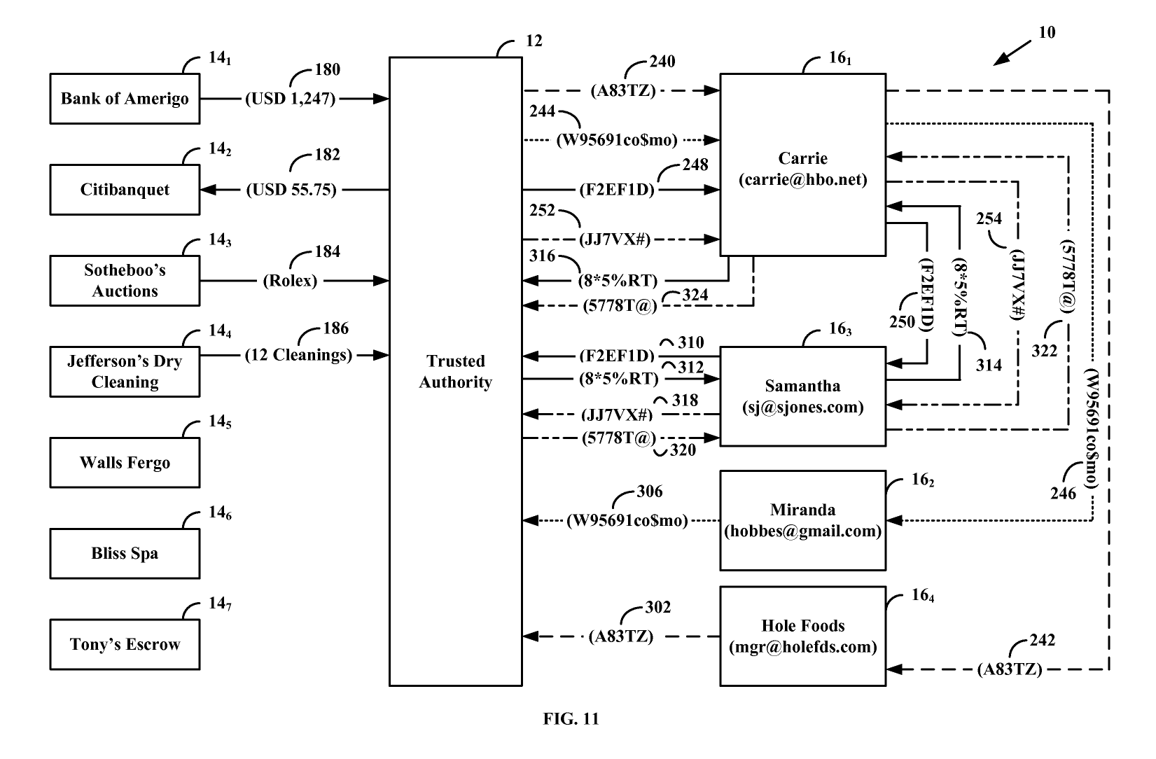

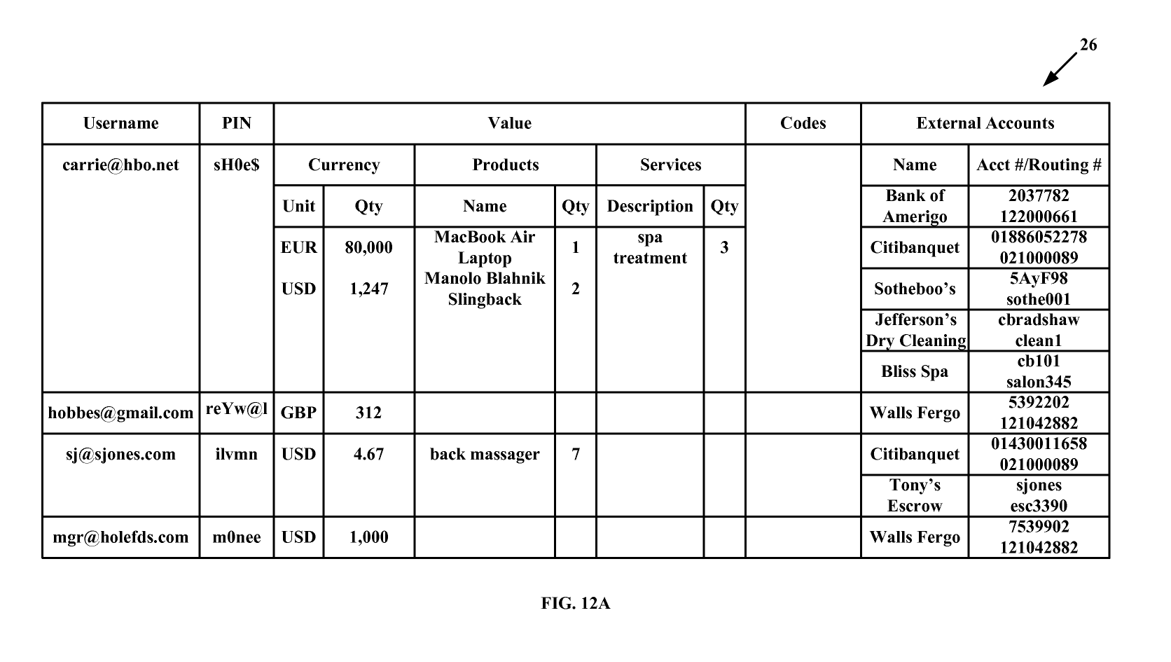

In particular, referring again to FIGS. 2 and 4, external institution interface 24 obtains from account database 26 (via controller 20) the account information associated with the user's TA account and the specified external account. In the example illustrated in FIG. 10B, external institution interface 24 obtains the account number (2037782) and routing number (122000661) of carrie@hbo.net's Bank of Amerigo account from account database 26. Using an electronic funds transfer protocol, or other similar protocol, external institution interface 24 may then initiate a transfer of the specified value (i.e., USD 1,247.00) from the user's Bank of Amerigo account to value store 30. This is illustrated schematically in FIG. 11 as transfer 180 from external institution 141 (Bank of Amerigo) to trusted authority 12.

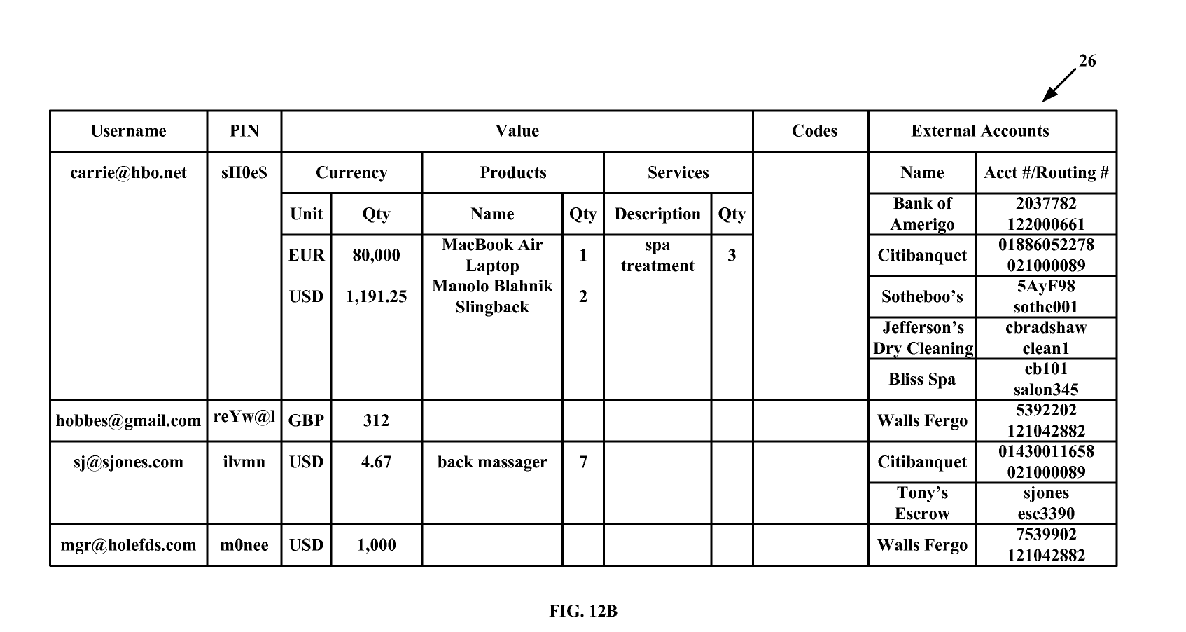

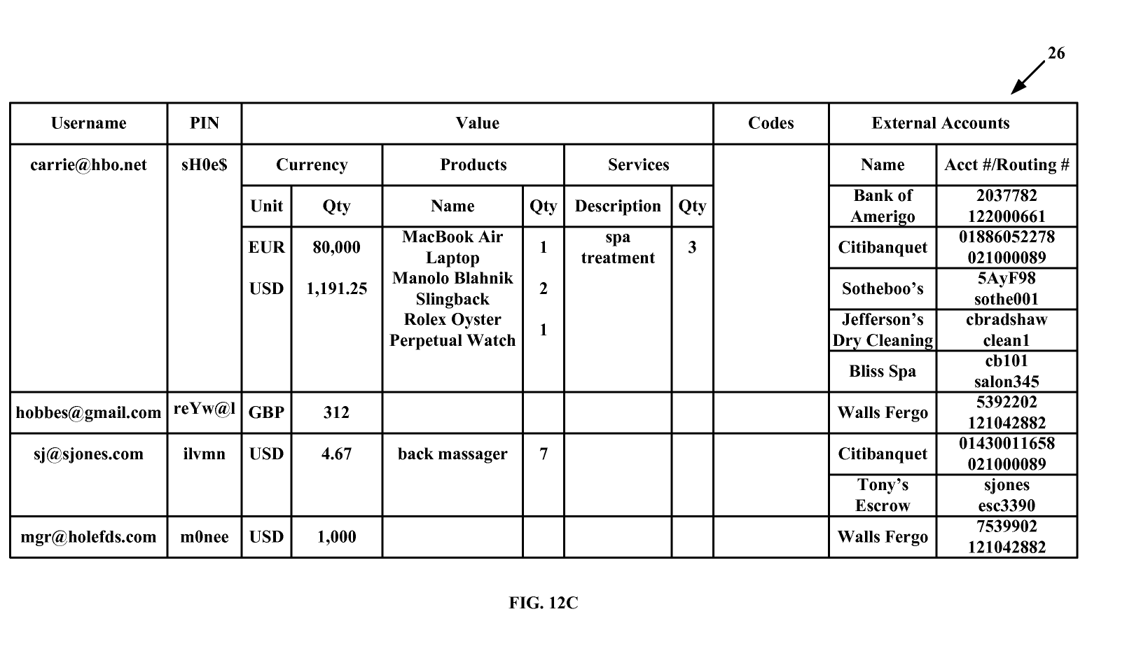

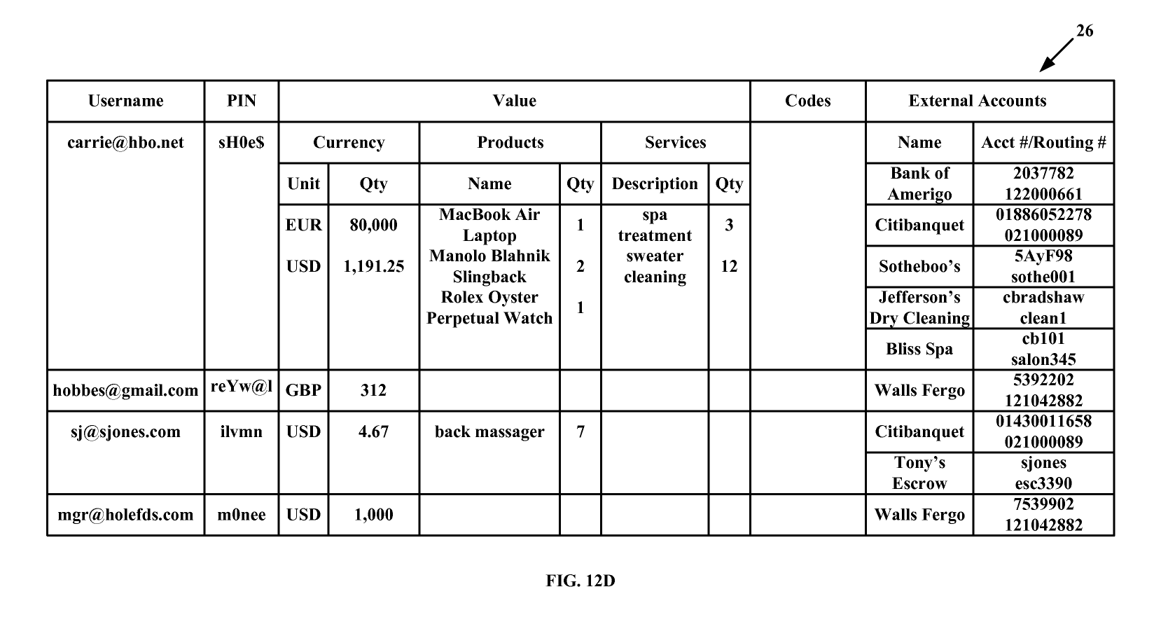

When trusted authority 12 determines that the specified value has been received in value store 30, account database 26 will be updated to reflect the increased value in the user's TA account. Optionally, trusted authority 12 may “float” the user's TA account the value transferred from an external account, trusting that the value will be transferred successfully. As shown in FIG. 12A, account database 26 has been updated to reflect an increase in carrie@hbo.net's currency value by USD 1,247.00.

FIG. 10C illustrates an exemplary External Account Transfer web page 160b in which currency value is transferred from a user's TA account to one of her linked external accounts. In particular, drop down menu 162 indicates that a specified value will be transferred from the user's TA account, and drop down menu 164 indicates that the specified value will be transferred to one of the user's linked external accounts. In the illustrated example, user carrie@hbo.net has specified a transfer of USD 55.75 from her TA Account to her linked Citibanquet account. Once the user 16 clicks the submit button, the specified value will be transferred from value store 30 to the selected linked external account. In addition, account database 26 will be updated to reflect the decreased value in the user's TA account.

In particular, referring again to FIGS. 2 and 4, external institution interface 24 obtains from account database 26 (via controller 20) the account information associated with the user's selected external account. In the example illustrated in FIG. 10C, external institution interface 24 obtains the account number (01886052278) and routing number (021000089) of carrie@hbo.net's Citibanquet account from account database 26. Using an electronic funds transfer protocol, or other similar protocol, external institution interface 24 may then initiate a transfer of the specified value (i.e., USD 55.75) from value store 30 to the user's Citibanquet account. This is illustrated schematically in FIG. 11 as transfer 182 from trusted authority 12 to external institution 142 (Citibanquet). In addition, as shown in FIG. 12B, account database 26 has been updated to reflect a decrease in carrie@hbo.net's currency value by USD 55.75.

FIG. 10D illustrates an exemplary External Account Transfer web page 160c in which product value is transferred from a user's linked external account to her TA account. In particular, drop down menu 162 indicates that a specified value will be transferred from one of the user's external accounts, and drop down menu 164 indicates that the specified value will be transferred to the user's TA account. In the illustrated example, user carrie@hbo.net has specified a transfer of one Rolex Oyster Perpetual Watch from her linked Sotheboo's account to her TA account. Once the user 16 clicks the submit button, the specified value will be transferred from the user's linked external account to value store 30.

In particular, referring again to FIGS. 2 and 4, external institution interface 24 obtains from account database 26 (via controller 20) the account information associated with the user's selected external account. In the example illustrated in FIG. 10D, external institution interface 24 obtains the account number (5AyF98) and security number (sothe001) of carrie@hbo.net's Sotheboo's account from account database 26. Using a product shipment protocol, or other similar protocol, external institution interface 24 may then initiate a transfer of the specified value (i.e., one Rolex Oyster Perpetual Watch) from the user's Sotheboo's account to value store 30. This is illustrated schematically in FIG. 11 as transfer 184 from external institution 143 (Sotheboo's) to trusted authority 12.

When trusted authority 12 determines that the specified value has been received in value store 30, account database 26 will be updated to reflect the increased value in the user's TA account. Thus, as shown in FIG. 12C, account database 26 has been updated to reflect an increase in carrie@hbo.net's products value by one Rolex Oyster Perpetual Watch.

Persons of ordinary skill in the art will understand that product value transfers do not require physical transfer of products between an external institution 14 and value store 30. Instead, a product may remain at an external institution 14, and indicia of ownership of value may be transferred from the external institution 14 to trusted authority 12. In connection with such transfers, indicia of ownership of value (e.g., a deed, title instrument, certificate of ownership, or other similar indicia of ownership) may be transferred from external institution to value store 30.

FIG. 10E illustrates an exemplary External Account Transfer web page 160d in which service value is transferred from a user's linked external account to her TA account. In particular, drop down menu 162 indicates that a specified value will be transferred from one of the user's external accounts, and drop down menu 164 indicates that the specified value will be transferred to the user's TA account. In the illustrated example, user carrie@hbo.net has specified a transfer of twelve sweater cleanings from her linked Jefferson's Dry Cleaning account to her TA account. Once the user 16 clicks the submit button, indicia of the specified value will be transferred from the user's linked external account to value store 30.

In particular, referring again to FIGS. 2 and 4, external institution interface 24 obtains from account database 26 (via controller 20) the account information associated with the user's selected external account. In the example illustrated in FIG. 10E, external institution interface 24 obtains the account number (cbradshaw) of carrie@hbo.net's Jefferson's Dry Cleaning account from account database 26. Using a communication protocol such as a phone call, email message, text message, facsimile message, or other similar communication protocol, external institution interface 24 may then initiate a transfer of indicia of the specified value (e.g., coupons or tokens for twelve sweater cleanings) from the user's Jefferson's Dry Cleaning account to value store 30. This is illustrated schematically in FIG. 11 as transfer 186 from external institution 144 (Jefferson's Dry Cleaning) to trusted authority 12.

When trusted authority 12 determines that indicia of the specified value has been received in value store 30, account database 26 will be updated to reflect the increased value in the user's TA account. Thus, as shown in FIG. 12D, account database 26 has been updated to reflect an increase in carrie@hbo.net's services value by twelve sweater cleanings.

Persons of ordinary skill in the art will understand that methods and systems in accordance with this invention additionally or alternatively may permit a user 16 to transfer value between a user's external account and her TA account even if the external account has not previously been linked to the TA account. For example, a user 16 may be permitted to specify the account type, account name, account number, etc. at the time of the transfer request. Such operation may be desirable for “one-time” transfers between a user's TA account and an external account.

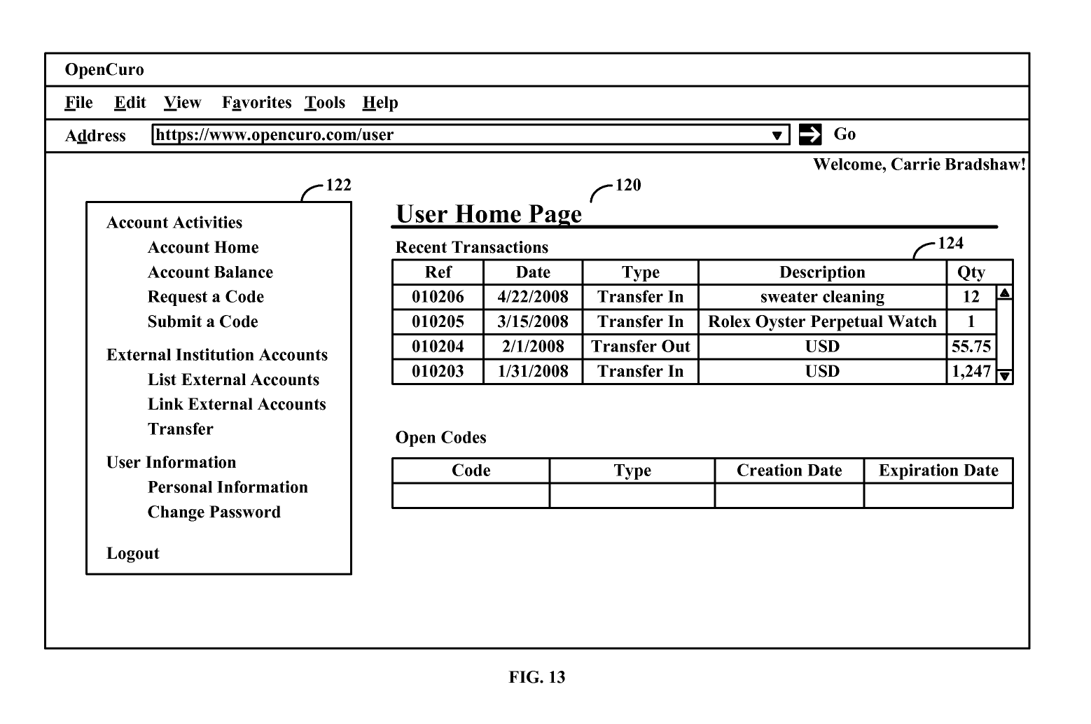

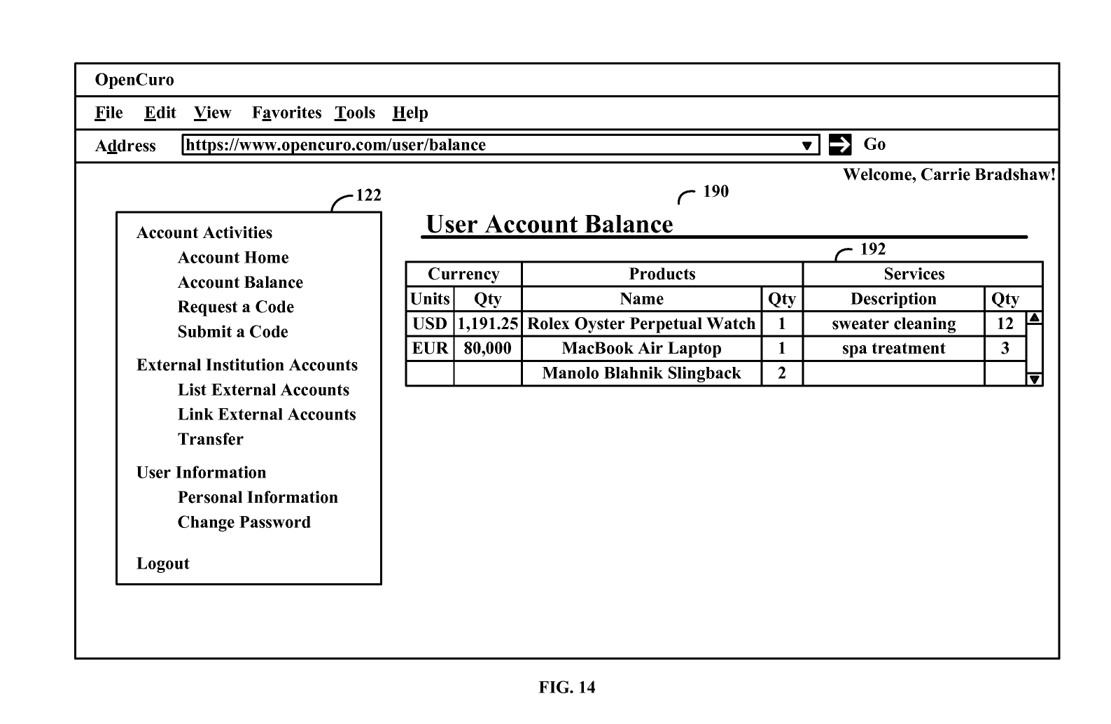

As shown in FIG. 13, if the user 16 selects the “Account Home” hyperlink in navigation pane 122, user home page 120 displays a summary of the foregoing transfers in “Recent Transactions” table 124. Further, as shown in FIG. 14, if the user 16 selects the “Account Balance” hyperlink in navigation pane 122, account balance page 190 displays a summary of the value in the user's TA account in the account balance table 192.

As previously mentioned, web interface 22 may be used by users 16 to transfer value to other users 16 using Codes associated with the specified value. In particular, a Payer may use web interface 22 to request a P-Code from trusted authority 12 that is associated with a specified value. The Payer may communicate the P-Code to a Payee, who may then submit the P-Code to trusted authority 12. If trusted authority 12 determines that the submitted P-Code is valid, and that the Payer's TA account has sufficient funds, trusted authority 12 debits the specified value from the Payer's TA account, and credits the specified value to the Payee's TA account.

Alternatively, the same value transfer may be achieved using I-Codes. In particular, a Payee may use web interface 22 to request an I-Code from trusted authority 12 that is associated with a specified value. The Payee may communicate the I-Code to the a Payer, who may then submit the I-Code to trusted authority 12. If trusted authority 12 determines that the submitted I-Code is valid, and that the Payer's TA account has sufficient funds, trusted authority 12 debits the specified value from the Payer's TA account, and credits the specified value to the Payee's TA account. To facilitate such transactions, web interface 22 provides “Request a Code” and “Submit a Code” hyperlinks in navigation pane 122. Examples of the use of such hyperlinks will now be described.

### Payer Request of a Payment Code

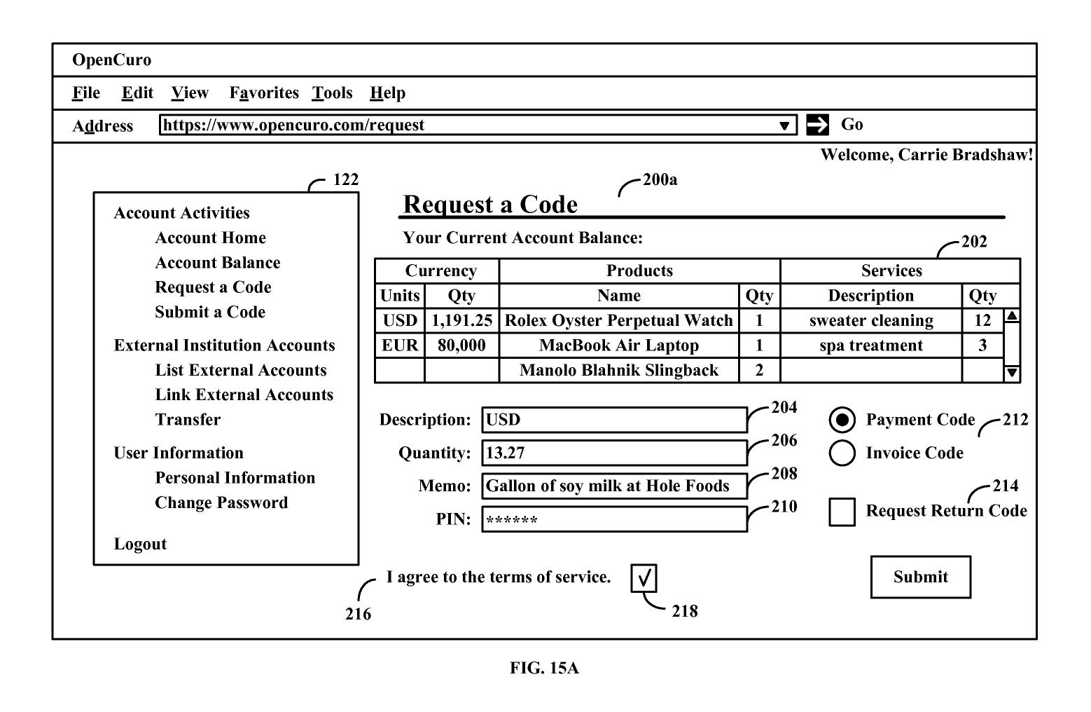

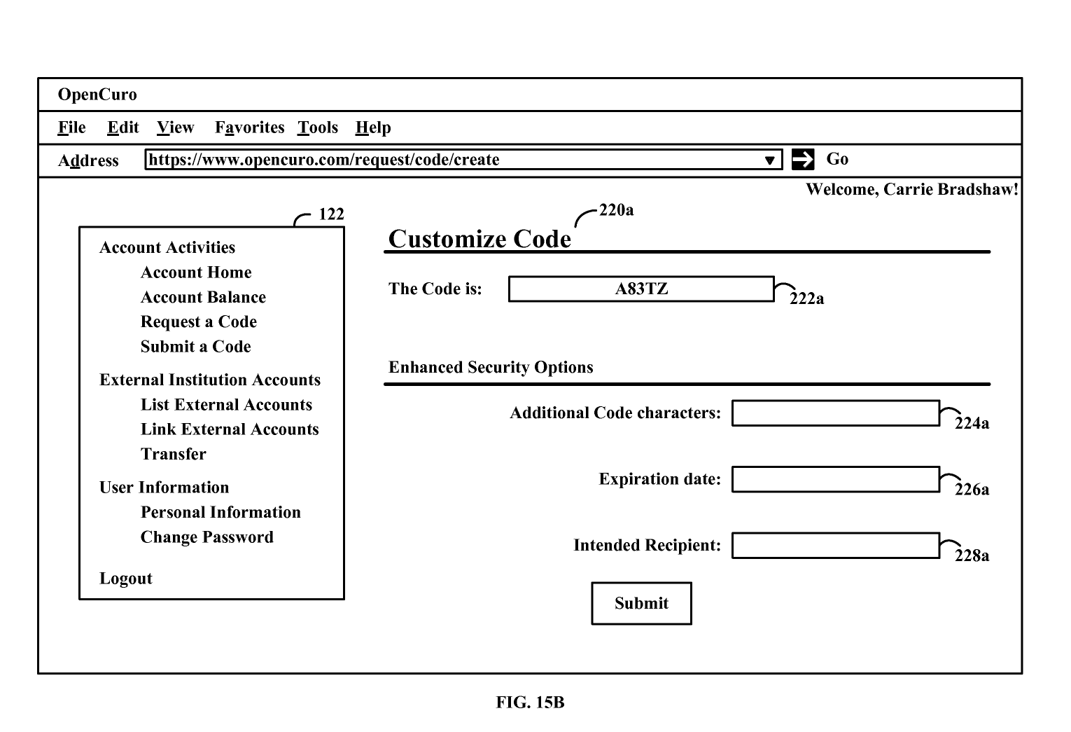

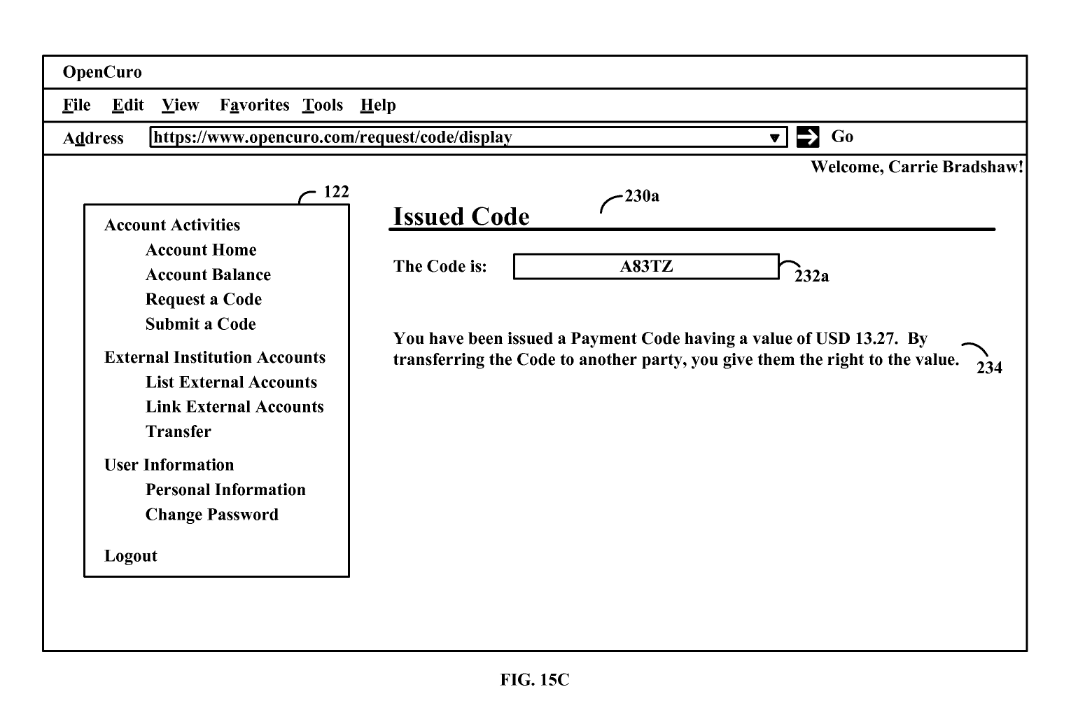

If user Carrie (carrie@hbo.net) purchases a gallon of soy milk from user Hole Foods (mgr@holefds.com), Carrie may pay for the milk using a P-Code. FIGS. 15A-15C illustrate exemplary web pages that illustrate Carrie's P-Code request from trusted authority 12.

In particular, FIG. 15A illustrates an exemplary “Request a Code” web page 200a that includes a current account balance table 202 that lists the user's current account balance. In addition, web page 200a includes a description data entry field 204 and a quantity data entry field 206 for specifying a description and quantity, respectively, of the value to be associated with the requested Code. Further, web page 200a includes an optional memo data entry field 208 for entering a text description of the Code, and a PIN data entry field 210 for specifying the PIN or other security code that the user 16 created during the TA account setup process. Also, web page 200a includes radio buttons 212 for specifying the requested Code as a P-Code or an I-Code, and a check box 214 for requesting a return Code. Moreover, a terms of service confirmation message 216 may be displayed, and the user 16 may be required to affirmatively agree to the terms of service, such as by selecting an “I agree” button 218, or other similar method of affirming agreement. In this example, Carrie has requested a P-Code to be associated with USD 13.27.

After the user 16 clicks the “Submit” button, code generator 32 (FIG. 3) generates a substantially random system code CS. As illustrated in FIG. 15B, web interface 22 displays a “Customize Code” web page 220a that displays the system code CS in system code display area 222a (“A83TZ” in this example), and includes an “Enhanced Security Options” section that includes an “Additional Code Characters” data entry field 224a in which a user 16 may provide a user-specified code CU, an “Expiration date” data entry field 226a in which a user 16 may specify an expiration date for the Code, and an “Intended Recipient” data entry field 228a in which the user 16 may specify an email address, telephone number or other information that may be used to identify the intended recipient of the Code. The user 16 may enter data in one or more of data entry fields 224a, 226a and 228a, or may leave all fields blank. After the user 16 clicks the “Submit” button, code combiner 36 (FIG. 3) combines system code CS with any user-specified code CU to generate the Code that is associated with the specified value. In the illustrated example, Carrie has not provided a user-specified code CU, and has not specified an expiration date or an intended recipient. Persons of ordinary skill in the art will understand that systems in accordance with this invention optionally may not display system code CS to the user 16 in Customize Code web page 220a.

Next, as shown in FIG. 15C, web interface 22 displays an “Issued Code” web page 230a that includes a code display field 232a that displays the Code associated with the specified value. In this example, Carrie did not provide a user-specified code CU, so the displayed Code is the same as the system code CS (“A83TZ” in this example). The Issued Code web page 230a also may include a message 234 summarizing the type and the value associated with the Code, and communicating additional terms of service related to the use of the Code.

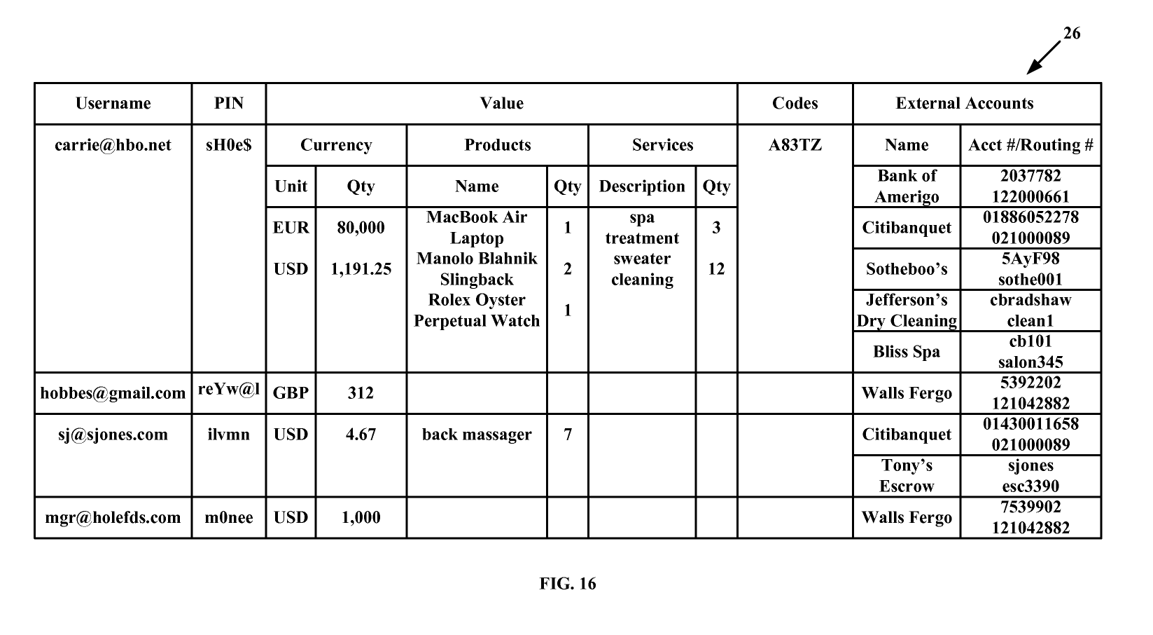

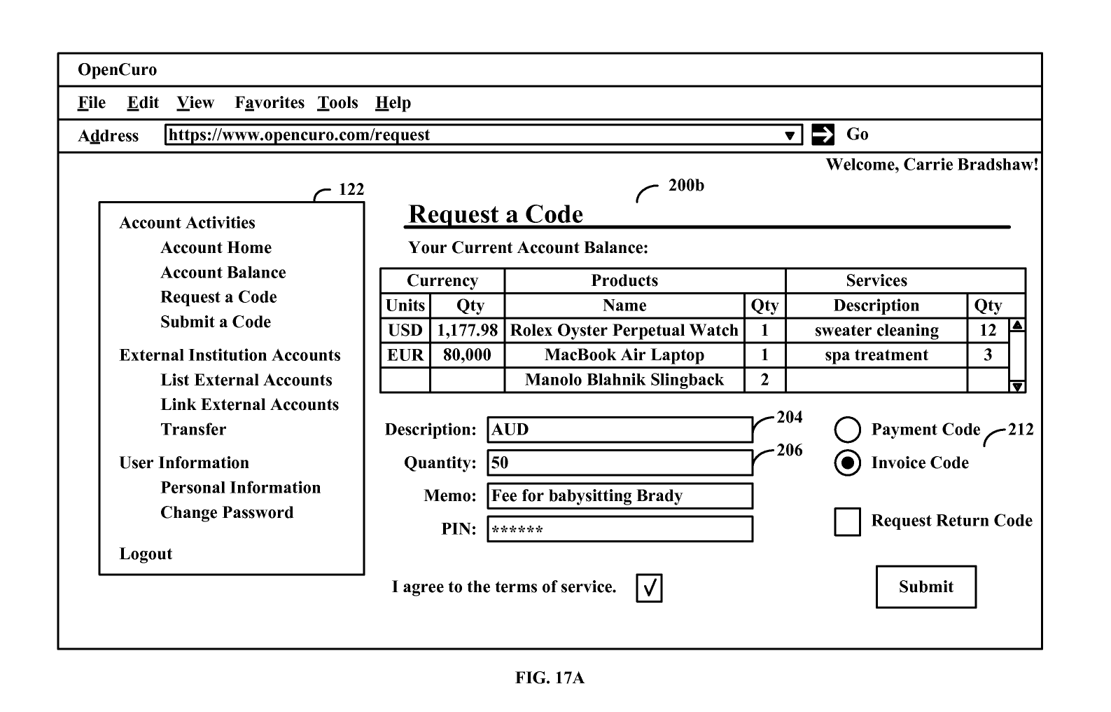

Referring again to FIG. 11, this exemplary P-Code request is illustrated schematically as request 240 of P-Code “A83TZ” from trusted authority 12. In addition, as shown in FIG. 16, account database 26 has been updated to indicate that Carrie has an open Code “A83TZ.” In this example, because the specified value associated with the Code has not yet been transferred from the user's TA account, account database 26 does not reflect any change in Carrie's TA account value. Persons of ordinary skill in the art will understand, however, that account database 26 alternatively could be updated to reflect a decrease in the amount of currency value (USD 13.27) associated with the generated Code.

Now that she has received the P-Code, Carrie may now communicate the P-Code to Hole Foods to pay for the gallon of soy milk. This transaction is illustrated schematically in FIG. 11 as payment 242 of P-Code “A83TZ” from Carrie to Hole Foods. Hole Foods may then submit the received P-Code to trusted authority 12, which will be described in more detail below.

### Payee Request of an Invoice Code

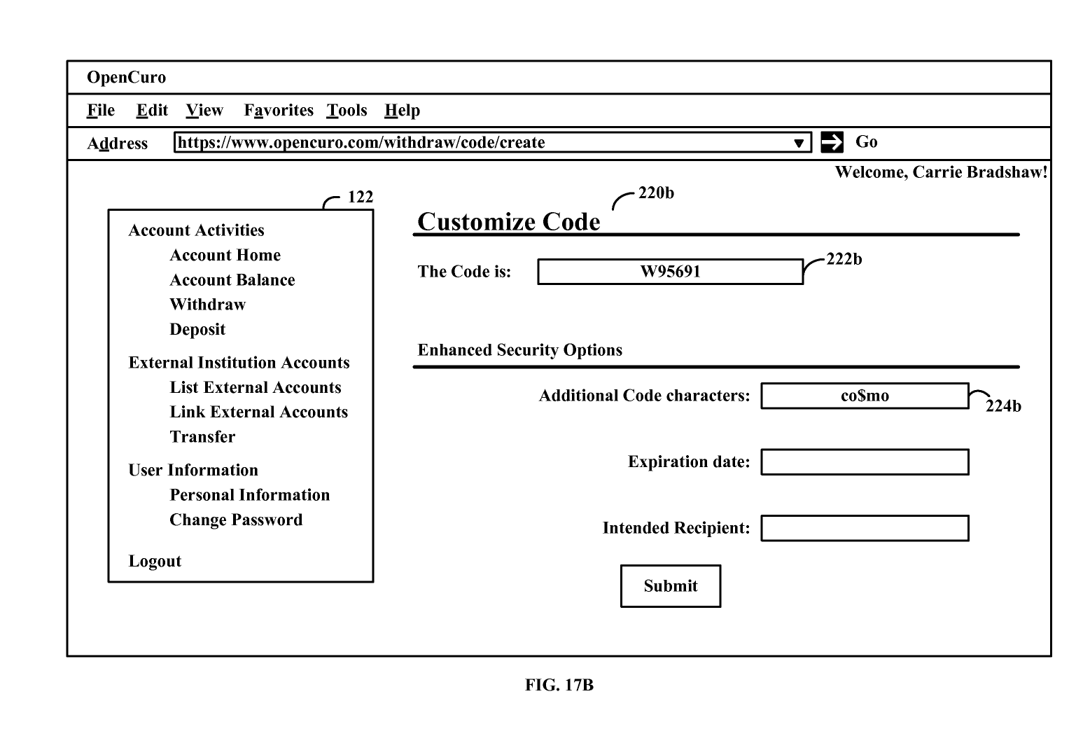

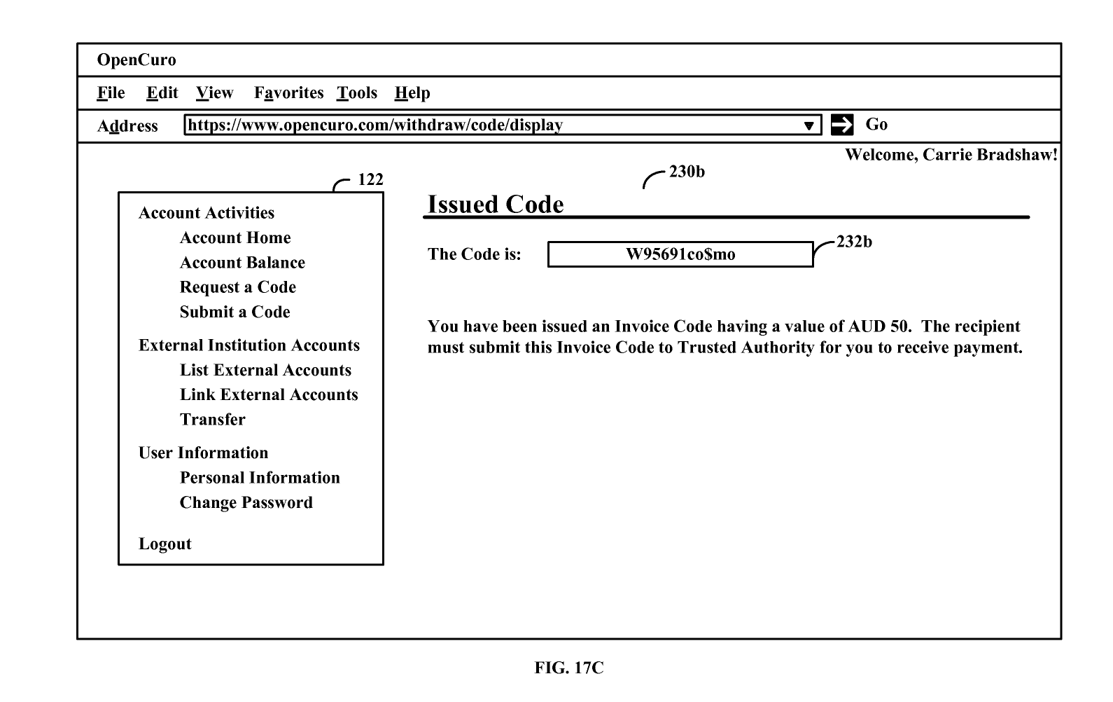

If Carrie babysits for user Miranda (hobbes@gmail.com), Carrie may invoice Miranda for her babysitting services using an I-Code. FIGS. 17A-17C illustrate exemplary web pages that illustrate Carrie's I-Code request from trusted authority 12.

In particular, FIG. 17A illustrates an exemplary “Request a Code” web page 200b in which Carrie has requested an I-Code to be associated with AUD 50. After the user 16 clicks the “Submit” button, code generator 32 (FIG. 3) generates a substantially random system code CS (“W95691” in this example), which is displayed in code display field 222b on “Customize Code” web page 220b illustrated in FIG. 17B. In this example, Carrie has provided a user-specified code CU of “co$mo” in the “Additional Code Characters” data entry field 224b, but has not specified an expiration date or intended recipient for the Code.

After the user 16 clicks the “Submit” button, code combiner 36 (FIG. 3) combines system code CS with any user-specified code CU to generate the Code that is associated with the specified value. Thus, as shown in FIG. 17C, web interface 22 displays an “Issued Code” web page 230b that includes a code display field 232b that displays the Code associated with the specified value. In this illustration, the displayed Code is the combination of the system code CS and the user-specified code CU (“W95691co$mo” in this example). In this example, the Code is simply the concatenation of system code CS and user-specified code CU. Persons of ordinary skill in the art will understand that code combiner 36 (FIG. 3) alternatively may use other techniques to combine system code CS and user-specified code CU, such as interleaving the codes, reverse-concatenating the codes, or other similar combination techniques.

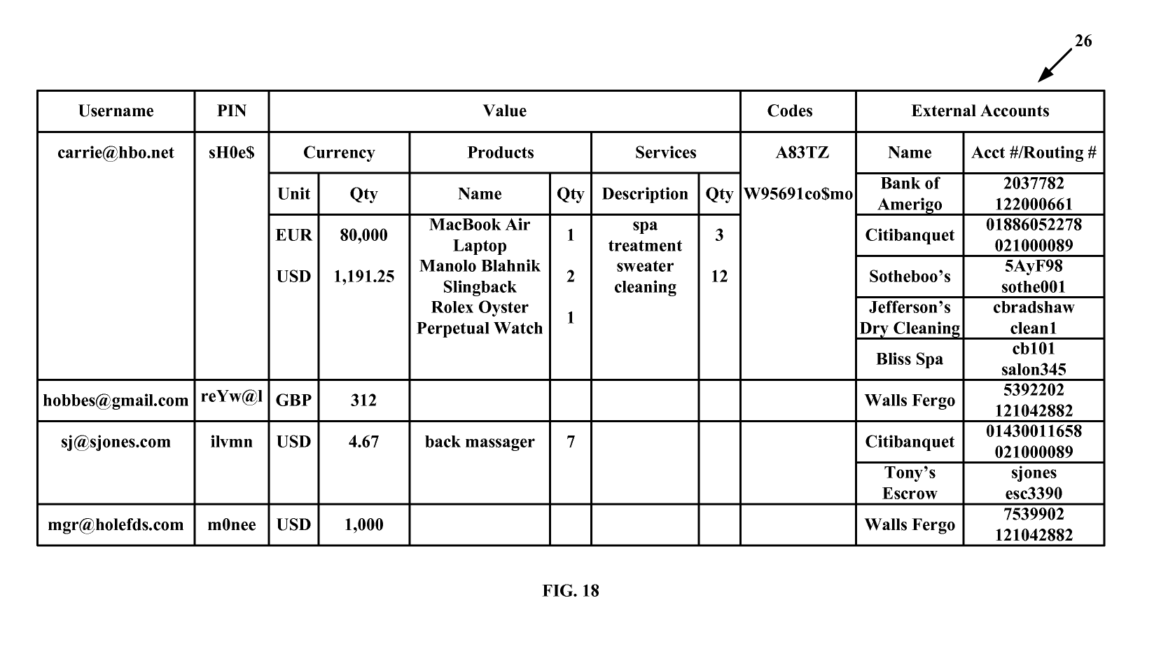

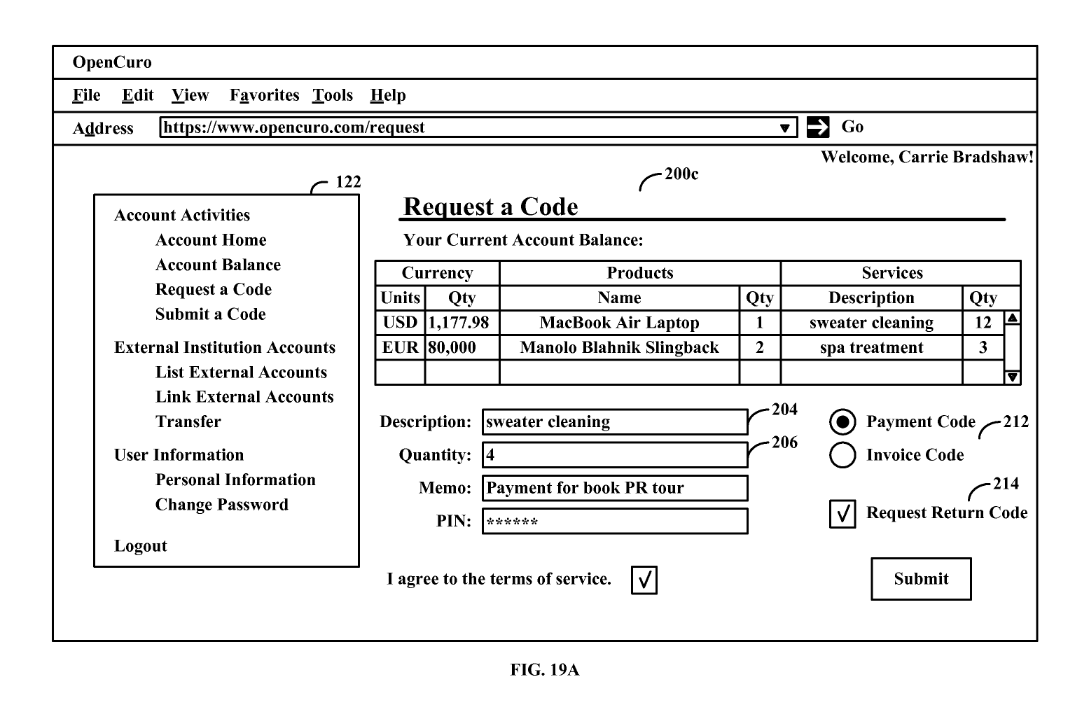

Referring again to FIG. 11, this exemplary I-Code request is illustrated schematically as request 244 of I-Code “W95691co$mo” from trusted authority 12. In addition, as shown in FIG. 18, account database 26 has been updated to indicate that carrie@hbo.net has an open Code “W95691co$mo.” In this example, because the specified value associated with the Code has not yet been transferred from Carrie's TA account, account database 26 does not reflect any change in Carrie's TA account value.

Now that she has received the I-Code, Carrie may now communicate the I-Code to Miranda as an invoice for babysitting services. This transaction is illustrated schematically in FIG. 11 as invoice 246 of I-Code “W95691co$mo” from Carrie to Miranda. Miranda may then submit the received I-Code to trusted authority 12, which will be described in more detail below.

### Payer Request of a Return Payment Code

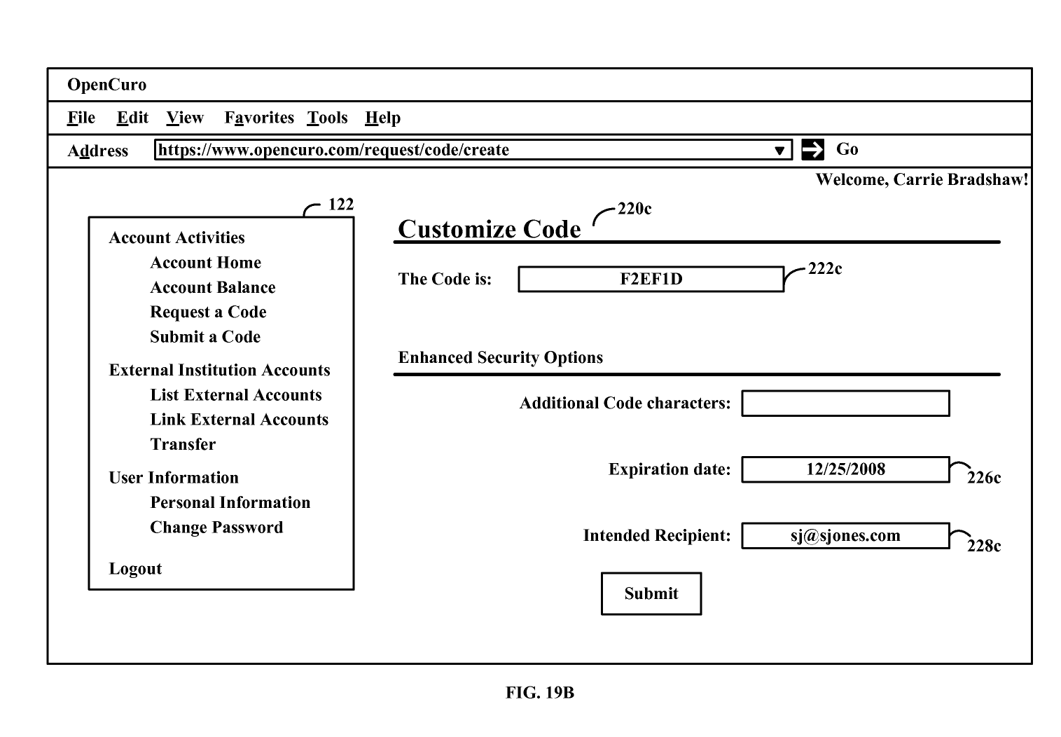

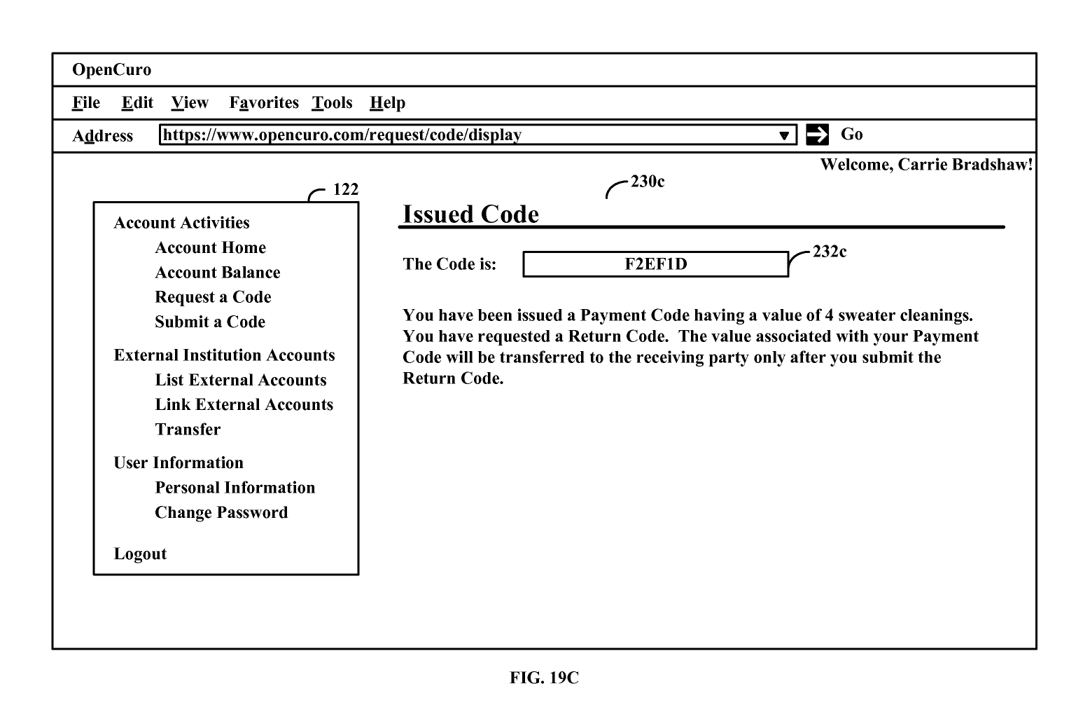

If Carrie retains user Samantha (sj@sjones.com) to provide public relations services to promote Carrie's latest book, Carrie may pay for Samantha's services using a P-Code. For added security, Carrie may request a return code as part of this transaction. FIGS. 19A-19C illustrate exemplary web pages that illustrate Carrie's RP-Code request from trusted authority 12.

In particular, FIG. 19A illustrates an exemplary “Request a Code” web page 200c in which Carrie has requested a P-Code to be associated with four sweater cleanings, and has requested a return Code. After the user 16 clicks the “Submit” button, code generator 32 (FIG. 3) generates first and second substantially random system codes CS1 and CS2 (“F2EF1D” and “8*5% RT,” respectively, in this example). The first system code CS1 is displayed in “Customize Code” web page 220c illustrated in FIG. 19B. In this example, Carrie has not provided a user-specified code CU, but has specified an expiration date of Dec. 25, 2008, and an intended recipient of sj@sjones.com for the Code. Persons of ordinary skill in the art will understand that code generator 32 alternatively may generate the second system code CS2 at a later time.

After the user 16 clicks the “Submit” button, code combiner 36 (FIG. 3) combines the first system code CS with any user-specified code CU to generate the Code that is associated with the specified value. Thus, as shown in FIG. 19C, web interface 22 displays an “Issued Code” web page 230c that includes a code display field 232c that displays the Code associated with the specified value. In this illustration, the displayed Code is the first system code CS1 (“F2EF1D” in this example).

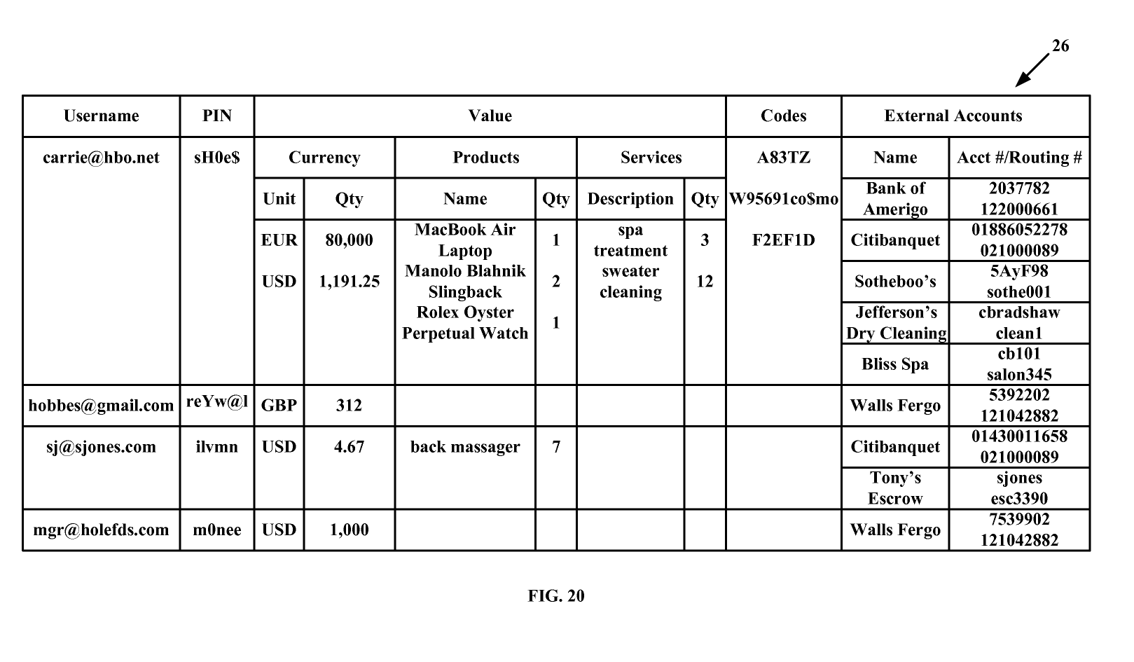

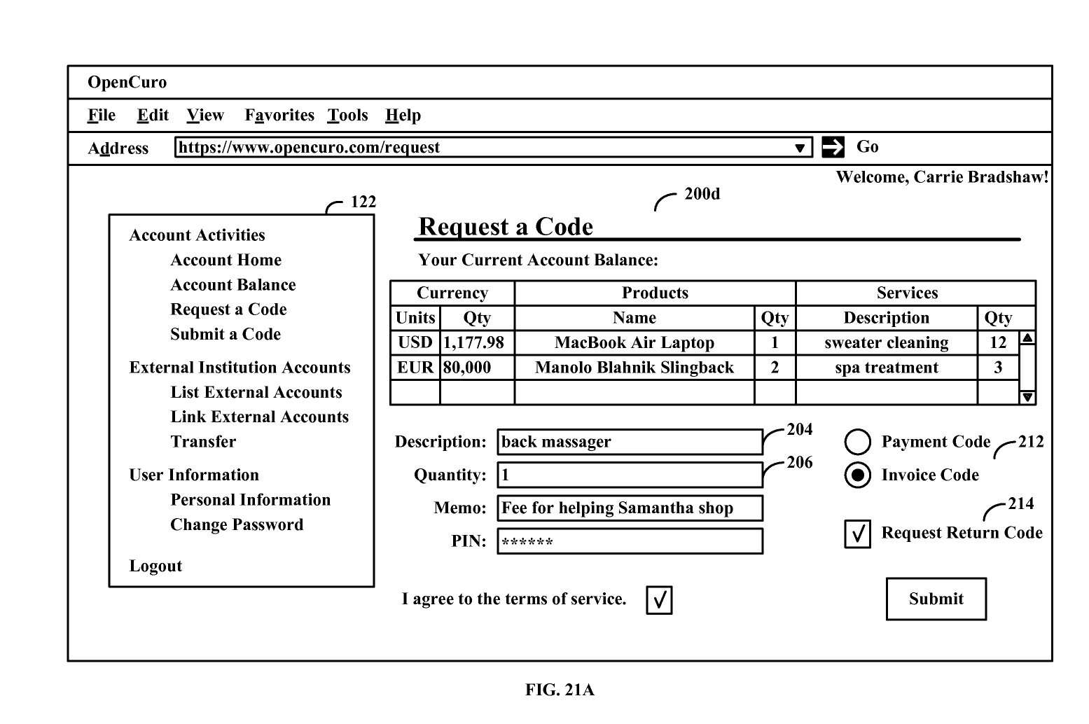

Referring again to FIG. 11, this exemplary RP-Code request is illustrated schematically as request 248 of RP-Code “F2EF1D” from trusted authority 12. In addition, as shown in FIG. 20, account database 26 has been updated to indicate that carrie@hbo.net has an open Code “F2EF1D.” In this example, because the specified value associated with the Code has not yet been transferred from the user's TA account, account database 26 does not reflect any change in Carrie's TA account value.

Now that she has received the RP-Code, Carrie may now communicate the RP-Code to Samantha to pay for the PR services. This transaction is illustrated schematically in FIG. 11 as payment 250 of RP-Code “F2EF1D” from Carrie to Samantha. Samantha may then submit the received RP-Code to trusted authority 12, which will be described in more detail below.

### Payee Request of a Return Invoice Code

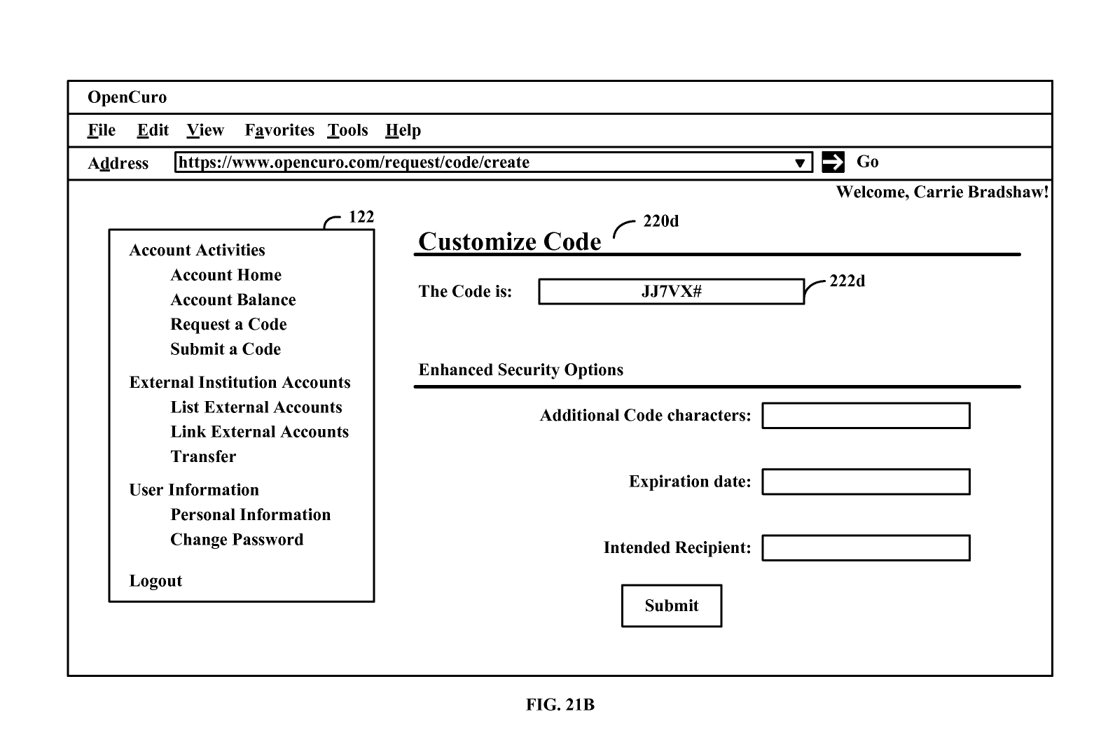

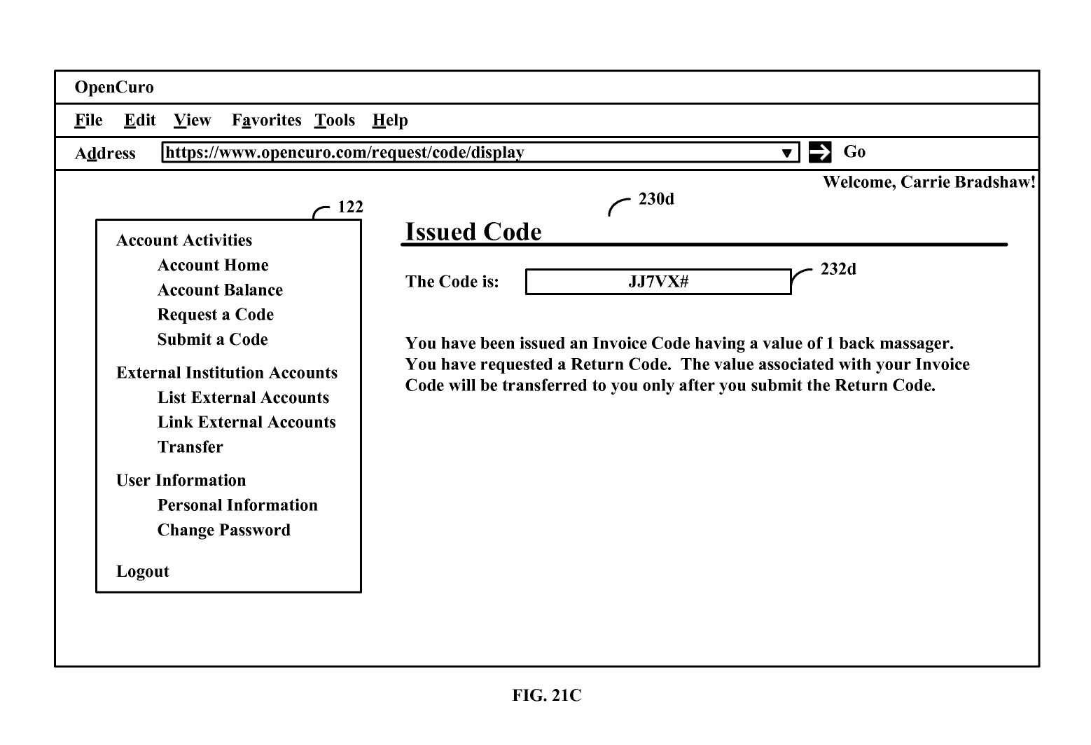

If Carrie helps Samantha shop for a new fall wardrobe, Carrie may invoice Samantha for her shopping services using an I-Code. For added security, Carrie may request a return code as part of this transaction. FIGS. 21A-21C illustrate exemplary web pages that illustrate Carrie's RI-Code request from trusted authority 12.

In particular, FIG. 21A illustrates an exemplary “Request a Code” web page 200d in which Carrie has requested an I-Code to be associated with one back massager, and has requested a return Code. After the user 16 clicks the “Submit” button, code generator 32 (FIG. 3) generates first and second substantially random systems code CS1 and CS2 (“JJ7VX#” and “5778T@,” respectively, in this example). The first system code CS 1 is displayed in “Customize Code” web page 220d illustrated in FIG. 21B. In this example, Carrie has not provided a user-specified code CU, an expiration date or an intended recipient for the Code. Persons of ordinary skill in the art will understand that code generator 32 alternatively may generate the second system code CS2 at a later time.

After the user 16 clicks the “Submit” button, code combiner 36 (FIG. 3) combines the first system code CS1 with any user-specified code CU to generate the Code that is associated with the specified value. Thus, as shown in FIG. 21C, web interface 22 displays an “Issued Code” web page 230d that includes a code display field 232d that displays the Code associated with the specified value. In this illustration, the displayed Code is the first system code CS1 (“JJ7VX#” in this example).

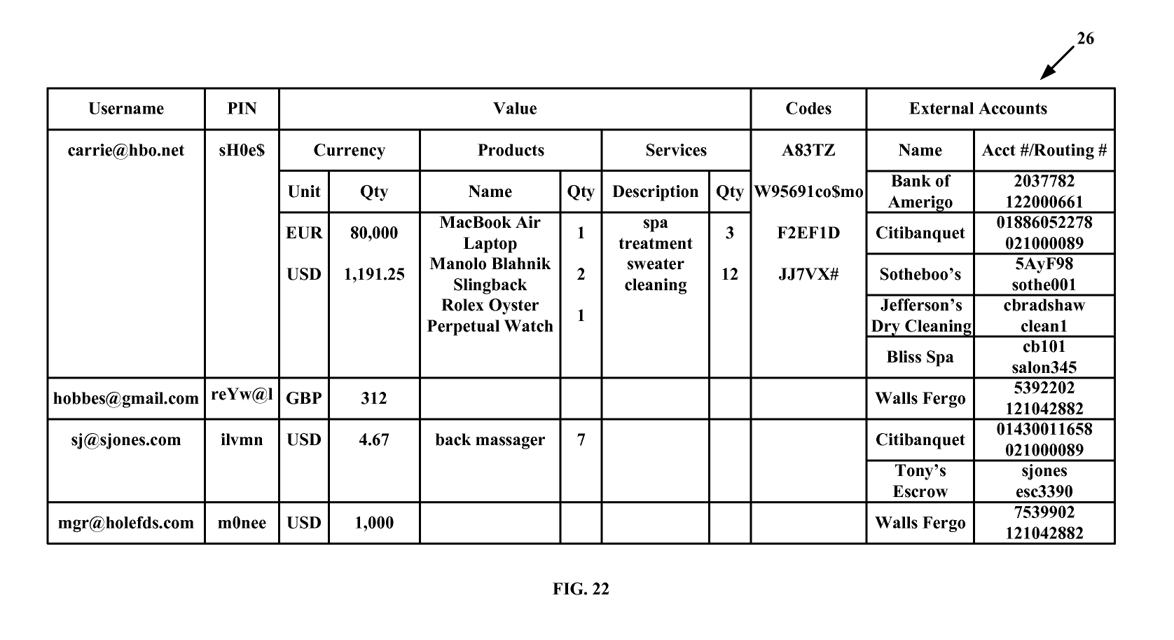

Referring again to FIG. 11, this exemplary RI-Code request is illustrated schematically as request 252 of RI-Code “JJ7VX#” from trusted authority 12. In addition, as shown in FIG. 22, account database 26 has been updated to indicate that Carrie has an open Code “JJ7VX#.” In this example, because the specified value associated with the Code has not yet been transferred from the user's TA account, account database 26 does not reflect any change in Carrie's TA account value.

Now that she has received the RI-Code, Carrie may now communicate the RI-Code to Samantha as an invoice for shopping services. This transaction is illustrated schematically in FIG. 11 as invoice 254 of RI-Code “JJ7VX#” from Carrie to Samantha. Samantha may then submit the received RI-Code to trusted authority 12, which will be described in more detail below.

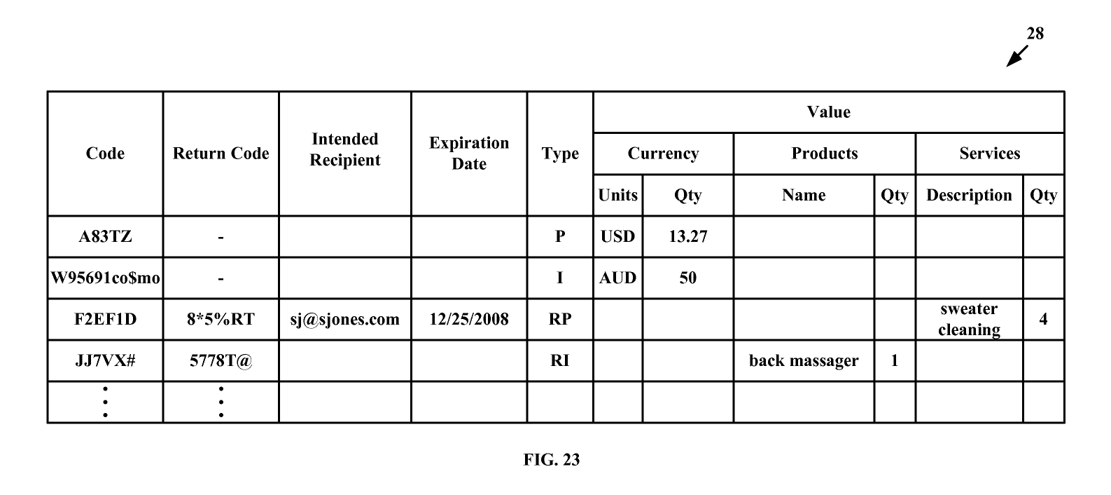

Thus, as shown in FIG. 23, after these four Code requests are completed, code database 28 indicates that: (1) Code “A83TZ” is a P-Code associated with a currency value of USD 13.27; (2) Code “W95691co$mo” is an I-Code associated with a currency value of AUD 50; (3) Codes “F2EF1D” and “8*5% RT” are corresponding RP-Codes associated with a service value of four sweater cleanings; and (4) Codes “JJ7VX#” and “5778T@” are corresponding RI-Codes associated with a product value of one back massager.

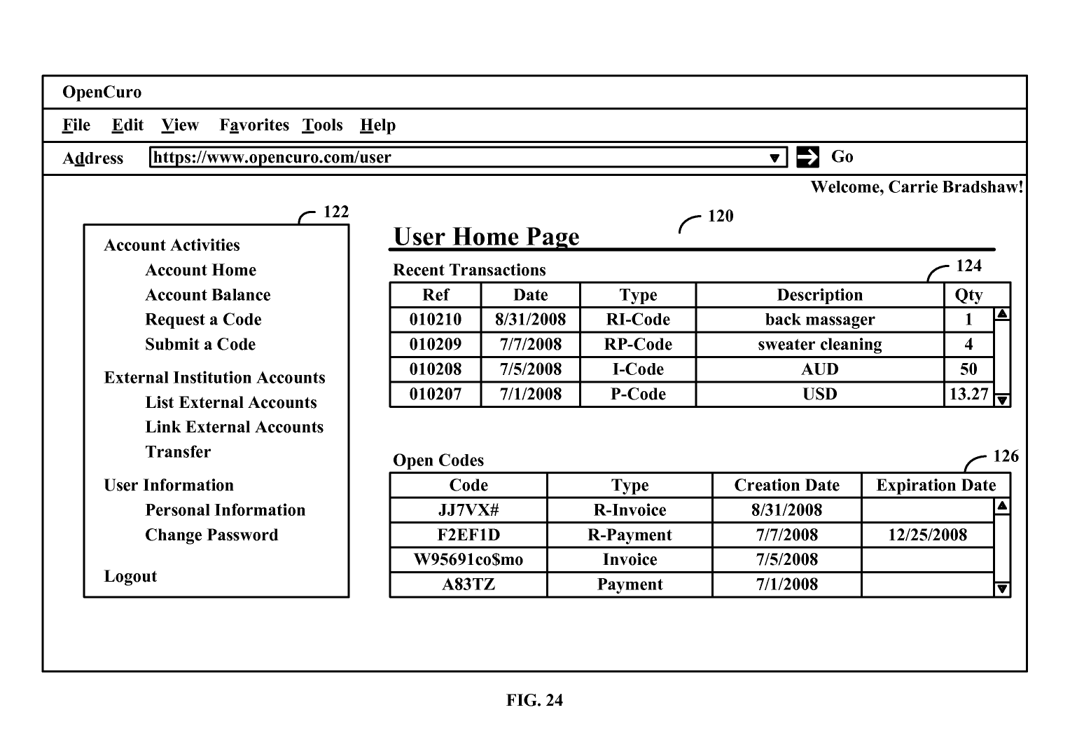

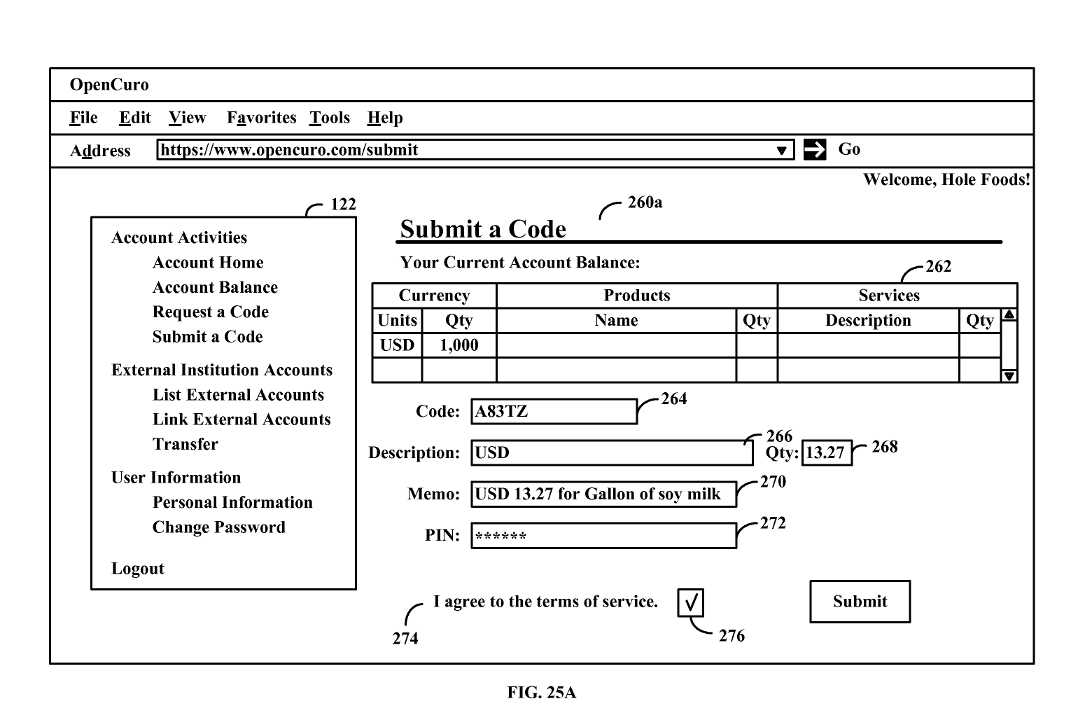

As shown in FIG. 24, if Carrie selects the “Account Home” hyperlink in navigation pane 122, user home page 120 displays a summary of the foregoing Code requests in Recent Transactions table 124. In addition, Open Codes table 126 displays a summary of Carrie's open Codes, including code type, creation date and expiration date. Persons of ordinary skill in the art will understand that more or less information may be displayed pertaining to the open Codes. For example, the value associated with each Code also may be displayed.

As described above, Carrie provided a P-Code to Hole Foods, an I-Code to Miranda, an RP-Code to Samantha, and an RI-Code to Samantha. Each of these recipients may then submit their received Codes to trusted authority 12 using the “Submit a Code” hyperlink in navigation panel 122 to transfer the value associated with each Code from the Payer to the Payee. Examples of the use of such hyperlinks will now be described.

### Payee Submission of a P-Code

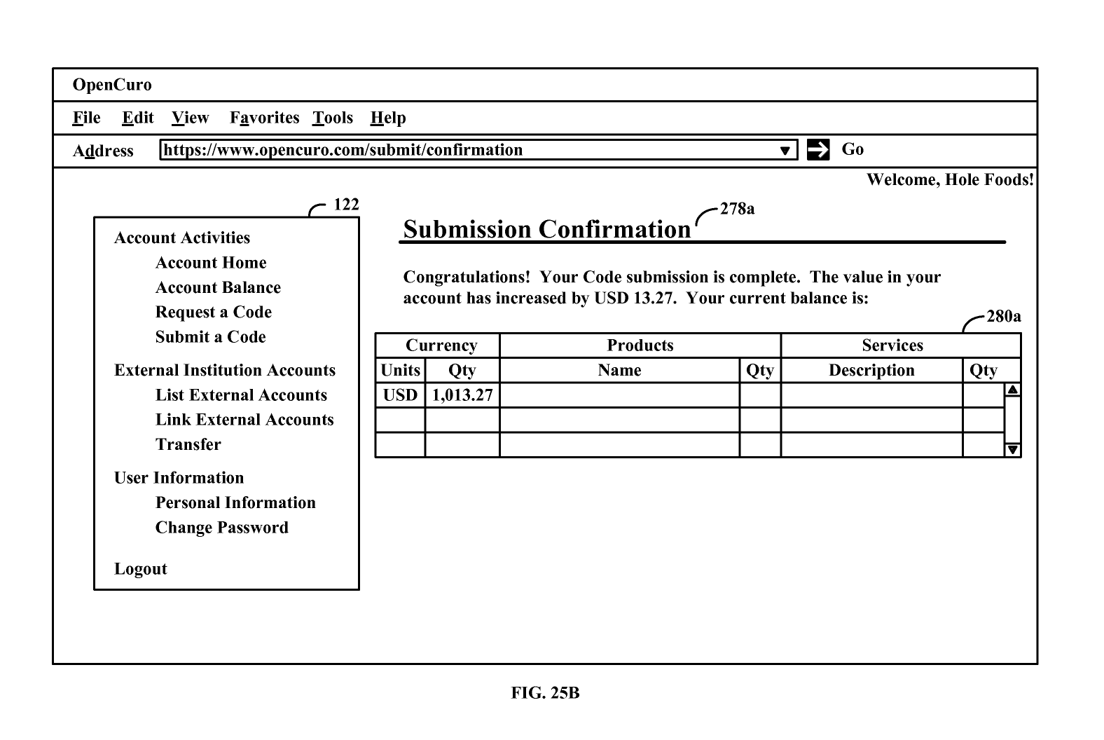

Upon receipt of the P-Code “A83TZ” from Carrie, Hole Foods may submit the P-Code to trusted authority 12 using the “Submit a Code” hyperlink in navigation pane 122 to submit a Code to trusted authority 12. For example, FIGS. 25A-25B illustrate exemplary web pages that depict submission of a P-Code to trusted authority 12.

In particular, FIG. 25A illustrates an exemplary “Submit a Code” web page 260a that includes an account balance table 262 that displays the user's current account balance, a Code data entry field 264 that may be used to enter a Code to be submitted, and value description and quantity data entry fields 266 and 268, respectively, that may be used to specify the value that is associated with the Code entered in Code data entry field 264. Persons of ordinary skill in the art will understand that methods and systems in accordance with this invention alternatively may only require that the user 16 provide the Code, without requiring that the user 16 also provide additional information, such as the value description, quantity, or other information.

In this example, Hole Foods has entered the Code “A83TZ” in Code data entry field 264, has specified “USD” in description data entry field 266 and “13.27” in quantity data entry field 268. An optional memo data entry field 270 may be used to enter a text memo regarding the submission, and a PIN data entry field 272 may be used to enter the user's PIN. A terms of service confirmation message 274 may be displayed, and the user 16 may be required to affirmatively agree to the terms of service, such as by selecting an “I agree” button 276, or other similar method of affirming agreement.

After the user 16 clicks the “Submit” button, controller 20 (FIG. 2) accesses code database 28 to determine if the submitted Code is valid. For example, a Code may be deemed valid if the Code is open, and if other Code data requirements are satisfied. For example, if the requesting user specified an expiration date or an intended recipient, a submitted Code may be valid only if the Code is submitted prior to the specified expiration date, and if the Code is submitted by the intended recipient.

In some embodiments in accordance with this invention, trusted authority 12 may increase the security of the system by requiring that the user-supplied value description match the value description associated with the Code in code database 28. In that regard, if a Code is lost, an unauthorized user 16 who finds the Code may not simply submit the Code to trusted authority 12 without also knowing the exact value description associated with the Code. In this regard, the Code validity determination may include retrieving the value description associated with the Code from code database 28, and comparing the retrieved value description with the value description and quantity provided by the submitting user 16 in data entry fields 266 and 268.

If code database 28 does not include an entry for the Code provided by the receiving user 16 in data field 264, or if any of the Code validating conditions are not satisfied, controller 20 may cause user interface 22 to provide an error message stating that the specified Code and/or the specified value is incorrect. User interface 22 may permit the user 16 to retry the submission, or may immediately terminate the session. For security reasons, controller 20 may freeze a user's account after a predetermined number of failed submission attempts.

If controller 20 determines that the submitted P-Code is valid, controller 20 invalidates the Code (e.g., by deleting the P-Code from account database 26 and code database 28), debits the value associated with the P-Code from the Payer's TA account, and credits the associated value to the Payee's TA account. In addition, user interface 22 displays a “Submission Confirmation” web page 278a, an example of which is illustrated in FIG. 25B. In particular, web page 278a includes an account balance table 280a that displays the user's current account balance, including the amount credited to the user's TA account.

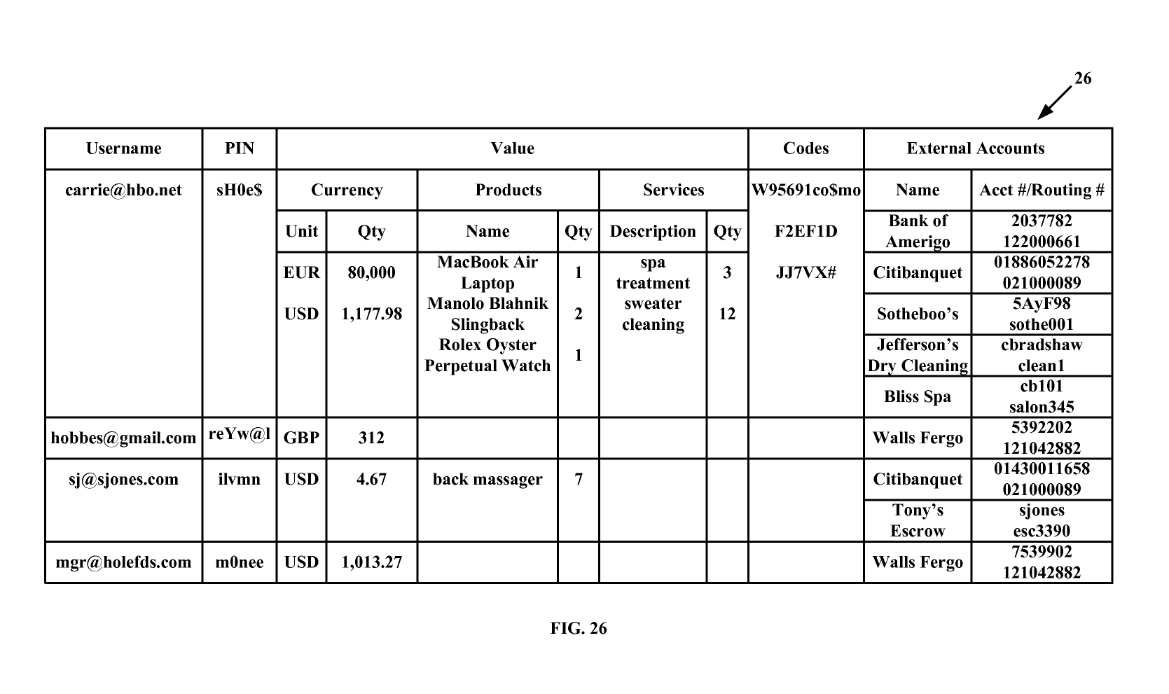

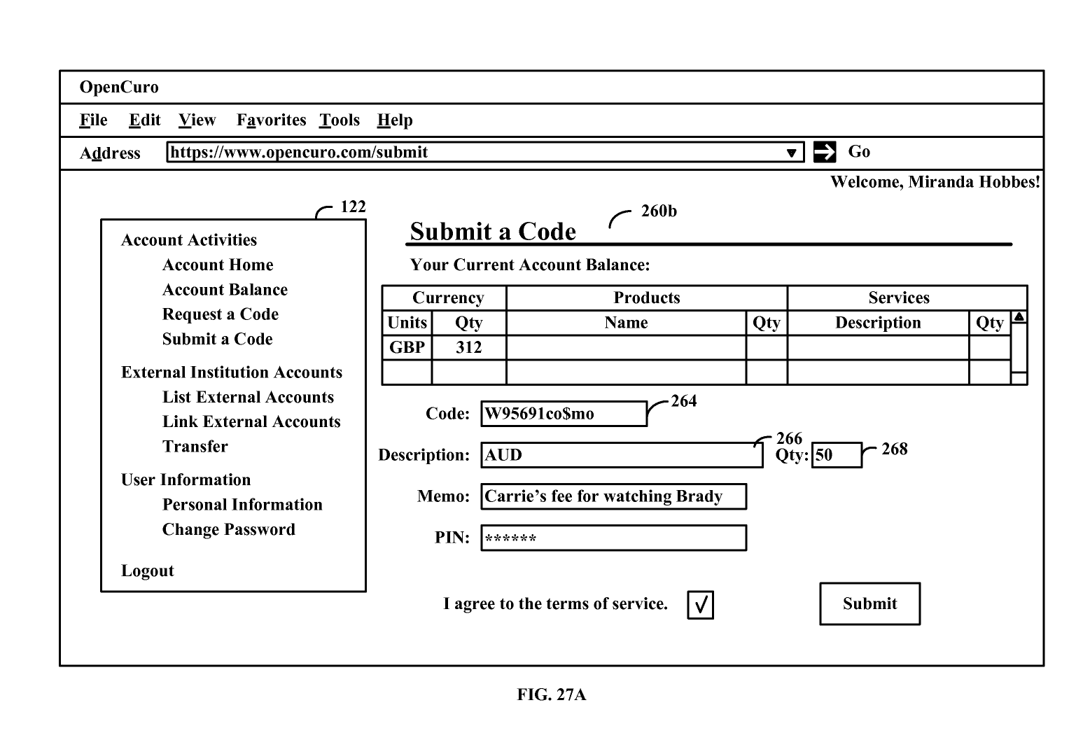

Referring again to FIG. 11, this transaction is illustrated schematically in FIG. 11 as Hole Food's submission 302 of code “A83TZ” to trusted authority 12. In addition, as shown in FIG. 26, account database 26 has been updated to reflect an increase in Hole Foods currency value by the amount associated with the submitted P-Code (USD 13.27), and a decrease in Carrie's currency value by the same amount. Also, account database 26 has been updated to delete the Code “A83TZ” from Carrie's open Codes. As this example illustrates, because Codes need not include any information identifying the user 16 who withdrew the value, users 16 may use Codes to anonymously transfer the value associated with the Code.

### Payee Submission of an I-Code

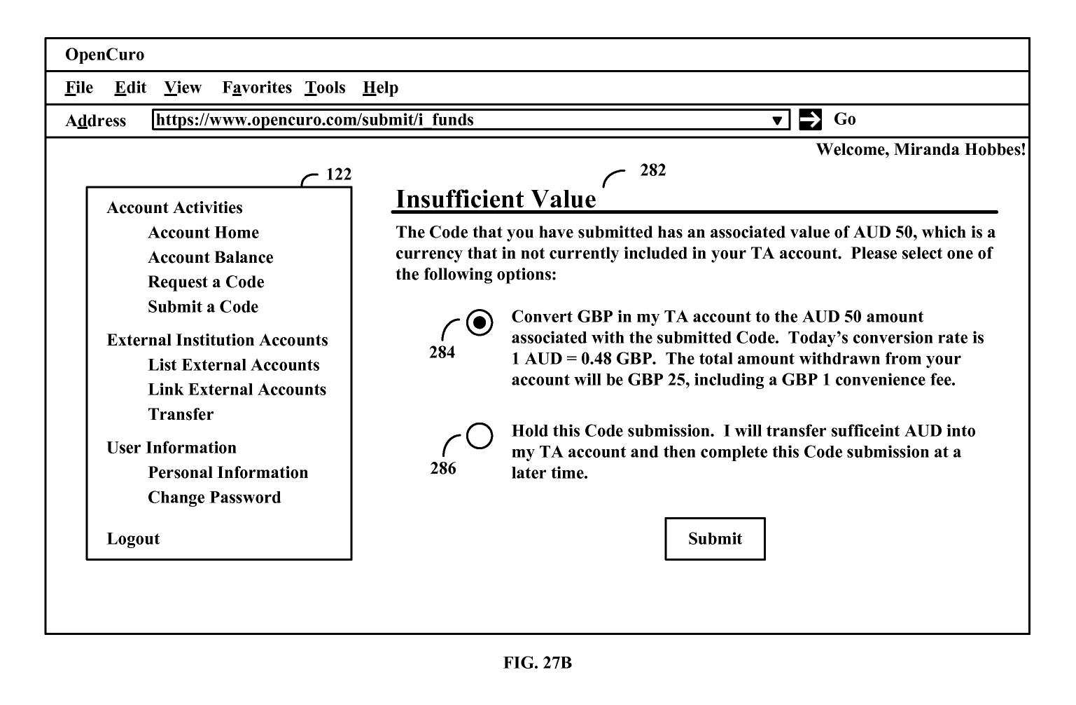

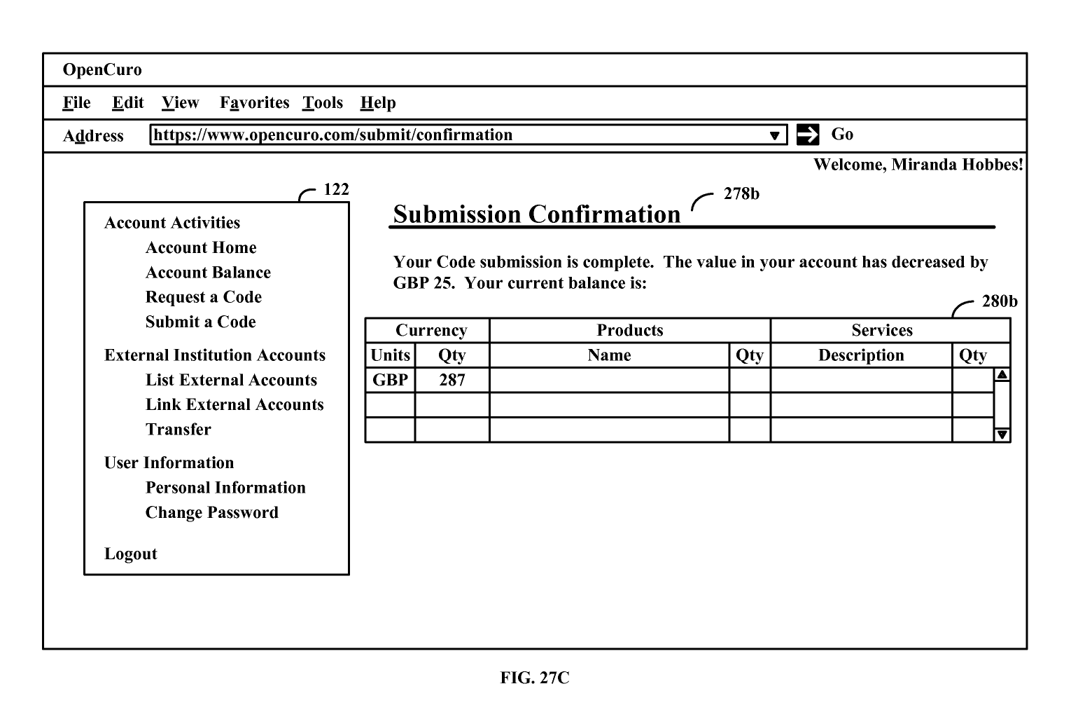

Upon receipt of the I-Code “W95691co$mo” from Carrie, Miranda may submit the I-Code to trusted authority 12. For example, FIGS. 27A-27C illustrate exemplary web pages that depict submission of an I-Code to trusted authority 12. In particular, FIG. 27A illustrates exemplary “Submit a Code” web page 260b in which Miranda has entered the Code “W95691co$mo” in Code data entry field 264, has specified “AUD” in description data entry field 266 and “50” in quantity data entry field 268.

After the user 16 clicks the “Submit” button, controller 20 (FIG. 2) accesses code database 28 to determine if the Code provided in Code data entry field 264 is valid. If controller 20 determines that the submitted I-Code is valid, controller 20 determines if the value associated with the I-Code is available in the user's TA account. In the example illustrated in FIG. 27A, the associated value (AUD 50) is not a currency currently available in Miranda's TA account. However, Miranda's account does include sufficient currency (GBP 312) that may be converted to the amount of the associated value. Thus, user interface 22 may display an “Insufficient Value” web page 282 that provides radio buttons 284 and 286 that allow the user 16 to authorize a currency conversion, or hold the Code submission to permit the user 16 to transfer sufficient value into her TA account to cover the value associated with the I-Code. In the illustrated example, Miranda elects to authorize a currency conversion (and a specified convenience fee).

After controller 20 determines that the specified value is available in the user's TA account, controller 20 invalidates the Code (e.g., by deleting the I-Code from account database 26 and code database 28), debits the value associated with the I-Code from the Miranda's TA account, and credits the associated value to Carrie's TA account. In addition, as shown in FIG. 27C, user interface 22 displays a “Submission Confirmation” web page 278b, that displays the user's current account balance, including the amount debited to the user's TA account.

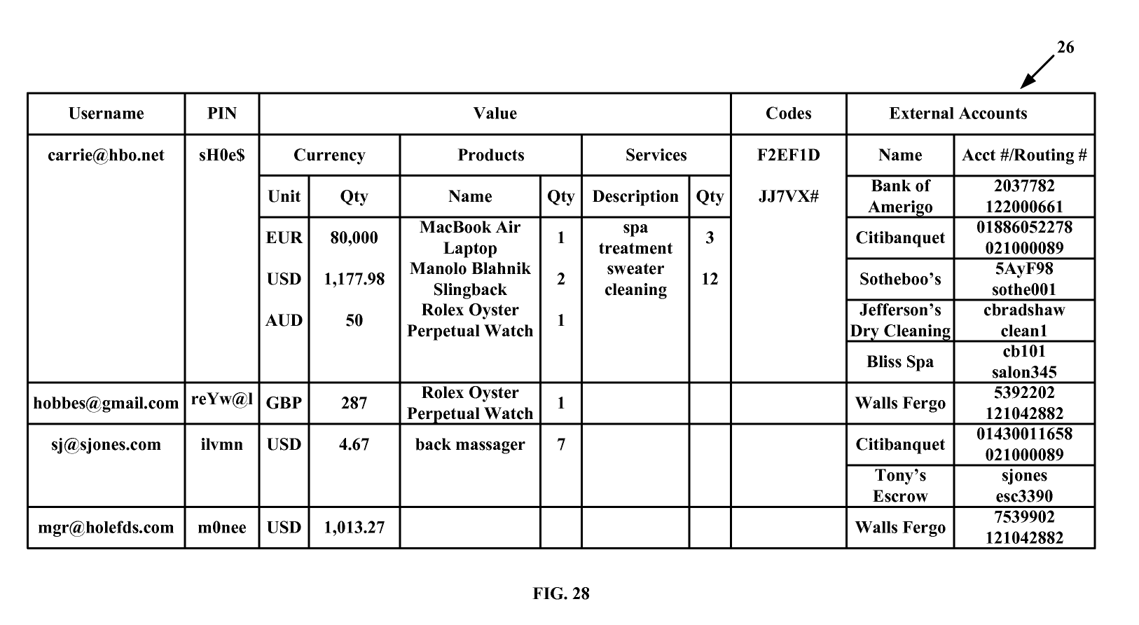

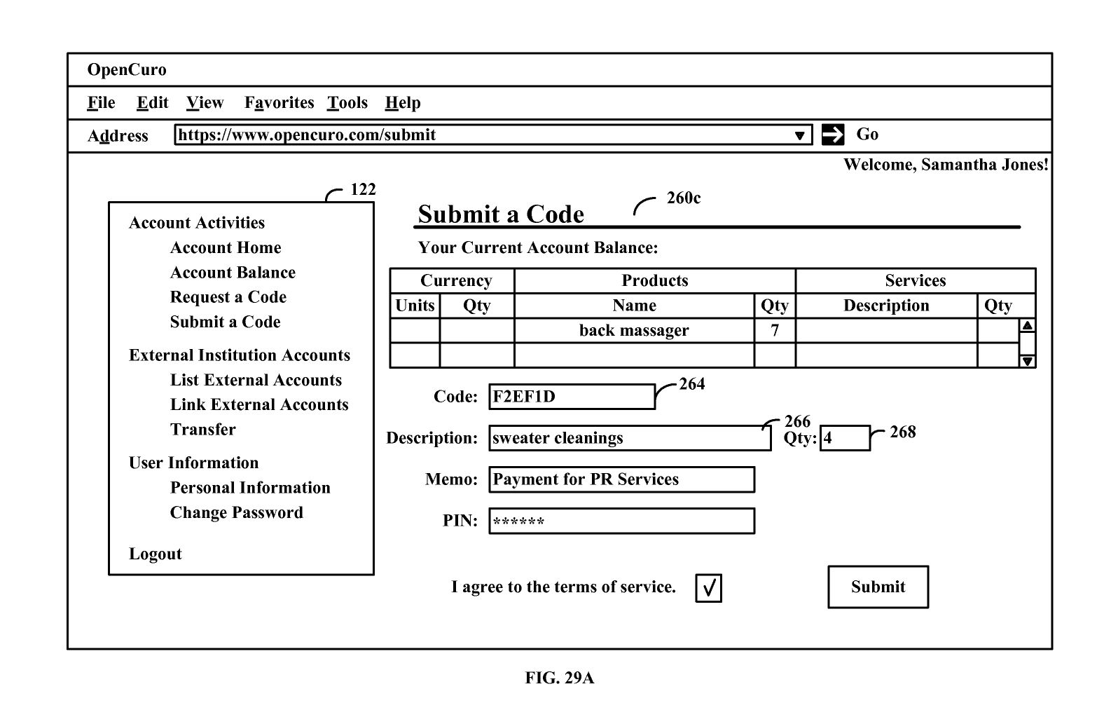

Referring again to FIG. 11, this transaction is illustrated schematically in FIG. 11 as Miranda's submission 306 of code “W959691co$mo” to trusted authority 12. In addition, as shown in FIG. 28, account database 26 has been updated to reflect an increase in Carrie's currency value by the amount associated with the submitted I-Code (AUD 50), and a decrease in Miranda's currency value by the converted amount associated with the submitted I-Code (GBP 25). Also, account database 26 has been updated to delete the Code “W959691co$mo” from Carrie's open Codes.

### Payee Submission of an RP-Code

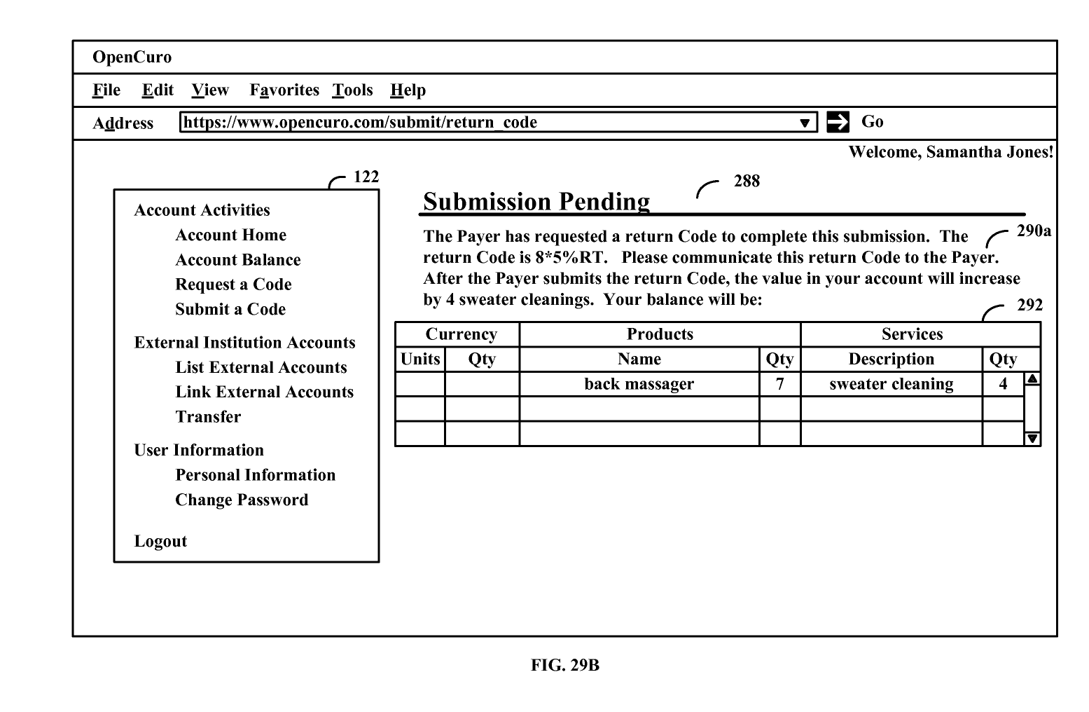

Upon receipt of the RP-Code “F2EF1D” from Carrie, Samantha may submit the RP-Code to trusted authority 12. For example, FIGS. 29A-29B illustrate exemplary web pages that depict submission of an RP-Code to trusted authority 12. In particular, FIG. 29A illustrates exemplary “Submit a Code” web page 260c in which Samantha has entered the Code “F2EF1D” in Code data entry field 264, has specified “sweater cleanings” in description data entry field 266 and “4” in quantity data entry field 268.

After the user 16 clicks the “Submit” button, controller 20 (FIG. 2) accesses code database 28 to determine if the submitted Code is valid. In this example, controller 20 determines from code database 28 that Code “F2EF1D” is an open return code that has an expiration date of Dec. 25, 2008, and an intended recipient of sj@sjones.com. Because the submitted Code is open, and the Code was submitted by the intended recipient prior to the expiration date, controller 20 determines that the submitted Code is valid. Controller then retrieves the value description associated with the Code from code database 28, and compares the retrieved value description with the value description and quantity provided by Samantha in data entry fields 266 and 268.

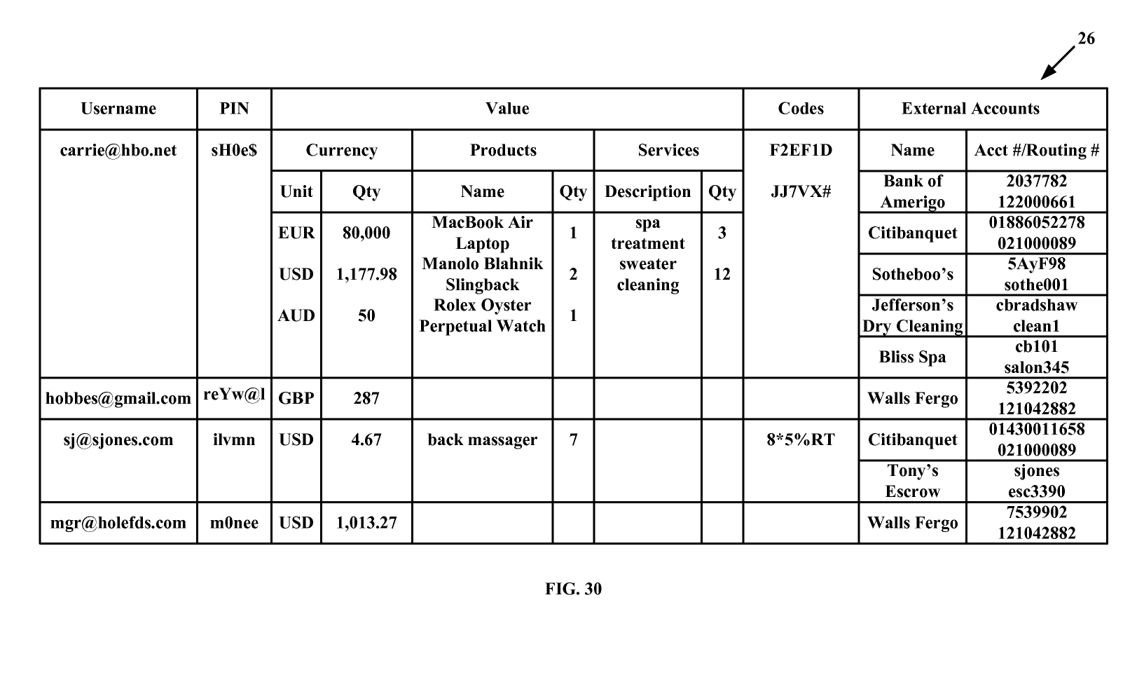

If controller 20 determines that the submitted RP-Code is valid, controller 20 causes web interface 22 to communicate the return Code to the user 16. For example, as illustrated in FIG. 29B, web interface 22 displays a “Submission Pending” web page 288 that includes instructions 290a that communicate the return Code to the Payee, and informs the Payee to communicate the return Code to the Payer. In addition, web page 288 may include a table 292 that displays the user's account balance if the RP-Code submission is complete. As shown in FIG. 30, account database 26 has been updated to add the RP-Code “8*5% RT” to Samantha's open Codes.

Referring again to FIG. 11, these transactions are illustrated schematically in FIG. 11 as Samantha's submission 310 of code “F2EF1D” to trusted authority 12, the communication 312 of the return Code “8*5% RT” from trusted authority 12 to Samantha, and Samantha's communication 314 of return Code “8*5% RT” to Carrie.

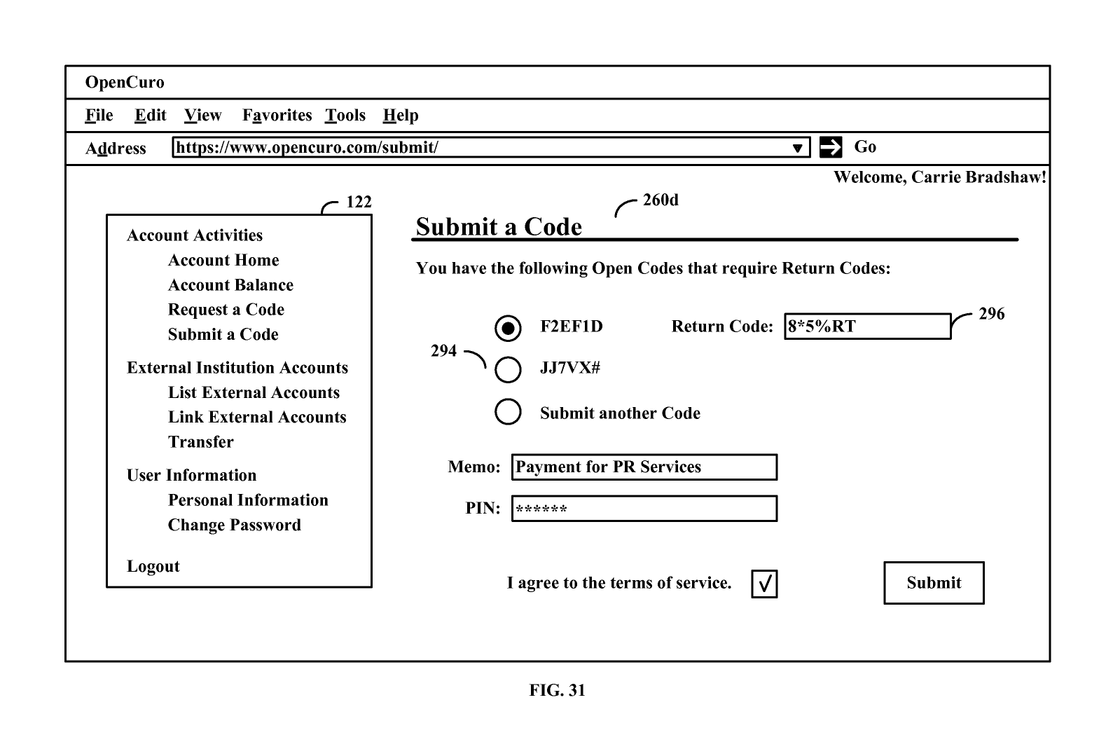

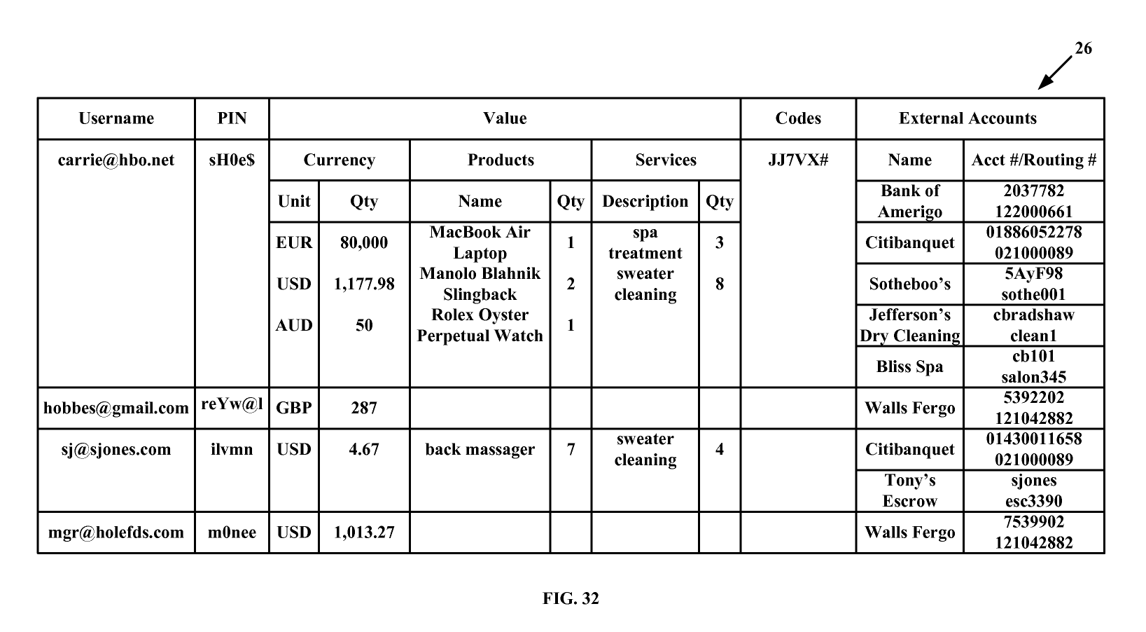

After Samantha provides the return Code to Carrie, Carrie may submit the return Code to trusted authority 12. In particular, as shown in FIG. 31, web interface 22 may display a “Submit a Code” web page 260d that informs the user that some open Codes require Return Codes, and enables the user 16 to easily specify the return Codes. For example, web page 260d may include radio buttons 294 that allow the user 16 to select one of the open RP-Codes to which a return Code may be specified in return code data entry field 296, or to select an option to submit another Code. In the illustrated example, Carrie submits the return Code “8*5% RT” corresponding to RP-Code “F2EF1D.”

After Carrie clicks the “Submit” button, controller 20 (FIG. 2) accesses code database 28 to determine if the submitted return Code is valid. In this example, controller 20 determines from code database 28 that submitted Code “8*5% RT” matches the RP-Code “F2EF1D.” Controller 20 then invalidates both RP-Codes (e.g., by deleting the RP-Codes from account database 26 and code database 28), debits the value associated with the RP-Codes from the Payer's TA account, and credits the associated value to the Payee's TA account.

Referring again to FIG. 11, this transaction is illustrated schematically in FIG. 11 as Carrie's submission 316 of code “8*5% RT” to trusted authority 12. In addition, as shown in FIG. 32, account database 26 has been updated to reflect an increase in Samantha's service value by the amount associated with the submitted RP-Code (4 sweater cleanings), and a decrease in Carrie's service value by the same amount. Also, account database 26 has been updated to delete the RP-Codes “F2EF1D” and “8*5% RT” from Carrie's and Samantha's open Codes, respectively.

### Payee Submission of an RI-Code

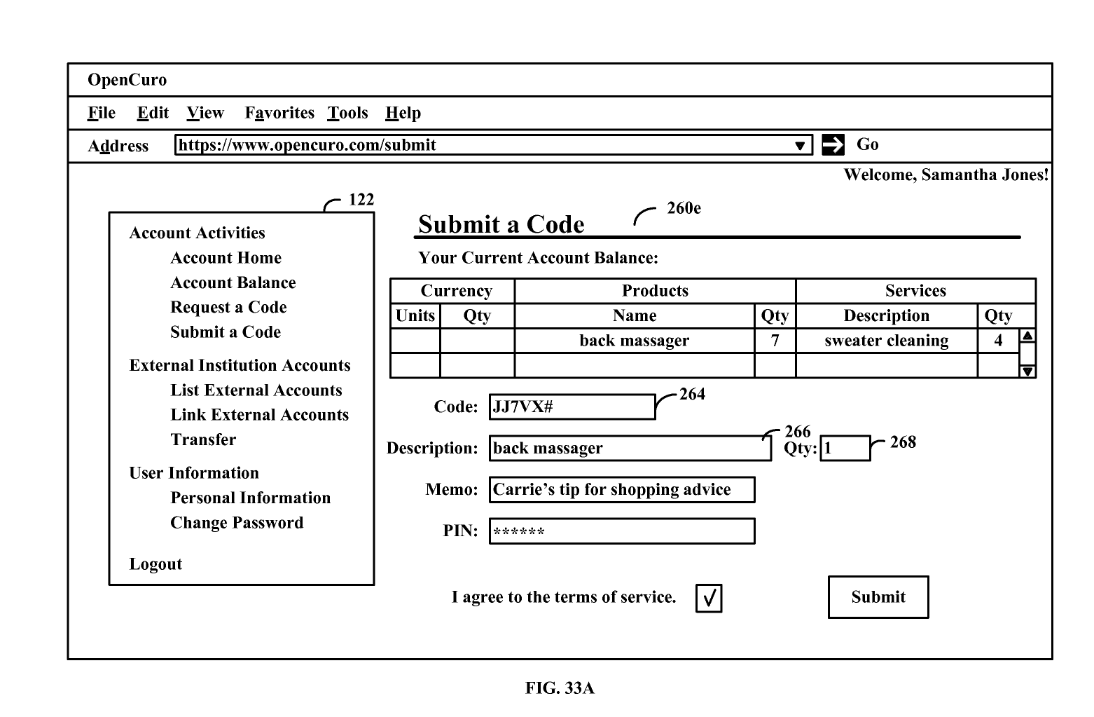

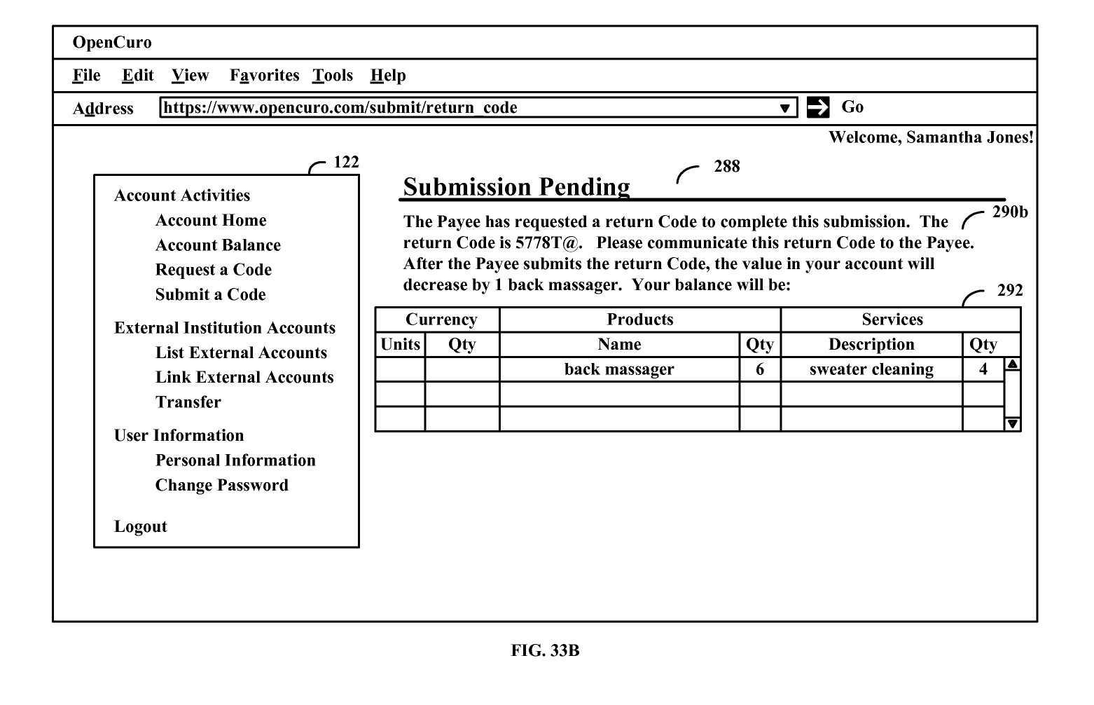

Upon receipt of the RI-Code “JJ7VX#” from Carrie, Samantha may submit the RI-Code to trusted authority 12. For example, FIGS. 33A-33B illustrate exemplary web pages that depict submission of an RI-Code to trusted authority 12. In particular, FIG. 33A illustrates exemplary “Submit a Code” web page 260e in which Samantha has entered the Code “JJ7VX#” in Code data entry field 264, has specified “back massager” in description data entry field 266 and “1” in quantity data entry field 268.

After the user 16 clicks the “Submit” button, controller 20 (FIG. 2) accesses code database 28 to determine if the submitted Code is valid. In this example, controller 20 determines from code database 28 that Code “JJ7VX#” is an open return code. Because the submitted Code is open, controller 20 determines that the submitted Code is valid. Controller then retrieves the value description associated with the Code from code database 28, and compares the retrieved value description with the value description and quantity provided by Samantha in data entry fields 266 and 268.

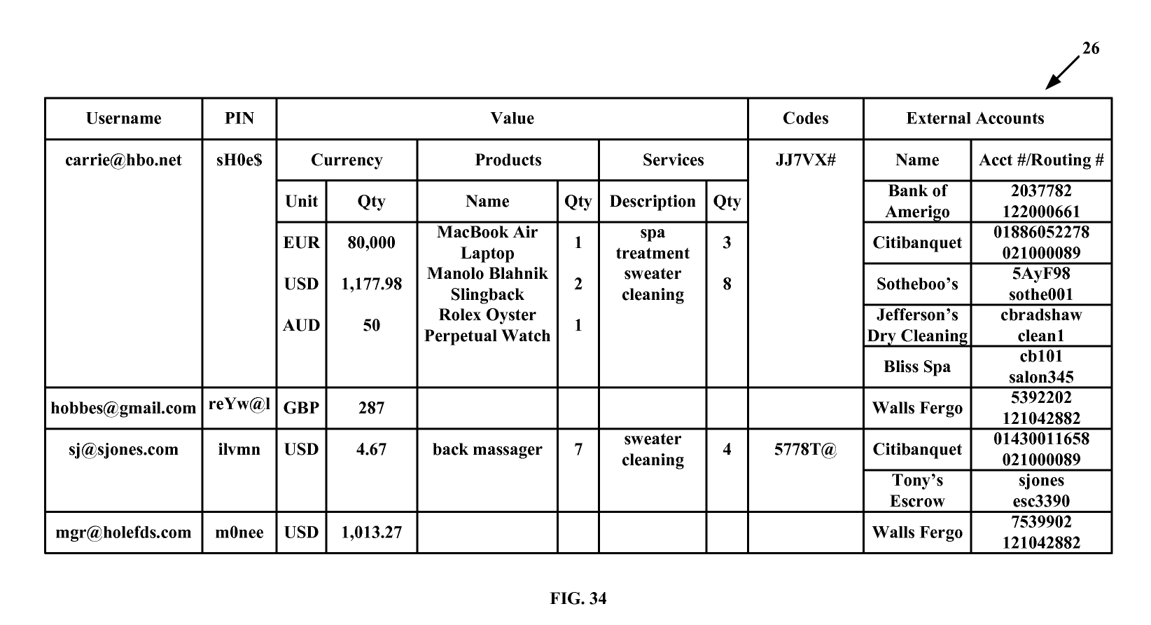

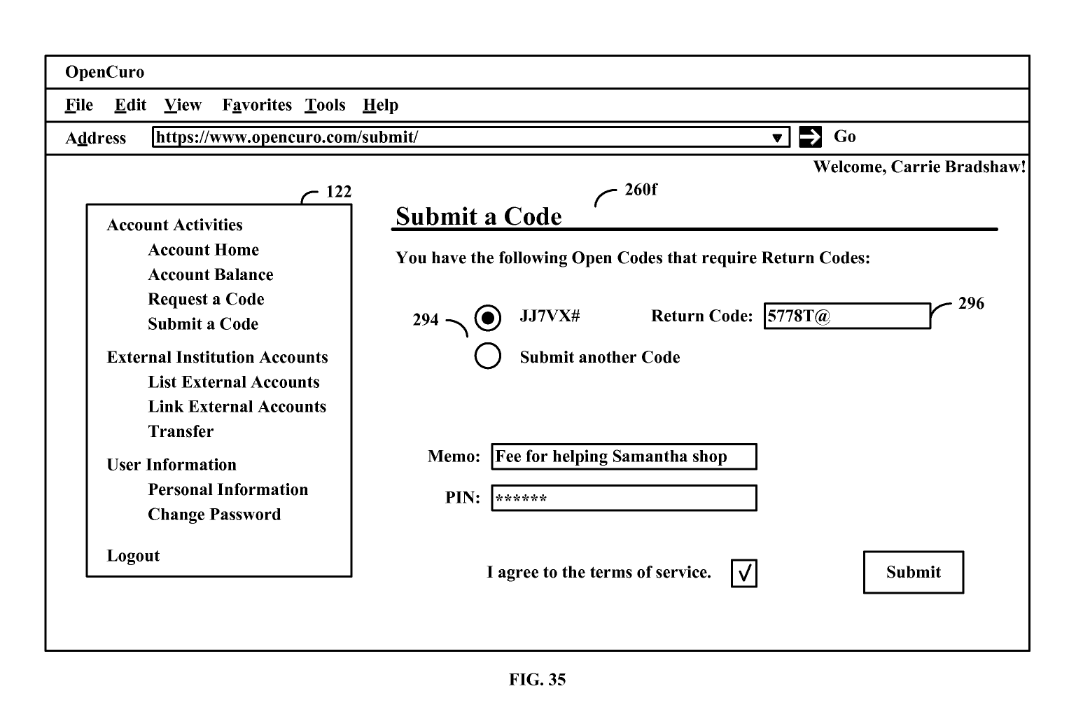

If controller 20 determines that the submitted RI-Code is valid, controller 20 causes web interface 22 to communicate the return Code to the user 16. For example, as illustrated in FIG. 33B, web interface 22 displays a “Submission Pending” web page 288 that includes instructions 290b that communicate the return Code to the Payer, and informs the Payer to communicate the return Code to the Payee. In addition, web page 288 may include a table 292 that displays the user's account balance if the RI-Code submission is complete. As shown in FIG. 34, account database 26 has been updated to add the RI-Code “5778T@” to Samantha's open Codes.

Referring again to FIG. 11, these transactions are illustrated schematically in FIG. 11 as Samantha's submission 318 of code “JJ7VX#” to trusted authority 12, the communication 320 of the return Code “5778T@” from trusted authority 12 to Samantha, and Samantha's communication 322 of the return Code “5778T@” to Carrie.

After Samantha provides the return Code to Carrie, Carrie may submit the return Code to trusted authority 12. In particular, as shown in FIG. 35, web interface 22 may display a “Submit a Code” web page 260f that informs the user that some open Codes require Return Codes, and enables the user 16 to easily specify the return Codes. For example, web page 260f may include radio buttons 294 that allow the user 16 to select the open RI-Code to which a return Code may be specified in return code data entry field 296, or to select an option to submit another Code. In the illustrated example, Carrie submits the return Code “5778T@” corresponding to RI-Code “JJ7VX#.”

After Carrie clicks the “Submit” button, controller 20 (FIG. 2) accesses code database 28 to determine if the submitted return Code is valid. In this example, controller 20 determines from code database 28 that submitted Code “5778T@” matches the RI-Code “JJ7VX#.” Controller 20 then invalidates both RI-Codes (e.g., by deleting the RI-Codes from account database 26 and code database 28), debits the value associated with the RI-Codes from Samantha's TA account, and credits the associated value to Carrie's TA account.

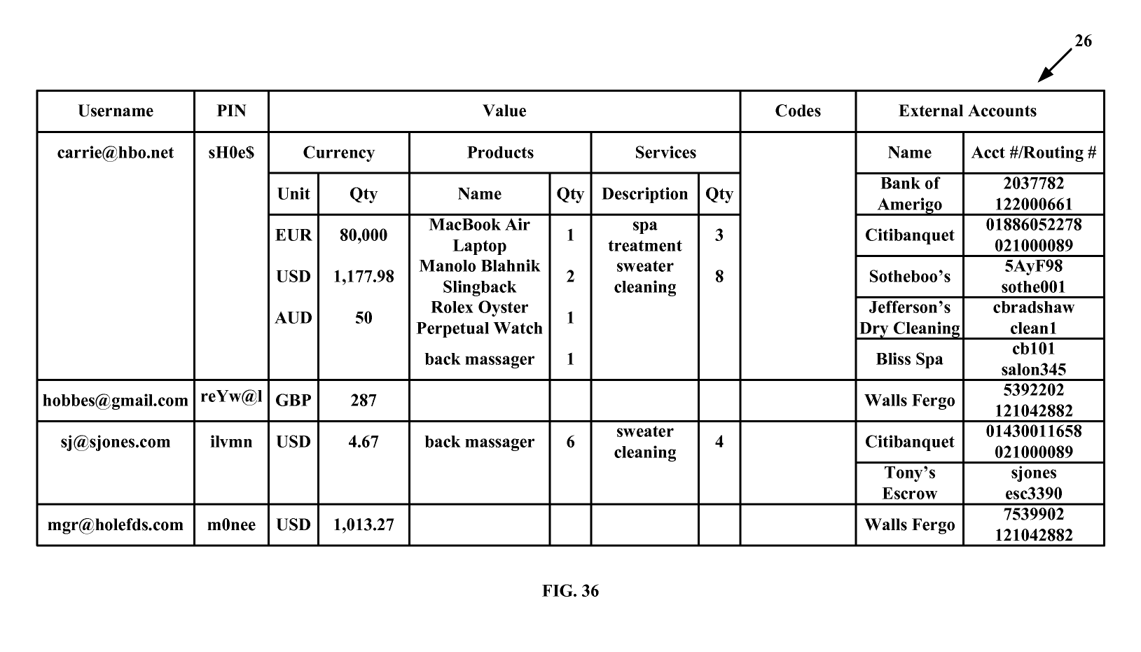

Referring again to FIG. 11, this transaction is illustrated schematically in FIG. 11 as Carrie's submission 324 of code “5778T@” to trusted authority 12. In addition, as shown in FIG. 36, account database 26 has been updated to reflect a decrease in Samantha's product value by the amount associated with the submitted RI-Code (1 back massager), and an increase in Carrie's product value by the same amount. Also, account database 26 has been updated to delete the RI-Codes “JJ7VX#” and “5778T@” from Carrie's and Samantha's open Codes, respectively.

### Code Process Flow

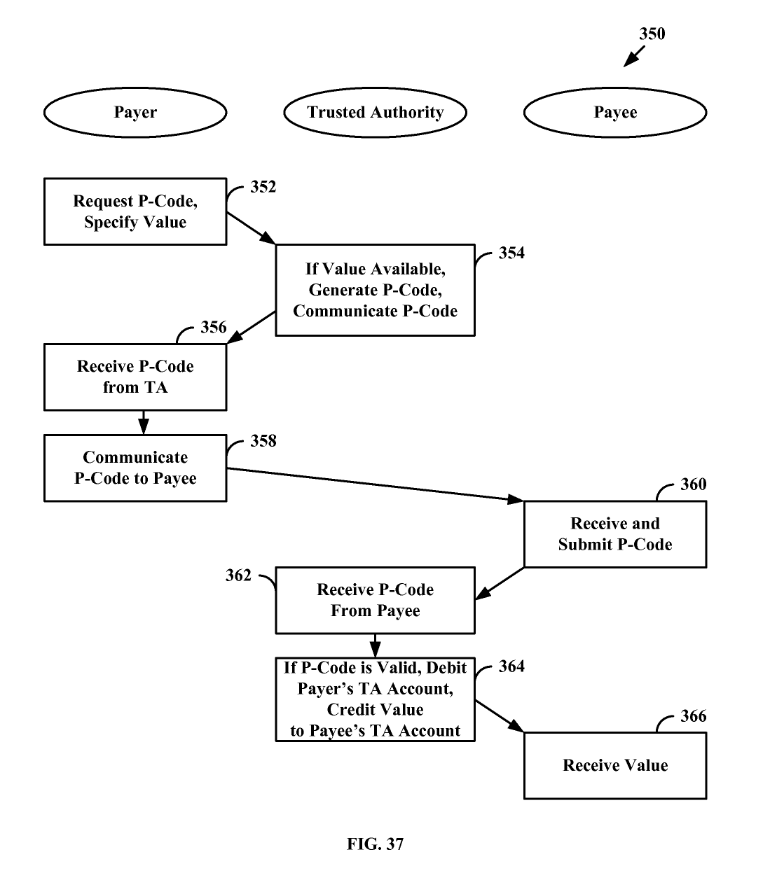

To further illustrate the process operation of value transfer system 10, FIGS. 37-40 illustrate diagrammatically the Code request and submission processes for each of the four different types of Codes described above.

Referring now to FIG. 37, an exemplary P-Code transaction 350 is described. In particular, at step 352, a Payer requests a P-Code for a specified value from trusted authority 12. At step 354, trusted authority 12 determines if the specified value is available in the Payer's TA account, and if so, generates a P-Code, associates the specified value with the P-Code, updates account database 26 and code database 28, and communicates the P-Code to the Payer. Next, at step 356, the Payer receives the P-Code from trusted authority 12. At step 358, the Payer communicates the P-Code to the Payee. At step 360, the Payee receives the P-Code from the Payer, and submits the P-Code to trusted authority 12. At step 362, trusted authority 12 receives the P-Code from the Payee. At step 364, trusted authority 12 determines if the received P-Code is valid, and if so, determines the value associated with the P-Code, invalidates the P-Code (e.g., by deleting it from code database 28), debits the Payer's TA account by the associated value, and credits the Payee's TA account by the associated value. Finally, at step 366, the Payee receives the value in the Payee's TA account.

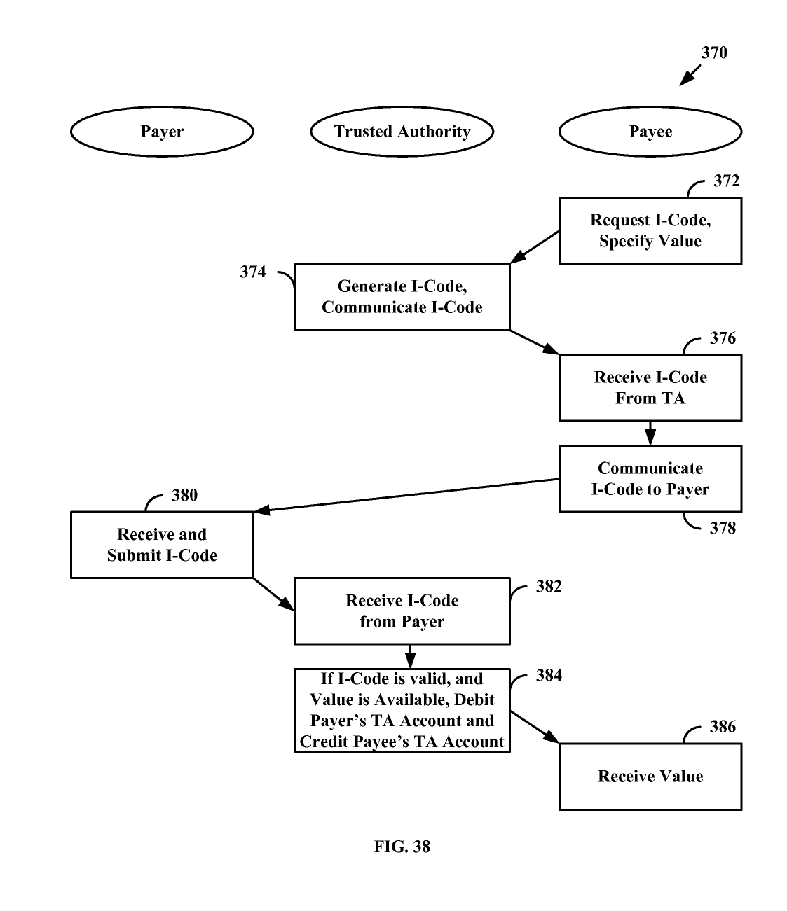

Referring now to FIG. 38, an exemplary I-Code transaction 370 is described. In particular, at step 372, a Payee requests an I-Code from trusted authority 12 for a specified value. At step 374, trusted authority 12 receives the request from the Payee, generates an I-Code, associates the specified value with the I-Code, updates account database 26 and code database 28, and communicates the I-Code to the Payee. Next, at step 376, the Payee receives the I-Code from trusted authority 12. At step 378, the Payee communicates the I-Code to the Payer. At step 380, the Payer receives the I-Code from the Payee, and submits the I-Code to trusted authority 12. At step 382, trusted authority 12 receives the I-Code from the Payer. At step 384, trusted authority 12 determines if the received I-Code is valid, and if so, determines the value associated with the I-Code, determines if the associated value is available in the Payer's TA account, and if so, invalidates the I-Code (e.g., by deleting it from code database 28), debits the Payer's TA account by the associated value, and credits the Payee's TA account by the associated value. Finally, at step 386, the Payee receives the value in the Payee's TA account.

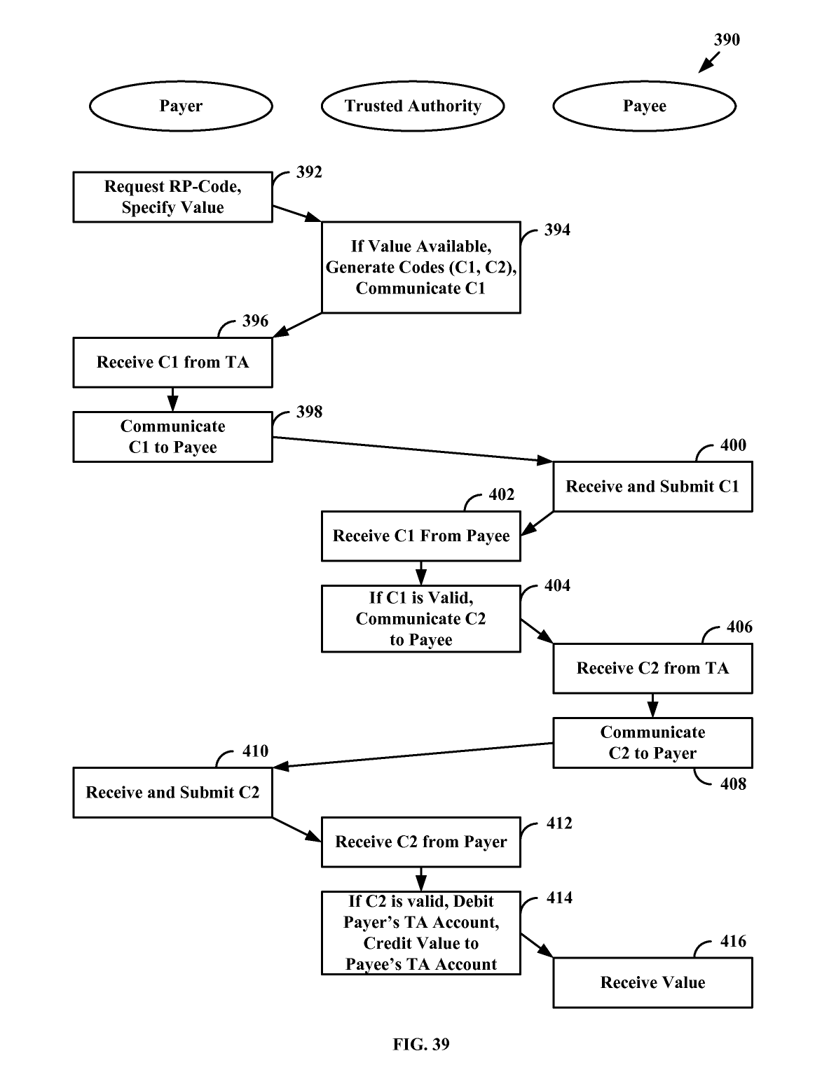

Referring now to FIG. 39, an exemplary RP-Code transaction 390 is described. In particular, at step 392, a Payer requests an RP-Code for a specified value from trusted authority 12. At step 394, trusted authority 12 determines if the specified value is available in the Payer's TA account, and if so, generates a pair of RP-Codes (e.g., C1, C2), associates the specified value with the RP-Codes, updates account database 26 and code database 28, and communicates C1 to the Payer. Next, at step 396, the Payer receives C1 from trusted authority 12. At step 398, the Payer communicates C1 to the Payee. At step 400, the Payee receives C1 from the Payer, and submits C1 to trusted authority 12. At step 402, trusted authority 12 receives C1 from the Payee. At step 404, trusted authority 12 determines if the received C1 is valid, and if so, communicates C2 to the Payee.

Next, at step 406, the Payee receives C2 from trusted authority 12. At step 408, the Payee communicates C2 to the Payer. At step 410, the Payer receives C2 from the Payee, and submits C2 to trusted authority 12. At step 412, trusted authority 12 receives C2 from the Payer. At step 414, trusted authority 12 determines if the received C2 is valid, and if so, determines the value associated with C2, invalidates C1 and C2 (e.g., by deleting them from code database 28), debits the Payer's TA account by the associated value, and credits the Payee's TA account by the associated value. Finally, at step 416, the Payee receives the value in the Payee's TA account.

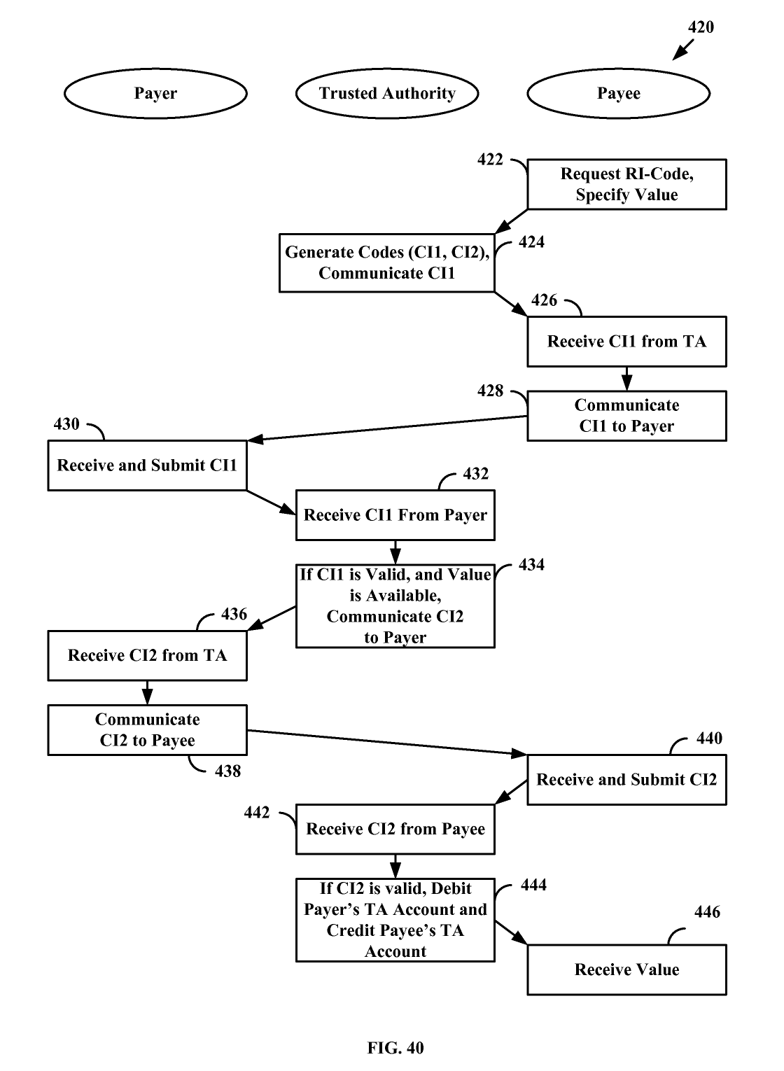

Referring now to FIG. 40, an exemplary RI-Code transaction 420 is described. In particular, at step 422, a Payee requests an RI-Code from trusted authority 12 for a specified value. At step 424, trusted authority 12 receives the request from the Payee, generates a pair of RI-Codes (e.g., CI1, CI2), associates the specified value with CI1 and CI2, updates account database 26 and code database 28, and communicates CI1 to the Payee. Next, at step 426, the Payee receives CI1 from trusted authority 12. At step 428, the Payee communicates CI1 to the Payer. At step 430, the Payer receives CI1 from the Payee, and submits CI1 to trusted authority 12. At step 432, trusted authority 12 receives CI1 from the Payer. At step 434, trusted authority 12 determines if the specified value is available in the Payer's TA account, and if so determines if the received CI1 is valid, and if so, communicates CI2 to the Payer.

Next, at step 436, the Payer receives CI2 from trusted authority 12. At step 438, the Payer communicates CI2 to the Payee. At step 440, the Payee receives CI2 from the Payer, and submits CI2 to trusted authority 12. At step 442, trusted authority 12 receives CI2 from the Payee. At step 444, trusted authority 12 determines if the received CI2 is valid, and if so, determines the value associated with CI2, invalidates CI1 and CI2 (e.g., by deleting them from code database 28), debits the Payer's TA account by the associated value, and credits the Payee's TA account by the associated value. Finally, at step 446, the Payee receives the value in the Payee's TA account.

### Trusted Authority Code Handling Operation

As described above, systems in accordance with this invention may use P-Codes, I-Codes, RP-Codes and/or RI-Codes. The operation of trusted authority 12 with respect to requests and submissions of each of these exemplary code types now will be described in more detail.

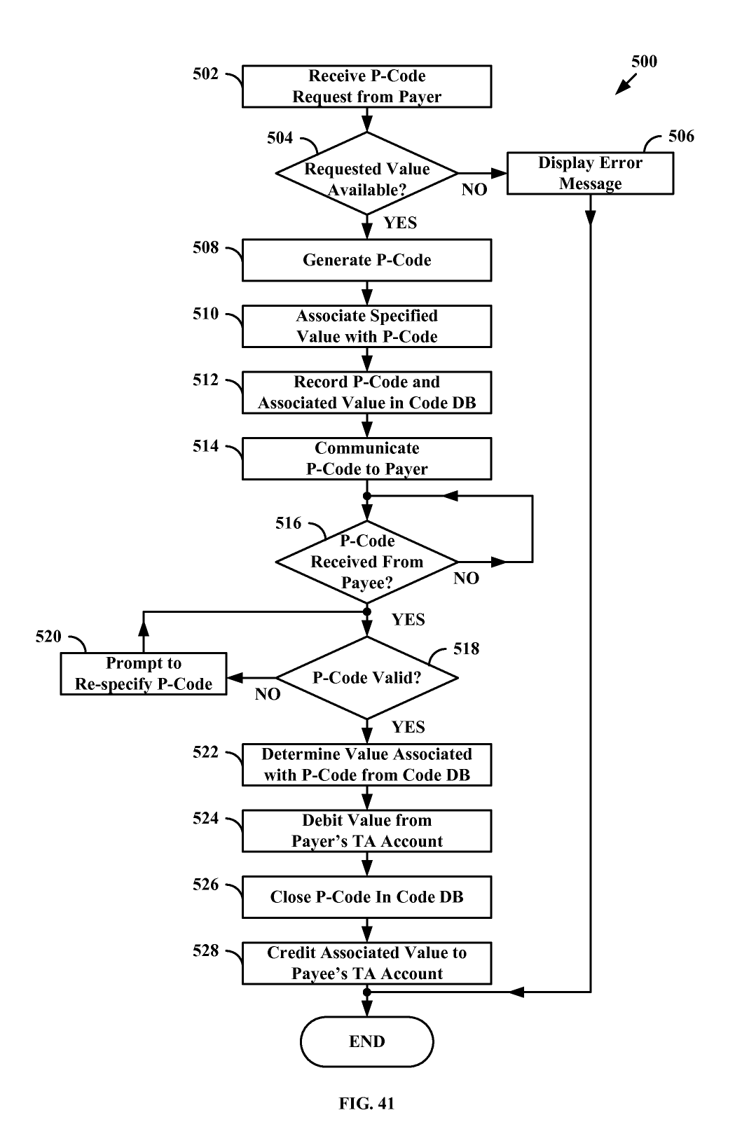

In particular, FIG. 41 illustrates an exemplary process 500 implemented by trusted authority 12 for processing P-Codes. Beginning at step 502, trusted authority 12 receives a request from a Payer for a P-Code for a specified value. Next, at step 504, trusted authority 12 determines if the specified value is available for withdrawal from the Payer's TA account. If not, at step 506 an error message may be displayed to the Payer, and the process may terminate. Otherwise, the process proceeds to step 508, whereby trusted authority 12 generates a P-Code. Next, at step 510, trusted authority 12 associates the specified value with the P-Code generated in step 508. At step 512, trusted authority 12 records the generated P-Code and its associated value as an open code in code database 28. Next, at step 514, trusted authority 12 communicates the generated P-Code to the Payer, who may then communicate the P-Code to a Payee.

At step 516, trusted authority 12 determines if it has received a P-Code submission from a Payee. If not, the trusted authority continues to wait. If, however, the trusted authority receives a P-Code submission, at step 518, trusted authority 12 determines if the submitted P-Code is valid. For example, trusted authority 12 may search code database 28 to determine if the submitted P-Code is still open, if additional data provided by the Payee is correct (e.g., the description and quantity of the value, the intended recipient, etc.). If the submitted P-Code is not valid, at step 520, trusted authority 12 may display an error message and prompt the Payee to re-submit the P-Code. Trusted authority 12 may permit an unlimited number of re-tries, or may prevent the Payee from re-submitting the P-Code after a predetermined number of failed attempts.

If trusted authority 12 determines that the submitted P-Code is valid, at step 522 trusted authority 12 determines from the code database 28 the value associated with the P-Code. Next, at step 524, trusted authority debits the associated value from the Payer's TA account. At step 526, trusted authority 12 invalidates the P-Code. For example, trusted authority 12 may mark the P-Code “closed” in code database 28, and may remove the P-Code from the Payer's TA account in account database 26. Finally, at step 528, trusted authority 12 credits the associated value to the Payee's TA account in account database 26.

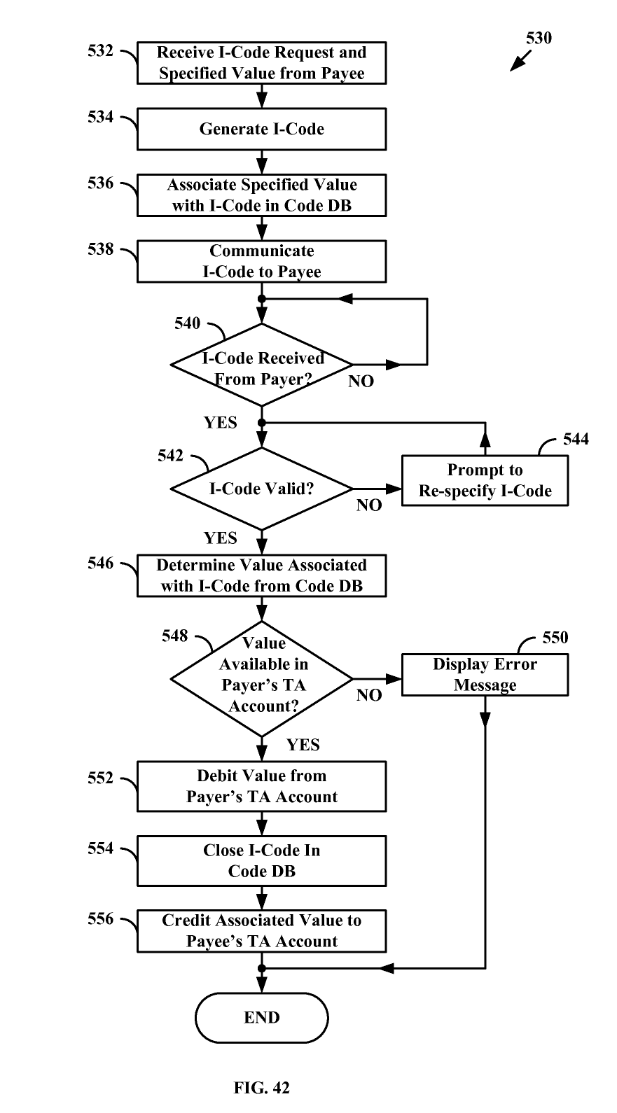

Referring now to FIG. 42, an exemplary process 530 implemented by trusted authority 12 for processing I-Codes is described. Beginning at step 532, trusted authority 12 receives a request from a Payee for an I-Code for a specified value. Next, at step 534, trusted authority 12 generates an I-Code. At step 536, trusted authority 12 records the generated I-Code and its associated value as an open code in code database 28. Next, at step 538, trusted authority 12 communicates the generated I-Code to the Payee, who may then communicate the I-Code to a Payer.

At step 540, trusted authority 12 determines if it has received an I-Code submission from a Payer. If not, the trusted authority continues to wait. If, however, the trusted authority receives an I-Code submission, at step 542, trusted authority 12 determines if the submitted I-Code is valid. For example, trusted authority 12 may search code database 28 to determine if the submitted I-Code is still open, if additional data provided by the Payer is correct (e.g., the description and quantity of the value, the intended recipient, etc.). If the submitted I-Code is not valid, at step 544, trusted authority 12 may display an error message and prompt the Payer to re-submit the I-Code. Trusted authority 12 may permit an unlimited number of re-tries, or may prevent the Payer from re-submitting the I-Code after a predetermined number of failed attempts.

If trusted authority 12 determines that the submitted I-Code is valid, at step 546 trusted authority 12 determines from the code database 28 the value associated with the I-Code. Next, at step 548, trusted authority 12 determines if the associated value is available for withdrawal from the Payer's TA account. If not, at step 550 an error message may be displayed to the Payer, and the process may terminate. Otherwise, the process proceeds to step 552, trusted authority debits the associated value from the Payer's TA account. At step 554, trusted authority 12 invalidates the I-Code. For example, trusted authority 12 may mark the I-Code “closed” in code database 28, and may remove the I-Code from the Payee's TA account in account database 26. Finally, at step 556, trusted authority 12 credits the associated value to the Payee's TA account in account database 26.

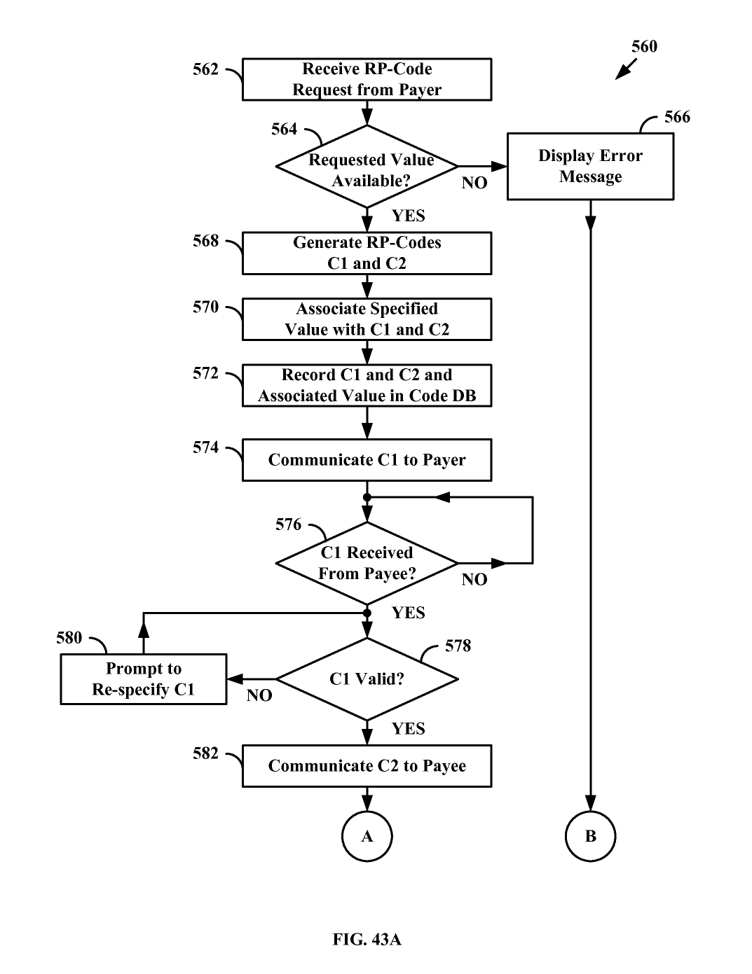

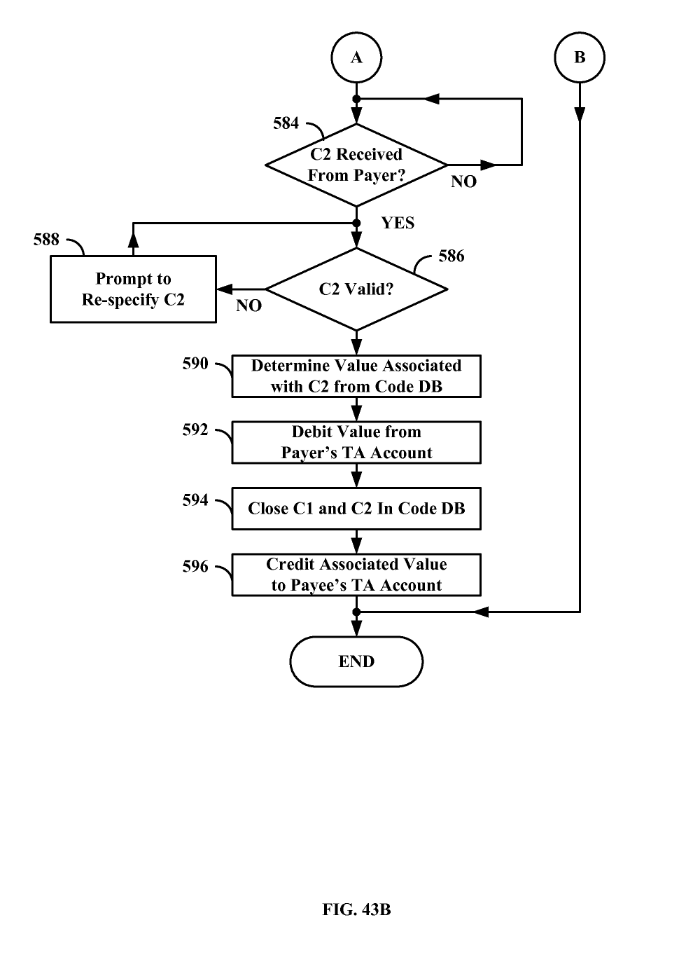

Referring now to FIGS. 43A-43B, an exemplary process 560 implemented by trusted authority 12 for processing RP-Codes is described. Beginning at step 562, trusted authority 12 receives a request from a Payer for an RP-Code for a specified value. Next, at step 564, trusted authority 12 determines if the specified value is available for withdrawal from the Payer's TA account. If not, at step 566 an error message may be displayed to the Payer, and the process may terminate. Otherwise, the process proceeds to step 568, whereby trusted authority 12 generates a pair of RP-Codes (e.g., C1 and C2). Next, at step 570, trusted authority 12 associates the specified value with C1 and C2 generated in step 568. At step 572, trusted authority 12 records C1 and C2 and their associated value as open codes in code database 28. Next, at step 574, trusted authority 12 communicates C1 to the Payer, who may then communicate C1 to a Payee.

At step 576, trusted authority 12 determines if it has received a C1 submission from a Payee. If not, the trusted authority continues to wait. If, however, the trusted authority receives a C1 submission, at step 578, trusted authority 12 determines if the submitted C1 is valid. For example, trusted authority 12 may search code database 28 to determine if the submitted C1 is still open, if additional data provided by the Payee is correct (e.g., the description and quantity of the value, the intended recipient, etc.). If the submitted C1 is not valid, at step 580, trusted authority 12 may display an error message and prompt the Payee to re-submit C1. Trusted authority 12 may permit an unlimited number of re-tries, or may prevent the Payee from re-submitting C1 after a predetermined number of failed attempts. Next, at step 582, trusted authority 12 communicates C2 to the Payee, who may then communicate C2 to a Payer.

At step 584, trusted authority 12 determines if it has received a C2 submission from a Payer. If not, the trusted authority continues to wait. If, however, the trusted authority receives a C2 submission, at step 586, trusted authority 12 determines if the submitted C2 is valid. For example, trusted authority 12 may search code database 28 to determine if the submitted C2 is still open, if additional data provided by the Payer is correct (e.g., the description and quantity of the value, the intended recipient, etc.). If the submitted C2 is not valid, at step 588, trusted authority 12 may display an error message and prompt the Payer to re-submit C2. Trusted authority 12 may permit an unlimited number of re-tries, or may prevent the Payer from re-submitting C2 after a predetermined number of failed attempts.

If trusted authority 12 determines that the submitted C2 is valid, at step 590 trusted authority 12 determines from the code database 28 the value associated with C2. Next, at step 592, trusted authority debits the associated value from the Payer's TA account. At step 594, trusted authority 12 invalidates C1 and C2. For example, trusted authority 12 may mark C1 and C2 “closed” in code database 28, and may remove C1 from the Payer's TA account and C2 from the Payee's TA account in account database 26. Finally, at step 596, trusted authority 12 credits the associated value to the Payee's TA account in account database 26.

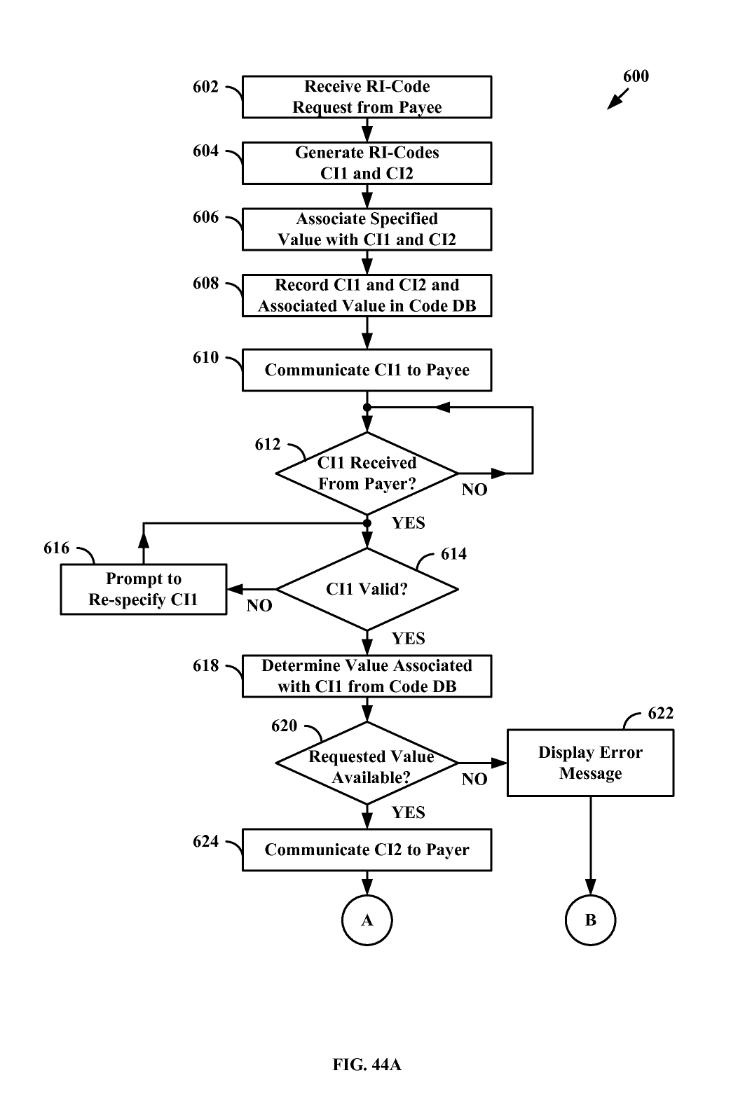

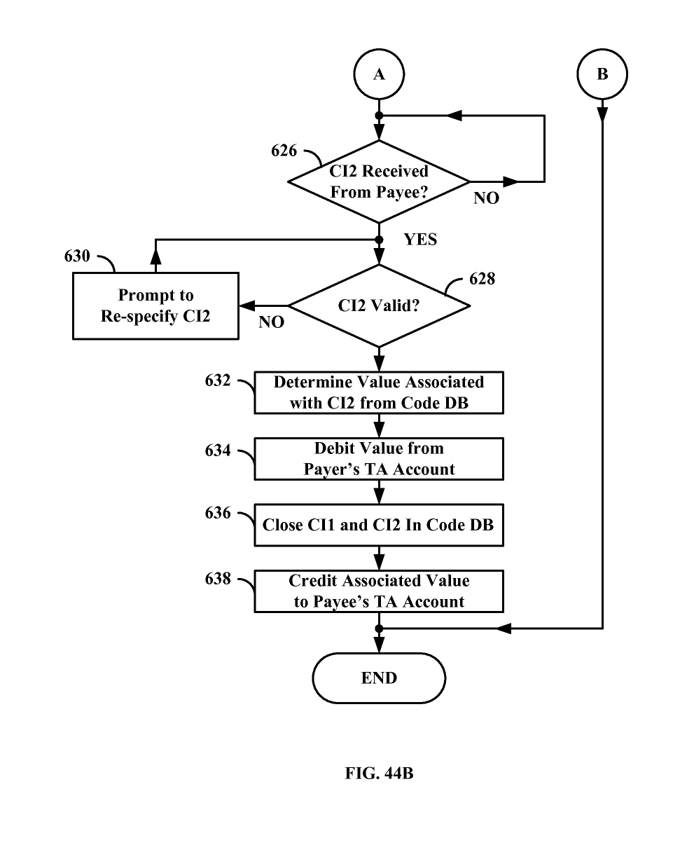

Referring now to FIGS. 44A-44B, an exemplary process 600 implemented by trusted authority 12 for processing RI-Codes is described. Beginning at step 602, trusted authority 12 receives a request from a Payee for an RI-Code for a specified value. Next, at step 604, trusted authority 12 generates a pair of RI-Codes (e.g., CI1 and CI2). Next, at step 606, trusted authority 12 associates the specified value with CI1 and CI2 generated in step 604. At step 608, trusted authority 12 records CI1 and CI2 and their associated value as open codes in code database 28. Next, at step 610 trusted authority 12 communicates CI1 to the Payee, who may then communicate CI1 to a Payer.

At step 612, trusted authority 12 determines if it has received a CI1 submission from a Payer. If not, the trusted authority continues to wait. If, however, the trusted authority receives a CI1 submission, at step 614, trusted authority 12 determines if the submitted CI1 is valid. For example, trusted authority 12 may search code database 28 to determine if the submitted CI1 is still open, if additional data provided by the Payer is correct (e.g., the description and quantity of the value, the intended recipient, etc.). If the submitted CI1 is not valid, at step 616, trusted authority 12 may display an error message and prompt the Payer to re-submit CI1. Trusted authority 12 may permit an unlimited number of re-tries, or may prevent the Payer from re-submitting CI1 after a predetermined number of failed attempts.

Next, at step 618, trusted authority 12 determines from the code database 28 the value associated with CI1. At step 620, trusted authority 12 determines if the specified value is available for withdrawal from the Payer's TA account. If not, at step 622 an error message may be displayed to the Payer, and the process may terminate. Otherwise, the process proceeds to step 624, and trusted authority 12 communicates CI2 to the Payer, who may then communicate CI2 to the Payee.

At step 626, trusted authority 12 determines if it has received a CI2 submission from a Payee. If not, the trusted authority continues to wait. If, however, the trusted authority receives a CI2 submission, at step 628, trusted authority 12 determines if the submitted CI2 is valid. For example, trusted authority 12 may search code database 28 to determine if the submitted CI2 is still open, if additional data provided by the Payee is correct (e.g., the description and quantity of the value, the intended recipient, etc.). If the submitted CI2 is not valid, at step 630, trusted authority 12 may display an error message and prompt the Payee to re-submit CI2. Trusted authority 12 may permit an unlimited number of re-tries, or may prevent the Payee from re-submitting CI2 after a predetermined number of failed attempts.

If trusted authority 12 determines that the submitted CI2 is valid, at step 632 trusted authority 12 determines from the code database 28 the value associated with CI2. Next, at step 634, trusted authority debits the associated value from the Payer's TA account. At step 636, trusted authority 12 invalidates CI1 and CI2. For example, trusted authority 12 may mark CI1 and CI2 “closed” in code database 28, and may remove CI1 from the Payee's TA account and CI2 from the Payer's TA account in account database 26. Finally, at step 638, trusted authority 12 credits the associated value to the Payee's TA account in account database 26.

Persons of ordinary skill in the art will understand that trusted authority 12 may use other processes for handling return Codes, including processes in which both the Payer and Payee substantially simultaneously request return Codes for the same value, and trusted authority matches the substantially simultaneous return Code requests.

Persons of ordinary skill in the art also will understand that trusted authority 12 may charge users 16 fees for one of more of the services provided by trusted authority. For example, trusted authority 12 may charge users 16 fees for one or more of transferring value between TA accounts and external accounts, requesting a Code, and submitting a Code. Trusted authority 12 may charge users 16 fees that vary based on the amount and/or type of value stored in value store 30, and/or may charge users 16 fees for Code requests and/or submissions based on the amount and/or type of value associated with the Code.

The foregoing merely illustrates the principles of this invention, and various modifications can be made by persons of ordinary skill in the art without departing from the scope and spirit of this invention.

1. A computer-implemented system comprising:
a trusted authority server comprising a value store adapted to store value owned by users, and an account database comprising user accounts, including a first user's account and a second user's account, each user account associated with a corresponding user and comprising a list of the stored value that is owned by the corresponding user, wherein the trusted authority server is adapted to:
receive a request from a first user for a code to be associated with a first specified value;
use hardware and/or software to generate first and second random codes;
associate the generated random codes with the first specified value;
communicate the first generated random code to the first user, wherein the first user communicates the first generated random code to a second user;
receive the first generated random code from the second user via an Internet interface;
determine if the received first generated random code is valid;
if the received first generated random code is valid, communicate the second generated random code to the second user, wherein the second user communicates the second generated random code to the first user;
receive the second generated random code from the first user;
determine if the received second generated random code is valid; and
if the received second generated random code is valid, debit the first specified value from the second user's account and credit the first specified value to the first user's account to transfer ownership of the first specified value from the second user to the first user.

2. The system of claim 1, wherein the stored value comprises any of a currency, a product and/or a service.

3. The system of claim 1, further comprising a code database comprising a list of the generated random codes.

4. The system of claim 3, wherein if the received first and second generated random codes are valid, the trusted authority server is further adapted to invalidate the received first and second generated random codes.

5. The system of claim 1, wherein determining the received code validity comprises determining if the received generated random code is in the code database.

6. The system of claim 1, wherein receiving the first generated random code further comprises receiving the first generated random code and a second specified value from the second user, and wherein determining the first generated random code's validity comprises determining if the second value equals the first value.

7. The system of claim 1, wherein the trusted authority is further adapted to determine if the second user's account includes the first specified value.

8. The system of claim 7, wherein the trusted authority server performs the debit step and the credit step only if the second user's account includes the first specified value.
